(19) United States
(12) Patent Application Publication
(10) Pub. No.: US 2026/0150858 A1
(43) Pub. Date: Jun. 4, 2026

(54) FRYER COOKING OIL COMPOSITIONS AND METHODS OF USE

(71) Applicant: Cemvita Factory, Inc., Houston, TX (US)

(72) Inventors: Jeff NOBBS, San Francisco, CA (US); Jay D. Keasling, Berkeley, CA (US); Stephen B. Del Cardayre, Belmont, CA (US)

(21) Appl. No.: 19/294,707

(22) Filed: Aug. 8, 2025

Related U.S. Application Data
(63) Continuation of application No. PCT/US2024/015267, filed on Feb. 9, 2024.
(60) Provisional application No. 63/484,268, filed on Feb. 10, 2023.
(60) Provisional application No. 63/592,149, filed on Oct. 20, 2023.

(51) Int. Cl. A23D 9/02

(52) U.S. Cl. CPC A23D 9/02

(57) ABSTRACT

The present disclosure provides a fryer containing a microbially derived oil; comprising a content of monounsaturated fat of at least 90% wt., a polyunsaturated fat of up to 3%, or both, where the fryer consumes less power to cook a food type, as compared to a fryer comprising a plant derived oil used to cook an identical food type, the oil having less aldehydes, alkenals, or alkadenials after cooking as compared to a plant derived oil, in which the oil or fried food comprises a reduced content of total polar materials as compared to a same food cooked in a plant derived oil at a same temperature for a same time, optionally, in which the oil prevents or reduces adhesion of a first particle of the food to a second particle of the food when cooked in the microbially derived oil.

### CROSS REFERENCE

This application is a continuation of International Patent Application PCT/US2024/015267 filed Feb. 9, 2024, which claims the benefit of U.S. Provisional Patent Application No. 63/484,268 filed Feb. 10, 2023, and U.S. Provisional Patent Application No. 63/592,149 filed Oct. 20, 2023, each of which is incorporated herein by reference in its entirety and for all purposes.

### BACKGROUND

The human ingestion of cytotoxic aldehydes can potentially induce damaging health effects. The generation of cytotoxic aldehydes are commonly formed during high temperature frying practices using polyunsaturated fatty acid (PUFA)-rich cooking oils. The high temperatures used for standard frying or cooking processes generate high concentrations of secondary lipid oxidation products that are consumed by millions of people per day. At the moment, there are few cooking oils that avoid the generation of cytotoxic aldehydes during common frying or high temperature cooking processes.

### SUMMARY

The reactive aldehydes produced from the thermal stressing of cooking oils by common frying practices are readily absorbed by the human gut upon consumption. This initiates the systemic circulation in vivo of the reactive aldehydes by the human body leading to the damage of tissues, cells, and essential organs. These reactive aldehydes have been demonstrated to promote a broad spectrum of concentration-dependent cellular stresses, and their adverse health properties include effects on critical metabolic pathways; the promotion and perpetuation of atherosclerosis and cardiovascular diseases; mutagenic and carcinogenic properties, teratogenic actions (embryo malformations during pregnancy); the exertion of striking pro-inflammatory effects; the induction of gastropathic properties (peptic ulcers) following dietary ingestion; neurotoxic actions, particularly for 4-hydroxy-trans-2-nonenal (HNE) and -hexenal (HHE); and impaired vasorelaxation coupled with the adverse stimulation of significant increases in systolic blood pressure. Further deleterious health effects include chromosomal aberrations, which are reflective of their clastogenic potential, sister chromatid exchanges and point mutations, in addition to cell damage and death. As a result, there is a need to generate new cooking oils that avoid the generation of food-borne toxins such as these reactive aldehydes.

Aspects disclosed herein provide a fryer comprising a microbially derived oil; comprising a monounsaturated fat (MUFA) content of at least 90% wt., a polyunsaturated fat (PUFA) content of up to 3%, or both, wherein: the fryer consumes less energy over a period of time to cook a food type, as compared to a fryer comprising a plant derived oil used to cook an identical food type; and/or the fryer comprises less aldehydes, alkenals, or alkadenials after cooking a food type, as compared to a fryer comprising a plant derived oil used to cook an identical food type. In some embodiments, the microbially derived oil is a yeast derived oil. In some embodiments, the microbially derived oil comprises a triacylglyceride (TAG) with a polyunsaturated fatty acids (PUFA) content of less than 2%. In some embodiments, the TAG has a C18:2 fatty acid content of less than 1%. In some embodiments, the TAG has a linoleic acid content of less than 1%. In some embodiments, the microbially derived oil is a non-photosynthetic microbial oil. In some embodiments, the microbially derived oil comprises less than 100 ppm of detectable volatile aldehydes, such as alpha, beta-unsaturated aldehydes, including acrolein and crotonaldehyde. In some embodiments, the microbially derived oil comprises a specific heat which is less than a plant derived cooking oil and a food, wherein a time to cook the food in the microbially derived oil is less than a time to cook the food in the plant derived cooking oil, optionally, wherein the plant derived cooking oil is sunflower oil. In some embodiments, the microbially derived oil is resistant to decomposition into polar materials as measured by total polar material (TMP) in the oil when heated. In some embodiments, the TMP comprises peroxides, epoxides, alcohols, ketones, aldehydes, acids, dimers, polymers, or combinations thereof. In some embodiments, the microbially derived oil prevents adhesion of a first particle of the food to a second particle of the food when cooked in the microbially derived oil. In some embodiments, the microbially derived oil comprises at least 90% oleic acid, and less than 4% saturated fatty acids and less than 3% polyunsaturated fatty acids, wherein a time to cook the food in the microbially derived oil is less than a time to cook the food in the plant derived cooking oil.

Aspects disclosed herein provide a method of using the fryer of any one of the preceding claims comprising: cooking one or more food items in the fryer for a period of time. In some embodiments, the fryer and/or the oil in the fryer comprises less aldehydes as compared to a fryer comprising a plant derived oil used to cook identical food items. In some embodiments, the method comprises using a reduced temperature for cooking as compared to a fryer comprising a plant derived oil. In some embodiments, the cooking at reduced temperature wherein the method prevents or reduces adhesion of a first particle of the food to a second particle of the food when cooked in the microbially derived oil. In some embodiments, the method increases a transfer of heat to the food and/or reduces a cooking time of the food as compared to a plant-derived oil. In some embodiments, the oil comprises a monounsaturated fat (MUFA) of at least 90% wt., a polyunsaturated fat (PUFA) of up to 3%, or both; placing a piece of food in the cooking oil until the temperature of the piece of food increases to at least 150° F.; and removing the fried food from the fryer, wherein the fried food comprises a reduced content of total polar materials as compared to a same food cooked in a plant derived oil at a same temperature for a same time. In some embodiments, the food is a meat, seafood, or vegetable. In some embodiments, a time required to increase the temperature of the piece of food to at least 150 F is less than a plant derived oil, optionally, wherein the plant derived oil is sunflower oil. In some embodiments, a time to cook the food in the microbially derived oil is the same as a time to cook the food in the plant derived oil when a temperature of the microbially derived oil is less than a temperature of the plant derived oil, optionally, wherein the plant derived oil is sunflower oil. In some embodiments, the microbially derived oil is resistant to decomposition into polar materials as measured by total polar material (TMP) in the oil when heated to 370 F, wherein the oil comprises a TMP of less than 20% after 6 days, wherein the oil comprises a TMP of less than 30% after 12 days, or wherein the oil comprises a TMP of less than 35% after 20 days. In some embodiments, the microbially derived oil prevents adhesion of a first particle of the food to a second particle of the food when cooked in the microbially derived oil. In some embodiments, the microbially derived oil comprises a polyunsaturated fatty acid content of less than about 4 mmol/kg. In some embodiments, the microbially derived oil comprises a polyunsaturated fatty acid content of less than about 3 mmol/kg. In some embodiments, the microbially derived oil comprises a polyunsaturated fatty acid content of less than about 2.5 mmol/kg. In some embodiments, the microbially derived oil comprises a linoleic acid content of less than about 2.5 mmol/kg. In some embodiments, the microbially derived oil comprises a monounsaturated fatty acid content of at least 55 mmol/kg. In some embodiments, the microbially derived oil comprises a monounsaturated fatty acid content of about 60 mmol/kg. In some embodiments, the microbially derived oil comprises a saturated fatty acid content of less than about 3 mmol/kg. In some embodiments, the microbially derived oil comprises arachidic acid in an amount of less than about 0.07 mmol/kg. In some embodiments, the microbially derived oil comprises palmitic acid in an amount of less than about 1.5 mmol/kg. In some embodiments, the microbially derived oil comprises stearic acid in an amount of less than about 0.8 mmol/kg. In some embodiments, the microbially derived oil comprises less than about 2 mmol/kg α,β-unsaturated aldehydes when heated to about 180° C. In some embodiments, the microbially derived oil comprises less than about 2 mmol/kg α,β-unsaturated aldehydes when heated to about 180° C. for about 90 minutes or less. In some embodiments, the microbially derived oil comprises less than about 50 mmol/kg aldehydes when heated to about 180° C. for about 90 minutes or less. In some embodiments, the microbially derived oil comprises essentially no α,β-unsaturated aldehydes when heated to about 180° C. for about 5 minutes or less. In some embodiments, the microbially derived oil comprises less than about 1.5 mmol/kg α,β-unsaturated aldehydes when heated to about 180° C. for about 60 minutes or less. In some embodiments, the microbially derived oil comprises essentially no (Z)-2-Alkenals when heated to about 180° C. for about 20 minutes or less. In some embodiments, the microbially derived oil comprises less than about 1 mmol/kg (Z)-2-Alkenals when heated to about 180° C. for about 90 minutes or less. In some embodiments, the microbially derived oil comprises essentially no (Z,E)-2,4-Alkadienals when heated to about 180° C. for about 90 minutes or less. In some embodiments, the microbially derived oil comprises no detectable (Z,E)-2,4-Alkadienals when heated to about 180° C. for about 20 minutes or less. In some embodiments, the microbially derived oil comprises essentially no 4-Hydroperoxy-/4-Hydroxy-(E)-2-alkenals when heated to about 180° C. for about 10 minutes or less. In some embodiments, the microbially derived oil comprises less than 1 mmol/kg 4-Hydroperoxy-/4-Hydroxy-(E)-2-alkenals when heated to about 180° C. for about 90 minutes or less. In some embodiments, the microbially derived oil comprises essentially no 4,5-Epoxy-(E)-2-alkenals when heated to about 180° C. for about 90 minutes or less. In some embodiments, the microbially derived oil comprises less than 0.3 mmol/kg 4-(E,E)-2,4-Alkadienals when heated to about 180° C. for about 20 minutes or less. In some embodiments, the microbially derived oil comprises less than about 50 mmol/kg total aldehydes when heated to about 180° C. In some embodiments, the microbially derived oil comprises less than about 50 mmol/kg total aldehydes when heated to about 180° C. for about 90 minutes or less. In some embodiments, the method prevents or reduces adhesion of a first particle of the food to a second particle of the food when cooked in the microbially derived oil.

Aspects disclosed herein provide a fryer containing a cooking oil comprising a specific heat which is less than a plant derived cooking oil, and a food, wherein a time to cook the food in the cooking oil is less than a time to cook the food in the plant derived cooking oil, optionally, wherein the plant derived cooking oil is sunflower oil. Aspects disclosed herein provide a fryer containing a cooking oil comprising a specific heat which is less than a plant derived cooking oil, and a food, wherein a time to cook the food in the cooking oil is the same as a time to cook the food in the plant derived cooking oil when a temperature of the cooking oil is less than a temperature of the plant derived oil, optionally, wherein the plant derived cooking oil is sunflower oil. Aspects disclosed herein provide a fryer containing a food, and a cooking oil comprising at least 90% oleic acid, and less than 4% saturated fatty acids and less than 3% polyunsaturated fatty acids, wherein a time to cook the food in the cooking oil is less than a time to cook the food in the plant derived cooking oil. Aspects disclosed herein provide a fryer containing a cooking oil which is resistant to decomposition into polar materials as measured by total polar material (TMP) in the oil when heated to 370 F, wherein the oil comprises a TMP of less than 20% after 6 days, wherein the oil comprises a TMP of less than 30% after 12 days, or wherein the oil comprises a TMP of less than 35% after 20 days. Aspects disclosed herein provide a fryer containing a cooking oil, and a food, wherein the cooking oil prevents adhesion of a first particle of the food to a second particle of the food when cooked in the cooking oil. In another aspect, the present disclosure provides a fryer containing a cooking oil with a linoleic acid content below a detection limit. In some cases, the linoleic acid content is substantially negligible. In some cases, the cooking oil is a yeast oil. In some cases, the cooking oil is a non-photosynthetic microbial oil. In some cases, the cooking oil contains less than 5% oxidation products of linoleic acid. In some cases, the cooking oil contains less than 3% 4-hydroxynonenal (HNE). In some cases, the cooking oil contains less than 5 ppm of acrolein. In some cases, the cooking oil contains less than 5 ppm of crotonaldehyde. In some cases, the cooking oil contains less than 100 ppm of detectable volatile aldehydes, such as alpha, beta-unsaturated aldehydes, including acrolein and crotonaldehyde. Aspects disclosed herein provide a fryer containing a cooking oil that includes a triacylglyceride (TAG) with a polyunsaturated fatty acids (PUFA) content of less than 2%. In some cases, the TAG has a C18:2 fatty acid content of less than 1%. In some cases, the TAG has a linoleic acid content of less than 1%. In some cases, the TAG has an omega-6 fatty acid content of less than 1%. In some cases, the TAG has a MUFA content of more than 50%. In some cases, the TAG has a MUFA content of 50% to 95%. In some cases, the TAG has a C18:1 fatty acid content of 70% or greater. In some cases, the TAG has a SFA content of 40% or greater. In some cases, the TAG has a SFA content of 5% to 15%. In some cases, the TAG has a SFA content of 5% to 90% and a MUFA content of 10% to 80% In some cases, the cooking oil has an OSI of greater than 50 hours without antioxidants added to the cooking oil. In some cases, the cooking oil has an OSI of greater than 100 hours without antioxidants added to the cooking oil. In some cases, the cooking oil has a TPM content below 10% after heating at a temperature greater than 250° F. for 4 hours. In some cases, the cooking oil has a TPM content below 10% after heating at a temperature greater than 300° F. for 4 hours. In some cases, the cooking oil has a TPM content below 10% after heating at a temperature greater than 350° F. for 4 hours. In some cases, the cooking oil has a TPM content below 10% after heating at a temperature greater than 400° F. for 4 hours. In some cases, the cooking oil has a TPM content below 10% after heating from between 250° F. to 400° F. for 4 hours In some cases, the cooking oil has a TPM content of less than 24% after heating at 250° F. for three days. In some cases, the cooking oil comprises less than 5% free fatty acids after heating at 250° F. for 4 hours. In some cases, the cooking oil contains less than 3% of aldehydes after heating at 250° F. for 50 hours. In some cases, the cooking oil contains less than 1% of saturated aldehydes after heating at 250° F. for 50 hours. In some cases, the cooking oil contains less than 2% of α,β-unsaturated aldehydes after heating at 250° F. for 50 hours. In some cases, the cooking oil contains less than 0.5 mmol/mol FA of combined 4-hydrox/4-hydroperoxy-trans-2-alkenals after heating at 250° F. for 50 hours. In some cases, the cooking oil contains less than 5% w/w lipid oxidation products (LOP) after heating at 250° F. for 50 hours. In some cases, the cooking oil contains less than 350 μmol/L 4-hydroxy-trans-2-nonenal (HNE) after heating at 250° F. for 50 hours. In some embodiments, the cooking oil is resistant to rancidification resulting from oxidization or hydrolysis of fatty acids. In some embodiments, the cooking oil comprises a polyunsaturated fatty acid content of less than about 4 mmol/kg. In some embodiments, the cooking oil comprises a polyunsaturated fatty acid content of less than about 3.5 mmol/kg. In some embodiments, the cooking oil comprises a polyunsaturated fatty acid content of less than about 3 mmol/kg. In some embodiments, the cooking oil comprises a polyunsaturated fatty acid content of less than about 2.5 mmol/kg. In some embodiments, the cooking oil comprises a polyunsaturated fatty acid content of less than about 2.25 mmol/kg. In some embodiments, the cooking oil comprises a linoleic acid content of less than about 2.5 mmol/kg. In some embodiments, the cooking oil comprises a linoleic acid content of less than about 2.25 mmol/kg. In some embodiments, the cooking oil comprises a linoleic acid content of less than about 2 mmol/kg, or about 2 mmol/kg. In some embodiments, the cooking oil comprises a monounsaturated fatty acid content of at least 55 mmol/kg. In some embodiments, the cooking oil comprises a monounsaturated fatty acid content of at least 57.5 mmol/kg. In some embodiments, the cooking oil comprises a monounsaturated fatty acid content of about 60 mmol/kg. In some embodiments, the cooking oil comprises a saturated fatty acid content of less than about 3 mmol/kg. In some embodiments, the cooking oil comprises a saturated fatty acid content of less than about 2.75 mmol/kg. In some embodiments, the cooking oil comprises a saturated fatty acid content of about 2.5 mmol/kg. In some embodiments, the cooking oil comprises arachidic acid in an amount of less than about 0.07 mmol/kg. In some embodiments, the cooking oil comprises palmitic acid in an amount of less than about 1.5 mmol/kg. In some embodiments, the cooking oil comprises stearic acid in an amount of less than about 0.8 mmol/kg. In some embodiments, the cooking oil comprises less than about 2 mmol/kg α,β-unsaturated aldehydes when heated to about 180° C. In some embodiments, the cooking oil comprises less than about 1.8 mmol/kg α,β-unsaturated aldehydes when heated to about 180° C. In some embodiments, the cooking oil comprises less than about 2 mmol/kg α,β-unsaturated aldehydes when heated to about 180° C. for about 90 minutes or less. In some embodiments, the cooking oil comprises less than about 1.8 mmol/kg α,β-unsaturated aldehydes when heated to about 180° C. for about 90 minutes or less. In some embodiments, the cooking oil comprises less than about 50 mmol/kg aldehydes when heated to about 180° C. for about 90 minutes or less. In some embodiments, the cooking oil comprises essentially no α,β-unsaturated aldehydes when heated to about 180° C. for about 5 minutes or less. In some embodiments, the cooking oil comprises no detectable α,β-unsaturated aldehydes when heated to about 180° C. for about 5 minutes or less when measured using high-resolution proton (¹H) nuclear magnetic resonance (NMR). In some embodiments, the cooking oil comprises less than about 0.1 mmol/kg α,β-unsaturated aldehydes when heated to about 180° C. for about 10 minutes or less. In some embodiments, the cooking oil comprises less than about 0.35 mmol/kg α,β-unsaturated aldehydes when heated to about 180° C. for about 20 minutes or less. In some embodiments, the cooking oil comprises less than about 0.55 mmol/kg α,β-unsaturated aldehydes when heated to about 180° C. for about 30 minutes or less. In some embodiments, the cooking oil comprises less than about 1.5 mmol/kg α,β-unsaturated aldehydes when heated to about 180° C. for about 60 minutes or less. In some embodiments, the cooking oil comprises essentially no (Z)-2-Alkenals when heated to about 180° C. for about 20 minutes or less. In some embodiments, the cooking oil comprises no detectable (Z)-2-Alkenals when heated to about 180° C. for about 20 minutes or less when measured using high-resolution proton (¹H) nuclear magnetic resonance (NMR). In some embodiments, the cooking oil comprises less than about 0.15 mmol/kg (Z)-2-Alkenals when heated to about 180° C. for about 30 minutes or less. In some embodiments, the cooking oil comprises less than about 0.8 mmol/kg (Z)-2-Alkenals when heated to about 180° C. for about 60 minutes or less. In some embodiments, the cooking oil comprises less than about 1 mmol/kg (Z)-2-Alkenals when heated to about 180° C. for about 90 minutes or less. In some embodiments, the cooking oil comprises essentially no (Z,E)-2,4-Alkadienals when heated to about 180° C. for about 90 minutes or less. In some embodiments, the cooking oil comprises no detectable (Z,E)-2,4-Alkadienals when heated to about 180° C. for about 20 minutes or less when measured using high-resolution proton (¹H) nuclear magnetic resonance (NMR). In some embodiments, the cooking oil comprises essentially no 4-Hydroperoxy-/4-Hydroxy-(E)-2-alkenals when heated to about 180° C. for about 10 minutes or less. In some embodiments, the cooking oil comprises no detectable 4-Hydroperoxy-/4-Hydroxy-(E)-2-alkenals when heated to about 180° C. for about 10 minutes or less when measured using high-resolution proton (¹H) nuclear magnetic resonance (NMR). In some embodiments, the cooking oil comprises less than 0.1 mmol/kg 4-Hydroperoxy-/4-Hydroxy-(E)-2-alkenals when heated to about 180° C. for about 20 minutes or less. In some embodiments, the cooking oil comprises less than 0.4 mmol/kg 4-Hydroperoxy-/4-Hydroxy-(E)-2-alkenals when heated to about 180° C. for about 30 minutes or less. In some embodiments, the cooking oil comprises less than 0.4 mmol/kg 4-Hydroperoxy-/4-Hydroxy-(E)-2-alkenals when heated to about 180° C. for about 50 minutes or less. In some embodiments, the cooking oil comprises less than 0.8 mmol/kg 4-Hydroperoxy-/4-Hydroxy-(E)-2-alkenals when heated to about 180° C. for about 60 minutes or less. In some embodiments, the cooking oil comprises less than 1 mmol/kg 4-Hydroperoxy-/4-Hydroxy-(E)-2-alkenals when heated to about 180° C. for about 90 minutes or less. In some embodiments, the cooking oil comprises essentially no 4,5-Epoxy-(E)-2-alkenals when heated to about 180° C. for about 90 minutes or less. In some embodiments, the cooking oil comprises no detectable 4,5-Epoxy-(E)-2-alkenals when heated to about 180° C. for about 20 minutes or less when measured using high-resolution proton (¹H) nuclear magnetic resonance (NMR). In some embodiments, the cooking oil comprises less than 0.3 mmol/kg 4-(E,E)-2,4-Alkadienals when heated to about 180° C. for about 20 minutes or less. In some embodiments, the cooking oil comprises less than about 50 mmol/kg total aldehydes when heated to about 180° C. In some embodiments, the cooking oil comprises less than about 50 mmol/kg total aldehydes when heated to about 180° C. for about 90 minutes or less. In some embodiments, the cooking oil comprises less than about 40 mmol/kg total aldehydes when heated to about 180° C. for about 60 minutes or less. In some embodiments, the cooking oil comprises less than about 25 mmol/kg total aldehydes when heated to about 180° C. for about 30 minutes or less. In some embodiments, the cooking oil comprises less than about 15 mmol/kg total aldehydes when heated to about 180° C. for about 20 minutes or less. In some embodiments, the cooking oil comprises less than about 1 mmol/kg total aldehydes when heated to about 180° C. for about 10 minutes or less. In some embodiments, the temperature of the cooking oil is at least 5, 10, 15, 20, 25, or 30 F less than the temperature of the plant derived oil, to achieve the same time to cook the food in the cooking oil as the plant derived oil. In some embodiments, the cooking oil comprises a specific heat which is less than a plant derived cooking oil and a food, wherein a time to cook the food in the cooking oil is less than a time to cook the food in the plant derived cooking oil, optionally, wherein the plant derived cooking oil is sunflower oil. In some embodiments, cooking oil is resistant to decomposition into polar materials as measured by total polar material (TMP) in the oil when heated. In some embodiments, the TMP comprises peroxides, epoxides, alcohols, ketones, aldehydes, acids, dimers, polymers, or combinations thereof. In some embodiments, the cooking oil prevents adhesion of a first particle of the food to a second particle of the food when cooked in the cooking oil. In some embodiments, the cooking oil comprises at least 90% oleic acid, and less than 4% saturated fatty acids and less than 3% polyunsaturated fatty acids, wherein a time to cook the food in the cooking oil is less than a time to cook the food in the plant derived cooking oil. In some embodiments, the cooking oil is resistant to decomposition into polar materials as measured by total polar material (TMP) in the oil when heated to 370 F, wherein the oil comprises a TMP of less than 20% after 6 days, wherein the oil comprises a TMP of less than 30% after 12 days, or wherein the oil comprises a TMP of less than 35% after 20 days. In some embodiments, the TAG has a C18:2 fatty acid content of less than 1%. In some embodiments, the TAG has a linoleic acid content of less than 1%. In some embodiments, the TAG has an omega-6 fatty acid content of less than 1%. In some embodiments, the TAG has a MUFA content of more than 50%. In some embodiments, the TAG has a MUFA content of 50% to 95%. In some embodiments, the TAG has a C18:1 fatty acid content of 70% or greater. In some embodiments, the TAG has a SFA content of 40% or greater. In some embodiments, the TAG has a SFA content of 5% to 15%. In some embodiments, the TAG has a SFA content of 5% to 90% and a MUFA content of 10% to 80% In some embodiments, the cooking oil has an OSI of greater than 50 hours without antioxidants added to the cooking oil. In some embodiments, the cooking oil has an OSI of greater than 100 hours without antioxidants added to the cooking oil. In some embodiments, the cooking oil has a TPM content below 10% after heating at a temperature greater than 250° F. for 4 hours. In some embodiments, the cooking oil has a TPM content below 10% after heating at a temperature greater than 300° F. for 4 hours. In some embodiments, the cooking oil has a TPM content below 10% after heating at a temperature greater than 350° F. for 4 hours. In some embodiments, the cooking oil has a TPM content below 10% after heating at a temperature greater than 400° F. for 4 hours In some embodiments, the cooking oil has a TPM content below 10% after heating from between 250° F. to 400° F. for 4 hours In some embodiments, the cooking oil has a TPM content of less than 24% after heating at 250° F. for three days. In some embodiments, the cooking oil comprises less than 5% free fatty acids after heating at 250° F. for 4 hours. In some embodiments, the cooking oil contains less than 3% of aldehydes after heating at 250° F. for 50 hours. In some embodiments, the cooking oil contains less than 1% of saturated aldehydes after heating at 250° F. for 50 hours. In some embodiments, the cooking oil contains less than 2% of α,β-unsaturated aldehydes after heating at 250° F. for 50 hours. In some embodiments, the cooking oil contains less than 0.5 mmol/mol FA of combined 4-hydrox/4-hydroperoxy-trans-2-alkenals after heating at 250° F. for 50 hours. In some embodiments, the cooking oil contains less than 5% w/w lipid oxidation products (LOP) after heating at 250° F. for 50 hours. In some embodiments, the cooking oil contains less than 350 μmol/L 4-hydroxy-trans-2-nonenal (HNE) after heating at 250° F. for 50 hours. In some embodiments, the cooking oil comprises a linoleic acid content is substantially negligible. In some embodiments, the linoleic acid content is below a detection limit. In some embodiments, the cooking oil is a yeast oil. In some embodiments, the cooking oil is a non-photosynthetic microbial oil. In some embodiments, wherein the cooking oil contains less than 5% oxidation products of linoleic acid. In some embodiments, wherein the cooking oil contains less than 3% 4-hydroxynonenal (HNE). In some embodiments, the cooking oil contains less than 5 ppm of acrolein. In some embodiments, the cooking oil comprising less than 5 ppm of crotonaldehyde. In some embodiments, the cooking oil comprising less than 100 ppm of detectable volatile aldehydes, such as alpha, beta-unsaturated aldehydes, including acrolein and crotonaldehyde. In some embodiments, a time required to increase the temperature of the piece of food to at least 150 F is less than a plant derived oil, optionally, wherein the plant derived oil is sunflower oil. In some embodiments, a time to cook the food in the cooking oil is the same as a time to cook the food in the plant derived cooking oil when a temperature of the cooking oil is less than a temperature of the plant derived oil, optionally, wherein the plant derived cooking oil is sunflower oil. The method of any of the preceding claims, wherein the cooking oil is resistant to decomposition into polar materials as measured by total polar material (TMP) in the oil when heated to 370 F, wherein the oil comprises a TMP of less than 20% after 6 days, wherein the oil comprises a TMP of less than 30% after 12 days, or wherein the oil comprises a TMP of less than 35% after 20 days. In some embodiments, the cooking oil prevents adhesion of a first particle of the food to a second particle of the food when cooked in the cooking oil.

In another aspect, the present disclosures provides a method of preparing a fried food. The method includes heating the cooking oil in the fryer to at least 250° F.; placing a piece of food in the cooking oil until the temperature of the piece of food increases to at least 150° F.; removing the fried food from the fryer. Aspects disclosed herein provide a method of preparing a fried food comprising heating a cooking oil to a temperature of at least 250 F, placing a food in the cooking oil, wherein the cooking oil prevents adhesion of a first particle of the food to a second particle of the food when cooked in the cooking oil. In some cases, the food is a meat, seafood, or vegetable. In some cases, the meat is chicken. In some cases, the seafood is fish. In some cases, the vegetable is a tuber. In some cases, the vegetable is a potato or onion. In some cases, the food is a processed food.

Aspects disclosed herein provide a method of preparing a fried food comprising: heating a cooking oil in the fryer to at least 180° F., wherein the oil comprises less than about 5 mmol/kg α,β-unsaturated aldehydes when heated to about 180° C., wherein the composition comprises a polyunsaturated acid content of less than about 5 mmol/kg; placing a piece of food in the cooking oil until the temperature of the piece of food increases to at least 150° F.; and removing the fried food from the fryer. In some embodiments, the cooking oil comprises a polyunsaturated fatty acid content of less than about 4 mmol/kg. In some embodiments, the cooking oil comprises a polyunsaturated fatty acid content of less than about 3.5 mmol/kg. In some embodiments, the cooking oil comprises a polyunsaturated fatty acid content of less than about 3 mmol/kg. In some embodiments, the cooking oil comprises a polyunsaturated fatty acid content of less than about 2.5 mmol/kg. In some embodiments, the cooking oil comprises a polyunsaturated fatty acid content of less than about 2.25 mmol/kg. In some embodiments, the cooking oil comprises a linoleic acid content of less than about 2.5 mmol/kg. In some embodiments, the cooking oil comprises a linoleic acid content of less than about 2.25 mmol/kg. In some embodiments, the cooking oil comprises a linoleic acid content of less than about 2 mmol/kg, or about 2 mmol/kg. In some embodiments, the cooking oil comprises a monounsaturated fatty acid content of at least 55 mmol/kg. In some embodiments, the cooking oil comprises a monounsaturated fatty acid content of at least 57.5 mmol/kg. In some embodiments, the cooking oil comprises a monounsaturated fatty acid content of about 60 mmol/kg. In some embodiments, the cooking oil comprises a saturated fatty acid content of less than about 3 mmol/kg. In some embodiments, the cooking oil comprises a saturated fatty acid content of less than about 2.75 mmol/kg. In some embodiments, the cooking oil comprises a saturated fatty acid content of about 2.5 mmol/kg. In some embodiments, the cooking oil comprises arachidic acid in an amount of less than about 0.07 mmol/kg. In some embodiments, the cooking oil comprises palmitic acid in an amount of less than about 1.5 mmol/kg. In some embodiments, the cooking oil comprises stearic acid in an amount of less than about 0.8 mmol/kg. In some embodiments, the cooking oil comprises less than about 2 mmol/kg α,β-unsaturated aldehydes when heated to about 180° C. In some embodiments, the cooking oil comprises less than about 1.8 mmol/kg α,β-unsaturated aldehydes when heated to about 180° C. In some embodiments, the cooking oil comprises less than about 2 mmol/kg α,β-unsaturated aldehydes when heated to about 180° C. for about 90 minutes or less. In some embodiments, the cooking oil comprises less than about 1.8 mmol/kg α,β-unsaturated aldehydes when heated to about 180° C. for about 90 minutes or less. In some embodiments, the cooking oil comprises less than about 50 mmol/kg aldehydes when heated to about 180° C. for about 90 minutes or less. In some embodiments, the cooking oil comprises essentially no α,β-unsaturated aldehydes when heated to about 180° C. for about 5 minutes or less. In some embodiments, the cooking oil comprises no detectable α,β-unsaturated aldehydes when heated to about 180° C. for about 5 minutes or less when measured using high-resolution proton (¹H) nuclear magnetic resonance (NMR). In some embodiments, the cooking oil comprises less than about 0.1 mmol/kg α,β-unsaturated aldehydes when heated to about 180° C. for about 10 minutes or less. In some embodiments, the cooking oil comprises less than about 0.35 mmol/kg α,β-unsaturated aldehydes when heated to about 180° C. for about 20 minutes or less. In some embodiments, the cooking oil comprises less than about 0.55 mmol/kg α,β-unsaturated aldehydes when heated to about 180° C. for about 30 minutes or less. In some embodiments, the cooking oil comprises less than about 1.5 mmol/kg α,β-unsaturated aldehydes when heated to about 180° C. for about 60 minutes or less. In some embodiments, the cooking oil comprises essentially no (Z)-2-Alkenals when heated to about 180° C. for about 20 minutes or less. In some embodiments, the cooking oil comprises no detectable (Z)-2-Alkenals when heated to about 180° C. for about 20 minutes or less when measured using high-resolution proton (¹H) nuclear magnetic resonance (NMR). In some embodiments, the cooking oil comprises less than about 0.15 mmol/kg (Z)-2-Alkenals when heated to about 180° C. for about 30 minutes or less. In some embodiments, the cooking oil comprises less than about 0.8 mmol/kg (Z)-2-Alkenals when heated to about 180° C. for about 60 minutes or less. In some embodiments, the cooking oil comprises less than about 1 mmol/kg (Z)-2-Alkenals when heated to about 180° C. for about 90 minutes or less. In some embodiments, the cooking oil comprises essentially no (Z,E)-2,4-Alkadienals when heated to about 180° C. for about 90 minutes or less. In some embodiments, the cooking oil comprises no detectable (Z,E)-2,4-Alkadienals when heated to about 180° C. for about 20 minutes or less when measured using high-resolution proton (¹H) nuclear magnetic resonance (NMR). In some embodiments, the cooking oil comprises essentially no 4-Hydroperoxy-/4-Hydroxy-(E)-2-alkenals when heated to about 180° C. for about 10 minutes or less. In some embodiments, the cooking oil comprises no detectable 4-Hydroperoxy-/4-Hydroxy-(E)-2-alkenals when heated to about 180° C. for about 10 minutes or less when measured using high-resolution proton (¹H) nuclear magnetic resonance (NMR). In some embodiments, the cooking oil comprises less than 0.1 mmol/kg 4-Hydroperoxy-/4-Hydroxy-(E)-2-alkenals when heated to about 180° C. for about 20 minutes or less. In some embodiments, the cooking oil comprises less than 0.4 mmol/kg 4-Hydroperoxy-/4-Hydroxy-(E)-2-alkenals when heated to about 180° C. for about 30 minutes or less. In some embodiments, the cooking oil comprises less than 0.4 mmol/kg 4-Hydroperoxy-/4-Hydroxy-(E)-2-alkenals when heated to about 180° C. for about 50 minutes or less. In some embodiments, the cooking oil comprises less than 0.8 mmol/kg 4-Hydroperoxy-/4-Hydroxy-(E)-2-alkenals when heated to about 180° C. for about 60 minutes or less. In some embodiments, the cooking oil comprises less than 1 mmol/kg 4-Hydroperoxy-/4-Hydroxy-(E)-2-alkenals when heated to about 180° C. for about 90 minutes or less. In some embodiments, the cooking oil comprises essentially no 4,5-Epoxy-(E)-2-alkenals when heated to about 180° C. for about 90 minutes or less. In some embodiments, the cooking oil comprises no detectable 4,5-Epoxy-(E)-2-alkenals when heated to about 180° C. for about 20 minutes or less when measured using high-resolution proton (¹H) nuclear magnetic resonance (NMR). In some embodiments, the cooking oil comprises less than 0.3 mmol/kg 4-(E,E)-2,4-Alkadienals when heated to about 180° C. for about 20 minutes or less. In some embodiments, the cooking oil comprises less than about 50 mmol/kg total aldehydes when heated to about 180° C. In some embodiments, the cooking oil comprises less than about 50 mmol/kg total aldehydes when heated to about 180° C. for about 90 minutes or less. In some embodiments, the cooking oil comprises less than about 40 mmol/kg total aldehydes when heated to about 180° C. for about 60 minutes or less. In some embodiments, the cooking oil comprises less than about 25 mmol/kg total aldehydes when heated to about 180° C. for about 30 minutes or less. In some embodiments, the cooking oil comprises less than about 15 mmol/kg total aldehydes when heated to about 180° C. for about 20 minutes or less. In some embodiments, the cooking oil comprises less than about 1 mmol/kg total aldehydes when heated to about 180° C. for about 10 minutes or less.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings (also “figure” and “FIG.” herein), of which:

FIG. 1 illustrates the aldehyde concentration of a product comprising an edible lipid when heated as described herein;

FIG. 2 illustrates the aldehyde concentration of a product comprising an edible lipid when heated as described herein;

FIG. 3 illustrates the aldehyde concentration of a product comprising an edible lipid when heated as described herein;

FIG. 4 illustrates the aldehyde concentration of a product comprising an edible lipid when heated as described herein;

FIG. 5 illustrates the aldehyde concentration of a product comprising an edible lipid when heated as described herein;

FIG. 6 illustrates the aldehyde concentration of a product comprising an edible lipid when heated as described herein;

FIG. 7 illustrates the aldehyde concentration of a product comprising an edible lipid when heated as described herein;

FIG. 8 illustrates a temperature of an edible lipid when heated as described herein compared to a conventional oil over time;

FIG. 9 illustrates TMP content of an edible lipid when heated as described herein compared to a conventional oil over time;

FIG. 10 illustrates power meter energy consumed by the edible lipid and a control oil.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “at most”, “less than,” or “less than or equal to” precedes the first numerical value in a series of two or more numerical values, the term “no more than,” “at most,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “about” when referring to a number or a numerical range generally means that the number or numerical range referred to is an approximation within experimental variability (or within statistical experimental error), and thus the number or numerical range may vary from, for example, between 1% and 15% of the stated number or numerical range.

### Overview

Fryer cooking oil can have a wide variety of quality parameters that may be affected by the composition and origin of the cooking oil. Even further, the composition of the cooking oil can be significantly altered through common frying and high temperature cooking practices. As a result, the cooking oil quality parameters are subject to change upon the composition change of the cooking oil. Provided herein is a fryer comprising a cooking oil that aims to have a composition that minimizes the generation of cytotoxic aldehydes and may be more readily safe for human ingestion.

### I. Cooking Oil Generation

In an aspect, the present disclosure provides a cooking oil for a fryer. The cooking oil may be generated through a variety of different process. Cooking oils may be extracted from, for example, nuts, seeds, fruits, grains, or legumes by extraction using mechanical processes and/or chemical processes. In some embodiments, the cooking oils may be generated by a microorganism. In some cases, the microorganism may be genetically modified. In some cases, the genetically modified organism may be any organism whose genetic material has been altered using one or more genetic engineering techniques. In some cases, the microorganism may not be genetically modified. The microorganism may be for example, microalgae, yeast, fungi, or bacteria, etc. The yeast, fungi, bacteria, and microalgae can be used to synthesize triacylglycerols (TAG), an essential component for cooking oils. The utilization of yeast, fungi, and bacteria for cooking oil may be advantageous over microalgae or vegetable oils. Cultivation of yeasts and these other microorganisms in comparison to cultivation of plants to produce vegetable oil may be less affected by environmental conditions, seasonal production or geographic locations. Additionally, yeast, fungi, and bacteria may grow faster than microalgae, and be more resistant against climatic and seasonal changes. In some cases, the trace compounds of cooking oil from yeast, fungi, and bacteria may be different than the trace compounds generated from microalgae and higher plants leading to a cooking oil fingerprint. In some cases, the cooking oil may be a generated from a non-photosynthetic microorganism. The non-photosynthetic microorganism may generate a cooking oil (e.g., a non-photosynthetic microbial cooking oil).

The cooking oil may be generated from yeast that may come from the genera Candida, Cryptococcus, Lipomyces, Rhodosporidium, Rhodotorula, Rhizopus, Trichosporon or Yarrowia, etc. The yeast may be, for example, Rhodosporidium toruloides, Lipomyces starkeyi, Rhodosporidium sp., Rhodotorula sp., Yarrowia sp., Cryptococcus sp., Lipomyces sp., Candida curvata, Rhodotorula glutinis, Rhodotula 110, Cryptococcus podzolicus, Trichosporon porosum, Pichia segobiensis, Trichosporonoides spathulata, Kodamaea ohmeri, Cryptococcus sp., Cryptococcus music, Lipomyces tetrasporus, Lipomyces sp, Cutaneotrichosporon oleaginosus, ATCC 20509, or Metschnikowia pulcherrim, etc. In some cases, the yeast may be a recombinant yeast. The cooking oil may be extracted from the yeast upon production.

Yeast may accumulate lipids intracellularly when a nutrient in the medium (e.g. the nitrogen or the phosphorus source) becomes limited and the carbon source is present in excess. In some cases, nitrogen limitation may be used to induce lipogenesis. The yeast may use one or more different carbon sources for the production of cell mass and/or lipids. These sources can be, for example, starch, ethanol, acetic acid, glucose, fructose, sucrose, raffinose, molasses, bagasse, xylose, glycerol, methanol, synthesis gas, carbon dioxide, carbon monoxide, formic acid, cellulose hydrolysates, and industrial, agricultural, food, and municipal organic wastes. In some cases, the source may be ethanol. In other cases, the source may be acetic acid. In some cases, the source may be a blend of carbon sources. In some cases, the source of the carbon source is from a fossil source while in others they are from a renewable bio-based source. The major lipid components of oleaginous yeasts may be triacylglycerols. The triacylglycerols may be composed of, for example, C16 and C18 series long chain fatty acids. The triacylglycerols may be as described elsewhere herein.

The cooking oil may come from a bacterium, such as an oleaginous bacterium. The bacterium may be, for example, Rhodococcus sp, Acetinobacter sp, Ralstonia sp., Gordinia sp., and Arthrobacter sp.

The cooking oil may come from a fungus, such as an oleaginous fungus. The fungus may be, for example, Cunninghamella echinulate, Mortierella alpina, Aspergillus niger, and Trichoderma reesia, Backusella sp, Piloira sp., Rhizopus sp., Thamnostylum sp. Mortierella sp., and Mucoroycota sp.

### II. Fryer Cooking Oil Compositions

In an aspect, the present disclosure provides a fryer containing one or more cooking oils. The cooking oil may include one or more triacylglycerides (TAG). The TAG may include a variety of contents. The TAG may include, for example, at least one or more of the following contents: polyunsaturated fatty acids (PUFA), monounsaturated fatty acids (MUFA), saturated fatty acids (SFA), C18:2 fatty acid, C18:1 fatty acid, C16:1 fatty acid, linoleic acid, oleic acid, palmitic acid, palmitoleic acid, stearic acid, myristic acid, lauric acid, and the like content, omega-9 fatty acids, omega-3 fatty acids, and omega-6 fatty acid. In some cases, the one or more contents may be provided in a variety of different combinations with a variety of different percentages described elsewhere herein. In some embodiments, at least one or more contents may be below a detection limit or considered negligible.

The TAG may include a polyunsaturated fatty acid content. An unsaturated fatty acid is a fatty acid that contains a carbon-double bond, and that double bond can be in the cis configuration or the trans configuration. A polyunsaturated fatty acid is a fatty acid containing more than one carbon-carbon double bonds. The polyunsaturated fatty acid content may be a percentage relative to the total TAG content of the cooking oil. The polyunsaturated fatty acids (PUFA) content may be less than about 1.0%, 2.0%, 3.0%, 4.0%, or 5.0% The PUFA content may be more than about 0.1%, 0.5%, 1.0%, 1.5%, 2.0%, 2.5%, or 3.0%. The PUFA content may be from about 0.1% to 5.0%, 0.5% to 3.0%, or 1.0% to 2.0%. The PUFA content may be less than 2.0%. In some embodiments, the PUFA content may be below a detection limit or considered negligible. In some cases, the percentage may be relative to a total weight percent. In some cases, there may be no PUFA.

The TAG may include a linoleic acid content. The linoleic acid content may be a percentage relative to the total TAG content of the cooking oil. The linoleic acid content may be less than about 2.0%, 1.5%, 1.0%, 0.5%, or 0.2%. The linoleic acid content may be more than about 0.2%, 0.5%, 1.0%, 1.5%, or 2.0%. The linoleic acid content may be from about 0.2% to 2.0%, 0.2% to 1.0%, 0.2% to 0.5%, or 0.5% to 1.5%. The linoleic acid content may be less than 1%. In some embodiments, the linoleic acid content may be below a detection limit or considered negligible. In some cases, the percentage may be relative to a total weight percent. In some cases, there may be no linoleic acid.

The TAG may have a given carbon length chain. The carbon length chain may include at least 8, 10, 12, 13, 14, 15, 16, 17, 18, 19, 20, 21, 22, or more carbon atoms. The carbon length chain may include at most 22, 21, 20, 19, 18 17, 16, 15, 14, 12, 10, 8 or fewer carbon atoms. The carbon length chain may include from about 8 to 22 carbon atoms, 10 to 22 carbon atoms, 12 to 22 carbon atoms, 14 to 20 carbon atoms, 16 to 18 carbon atoms, or 16 to 20 carbon atoms.

The TAG may have one or more carbon-carbon double bonds. The number of these double bonds may depend on the carbon length chain of the TAG. The TAG may have at least 1, 2, 3, 4, 5, or more double bonds. The TAG may have at most 5, 4, 3, 2, or 1 double bonds. The TAG may have 0 double bonds. The TAG may have from 1 to 5 double bonds, 1 to 3 double bonds, 1 to 2 double bonds, 0 to 1 double bonds, 0 to 2 double bonds, or 2 to 3 double bonds.

The cooking oil may have a free fatty acid content. The free fatty acid content of the cooking oil may be less than 5% (w/w) after heating for 4 hrs at a temperature of 250° F. In some cases, the free fatty acid content value may be at less than about 20%, 10%, 7%, 5%, 3%, or less. In some cases, the free fatty acid content value may be more than about 3%, 5%, 7%, 10%, 20%, or more. In some cases, the free fatty acid content value may be from about 3% to 20%, 5% to 20%, 10% to 20%, or 3% to 5%. In some cases, the free fatty acid content may be measured after at least about 4 hours (hrs), 12 hrs, 24 hrs, 3 days, 1 week, or more. In some cases, the free fatty acid content may be measured after at most about 1 week, 3 days, 24 hrs, 12 hrs, 4 hrs, or less. In some cases, the free fatty acid content may be measured from about 4 hrs to 1 week, 4 hrs to 3 days, 4 hrs to 24 hrs, or 4 hrs to 12 hrs. The free fatty acid content of the cooking oil may be measured after heating at a temperature of at least about 250° F., 300° F., 350° F., 400° F., 450° F., 500° F., or more. The free fatty acid content of the cooking oil may be measured after heating at a temperature of at most about 500° F., 450° F., 400° F., 350° F., 300° F., 250° F., or less. The free fatty acid content of the cooking oil may be measured after heating at a temperature from about 250° F. to 500° F., 250° F. to 350° F., or 250° F. to 300° F.

The TAG may include a C18:2 fatty acid content wherein 18 denotes the quantity of carbon atoms in the fatty acid and 2 denotes the quantity of doubles bounds in the carbon chain. The a C18:2 fatty acid content may be a percentage relative to the total TAG content of the cooking oil. The C18:2 fatty acid content may be less than about 2.0%, 1.5%, 1.0%, 0.5%, or 0.2%. The C18:2 fatty acid content may be more than about 0.2%, 0.5%, 1.0%, 1.5%, or 2.0%. The C18:2 fatty acid content may be from about 0.2% to 2.0%, 0.2% to 1.0%, 0.2% to 0.5%, or 0.5% to 1.5%. The C18:2 fatty acid content may be less than 1%. In some embodiments, the C18:2 fatty acid content may be below a detection limit or considered negligible. In some cases, the percentage may be relative to a total weight percent. In some cases, there is no C18:2 fatty acid content.

The TAG may include a C18:1 fatty acid content. The a C18:1 fatty acid content may be a percentage relative to the total TAG content of the cooking oil. The C18:1 fatty acid content may be more than about 50%, 60%, 70%, 80%, or 90%. The C18:1 fatty acid content may be less than about 90%, 80%, 70%, 60%, or 50%. The C18:1 fatty acid content may from about 50% to 90%, 50% to 70%, 60% to 90%, 70% to 90%, 70% to 80%, or 80% to 90%. The C18:1 fatty acid content may be more than about 70%. In some embodiments, the C18:1 fatty acid content may be below a detection limit or considered negligible. In some cases, the percentage may be relative to a total weight percent.

The TAG may include a C18:0 fatty acid content. The a C18:0 fatty acid content may be a percentage relative to the total TAG content of the cooking oil. The C18:0 fatty acid content may be more than about 10%, 20%, or 30%. The C18:0 fatty acid content may be less than about 30%, 20%, or 10%. The C18:0 fatty acid content may from about 10% to 30%, 20% to 30%, or 10% to 30%. The C18:0 fatty acid content may more than about 70%. In some embodiments, the C18:0 fatty acid content may be below a detection limit or considered negligible. In some cases, the percentage may be relative to a total weight percent.

The TAG may include a C16:1 fatty acid content. The C16:1 fatty acid content may be a percentage relative to the total TAG content of the cooking oil. The C16:1 fatty acid content may be more than about 10%, 20%, 30%, 40%, 50%, or 60%. The C16:1 fatty acid content may be less than about 60%, 50%, 40%, 30%, 20%, or 10%. The C16:1 fatty acid content may from about 10% to 60%, 10% to 50%, 10% to 40%, 10% to 30%, or 10% to 20%. The C16:1 fatty acid content may more than about 10%. In some embodiments, the C16:1 fatty acid content may be below a detection limit or considered negligible. In some cases, the percentage may be relative to a total weight percent.

The TAG may include one or more OMEGA fatty acids. An OMEGA fatty acid is an unsaturated fatty acid in which the carbon-carbon double bond is located a defined number of carbons from the OMEGA (non-reducing) end of the fatty acid carbon chain (e.g., methyl). The OMEGA fatty acids may be, for example, OMEGA-9, OMEGA-6, or OMEGA-3, which have unsaturations 9, 6, and 3 carbons from the non-reducing end of the fatty acid chain, respectively. The OMEGA fatty acid content may be a percentage relative to the total TAG content of the cooking oil. The OMEGA fatty acid content may be less than about 2.0%, 1.5%, 1.0%, 0.5%, or 0.2%. The OMEGA fatty acid content may be more than about 0.2%, 0.5%, 1.0%, 1.5%, or 2.0%. The OMEGA fatty acid content may be from about 0.2% to 2.0%, 0.2% to 1.0%, 0.2% to 0.5%, or 0.5% to 1.5%. The OMEGA fatty acid content may be less than 1%. In some embodiments, the OMEGA content may be below a detection limit or considered negligible. In some cases, the percentage may be relative to a total weight percent. In some cases, there is no OMEGA fatty acid content.

The TAG may include an OMEGA-9 fatty acid content. The OMEGA-9 fatty acid content may be a percentage relative to the total TAG content of the cooking oil. The OMEGA-9 fatty acid content may be less than about 2.0%, 1.5%, 1.0%, 0.5%, or 0.2%. The OMEGA-9 fatty acid content may be more than about 0.2%, 0.5%, 1.0%, 1.5%, or 2.0%. The OMEGA-9 fatty acid content may be from about 0.2% to 2.0%, 0.2% to 1.0%, 0.2% to 0.5%, or 0.5% to 1.5%. The OMEGA-9 fatty acid content may be less than 1%. In some embodiments, the OMEGA-9 content may be below a detection limit or considered negligible. In some cases, the percentage may be relative to a total weight percent. In some cases, there is no OMEGA-9 fatty acid content.

The TAG may include an OMEGA-6 fatty acid content. The OMEGA-6 fatty acid content may be a percentage relative to the total TAG content of the cooking oil. The OMEGA-6 fatty acid content may be less than about 2.0%, 1.5%, 1.0%, 0.5%, or 0.2%. The OMEGA-6 fatty acid content may be more than about 0.2%, 0.5%, 1.0%, 1.5%, or 2.0%. The OMEGA-6 fatty acid content may be from about 0.2% to 2.0%, 0.2% to 1.0%, 0.2% to 0.5%, or 0.5% to 1.5%. The OMEGA-6 fatty acid content may be less than 1%. In some embodiments, the omega-6 content may be below a detection limit or considered negligible. In some cases, the percentage may be relative to a total weight percent. In some cases, there is no OMEGA-6 fatty acid content.

The TAG may include an omega-3 fatty acid content. The OMEGA-3 fatty acid content may be a percentage relative to the total TAG content of the cooking oil. The OMEGA-3 fatty acid content may be less than about 2.0%, 1.5%, 1.0%, 0.5%, or 0.2%. The OMEGA-6 fatty acid content may be more than about 0.2%, 0.5%, 1.0%, 1.5%, or 2.0%. The OMEGA-3 fatty acid content may be from about 0.2% to 2.0%, 0.2% to 1.0%, 0.2% to 0.5%, or 0.5% to 1.5%. The OMEGA-3 fatty acid content may be less than 1%. In some embodiments, the omega-6 content may be below a detection limit or considered negligible. In some cases, the percentage may be relative to a total weight percent. In some cases, there is no OMEGA-3 fatty acid content.

The TAG may include a monounsaturated fatty acids (MUFA) content. The MUFA content may be a percentage relative to the total TAG content of the cooking oil. The MUFA content may be more than about 40%, 50%, 60%, 70%, 80%, 90% or 95%. The MUFA content may be less than about 95%, 90%, 80%, 70%, 60%, or 55%. The MUFA content may from about 40% to 95%, 50% to 95%, 50% to 75%, 50% to 55%, 40% to 95%, 50% to 95%, 50% to 75%, 50% to 55%. The MUFA content may be more than about 50%. The MUFA content may be from about 50% to 95%. In some embodiments, the MUFA content may be below a detection limit or considered negligible. In some cases, the percentage may be relative to a total weight percent.

The TAG may include a saturated fatty acids (SFA) content. The SFA content may be a percentage relative to the total TAG content of the cooking oil. The SFA content may be more than about 1%, 5%, 10%, 20%, 30%, 40%, 50%, 60%, 70%, 80%, or 90%. The SFA content may be less than about 90%, 80%, 70%, 60%, 50%, 40%, 30%, 20%, 10%, 5%, or 1%. The SFA content may be from about 1% to 30%, 1% to 15%, 5% to 30%, 5% to 15%, 40% to 90%, 40% to 80%, 40% to 70%, 40% to 50%, 50% to 90%, 60% to 90%, or 70% to 90%. The SFA content may be more than about 40%. The SFA content may be from about 40% to 90%. The SFA content may be from about 5% to 15%. In some embodiments, the SFA content may be below a detection limit or considered negligible. In some cases, the percentage may be relative to a total weight percent. In some cases, there may be no SFA content.

The TAG may include a variety of contents. The TAG may include, for example, at least one or more of the following contents: PUFA, MUFA, SFA, C18:2 fatty acid, C18:1 fatty acid, linoleic acid content, C16:1 fatty acid, omega-3 fatty acid, omega-6 fatty acid, and omega-6 fatty acid. In some cases, the TAG may include at least a SFA content and a MUFA content. For example, the SFA content may be from about 5% to 90% and the MUFA content may be from about 10% to 90%. In some cases, the SFA content may be from about 20% to 90% and the MUFA content may be from about 10% to 90%. In some cases, the TAG may include at least a PUFA content, a C18:2 fatty acid content, and an omega-6 fatty acid content. For example, the PUFA content may be from about 1% to 2%, the C18:2 fatty acid content may be from 0.5% to 1.0%, and the omega-6 fatty acid content may be from about 0.5% to 1.0%. In some cases, the TAG may include a MUFA content, a PUFA content, and a C18:2 fatty acid content. For example, the MUFA content may be from 50% to 90%, the PUFA content may be from 1% to 2%, and the C18:2 fatty acid content from 0.5% to 1.0%. In some cases, the TAG may include a MUFA content, a PUFA content, and a C18:1 fatty acid content. In some cases, the TAG may include a C18:2 fatty acid content (e.g., 8, C18:1 fatty acid content, and a C18:0 fatty acid content. In some embodiments, the one or more contents may be below a detection limit or considered negligible. In some embodiments, the temperature of the cooking oil is at least 5, 10, 15, 20, 25, or 30 F less than the temperature of the conventional oil, to achieve the same time to cook the food in the cooking oil as the conventional oil. In some embodiments, the cooking oil comprises a specific heat which is less than a conventional cooking oil and a food, wherein a time to cook the food in the cooking oil is less than a time to cook the food in the conventional cooking oil, optionally, wherein the conventional cooking oil is sunflower oil. In some embodiments, the cooking oil is resistant to decomposition into polar materials as measured by total polar material (TMP) in the oil when heated. In some embodiments, the wherein the TMP comprises peroxides, epoxides, alcohols, ketones, aldehydes, acids, dimers, polymers, or combinations thereof. In some embodiments, the cooking oil prevents adhesion of a first particle of the food to a second particle of the food when cooked in the cooking oil. In some embodiments, the cooking oil comprises at least 90% oleic acid, and less than 4% saturated fatty acids and less than 3% polyunsaturated fatty acids, wherein a time to cook the food in the cooking oil is less than a time to cook the food in the conventional cooking oil. In some embodiments, the cooking oil is resistant to decomposition into polar materials as measured by total polar material (TMP) in the oil when heated to 370 F, wherein the oil comprises a TMP of less than 20% after 6 days, wherein the oil comprises a TMP of less than 30% after 12 days, or wherein the oil comprises a TMP of less than 35% after 20 days.

In some embodiments, the microbially derived oil comprises a triacylglyceride (TAG) with a polyunsaturated fatty acids (PUFA) content of less than 2%. In some embodiments, the TAG has a C18:2 fatty acid content of less than 1%. In some embodiments, the TAG has a linoleic acid content of less than 1%. In some embodiments, the microbially derived oil is a non-photosynthetic microbial oil. In some embodiments, the microbially derived oil comprises less than 100 ppm of detectable volatile aldehydes, such as alpha, beta-unsaturated aldehydes, including acrolein and crotonaldehyde. In some embodiments, the microbially derived oil comprises a specific heat which is less than a plant derived cooking oil and a food, wherein a time to cook the food in the microbially derived oil is less than a time to cook the food in the plant derived cooking oil, optionally, wherein the plant derived cooking oil is sunflower oil. In some embodiments, the microbially derived oil is resistant to decomposition into polar materials as measured by total polar material (TMP) in the oil when heated. In some embodiments, the TMP comprises peroxides, epoxides, alcohols, ketones, aldehydes, acids, dimers, polymers, or combinations thereof. In some embodiments, the microbially derived oil prevents adhesion of a first particle of the food to a second particle of the food when cooked in the microbially derived oil. In some embodiments, the microbially derived oil comprises at least 90% oleic acid, and less than 4% saturated fatty acids and less than 3% polyunsaturated fatty acids, wherein a time to cook the food in the microbially derived oil is less than a time to cook the food in the plant derived cooking oil. Aspects disclosed herein provide a method of using the fryer of any one of the preceding claims comprising: cooking one or more food items in the fryer for a period of time. In some embodiments, the fryer and/or the oil in the fryer comprises less aldehydes as compared to a fryer comprising a plant derived oil used to cook identical food items. In some embodiments, the method comprises using a reduced temperature for cooking as compared to a fryer comprising a plant derived oil. In some embodiments, the cooking at reduced temperature wherein the method prevents or reduces adhesion of a first particle of the food to a second particle of the food when cooked in the microbially derived oil. In some embodiments, the method increases a transfer of heat to the food and/or reduces a cooking time of the food as compared to a plant-derived oil.

### III. Fryer Cooking Oil Degradation Products

The cooking oil may include one or more degradation products. The one or more degradation products may be one or more oxidation products generated by heating/frying the cooking oil. The oxidation products may be generated from the one or more TAG of the cooking oil. For example, the one or more generated oxidation products may be generated from heating/frying PUFA (e.g., linoleic acid). The oxidation products content may be a percentage relative to the total TAG content of the cooking oil. The percentage of oxidation products in the cooking oil may be less than 20%, 10%, 5%, 3%, 1%, or less. The percentage of oxidation products in the cooking oil may be more than 0.1%, 1%, 3%, 5%, 10%, 20%, or more. The percentage of oxidation products in the cooking oil may be from about 0.1% to 20%, 0.1% to 10%, 0.1% to 3%, 0.1% to 1%. The percentage of oxidation products generated may be below a detection limit or considered negligible. In some cases, the percentage may be relative to a total weight percent.

The cooking oil may include one or more lipid oxidation products (LOP). The lipid oxidation products may be provided as a weight percent of a solution (% w/w). The lipid oxidation products may be, for example, acrolein, 4-hydroxy-trans-nonenal, 4-hydroxy-trans-hexanal (HNE), crotonaldehyde, and malondialdehyde (MDA), etc. The cooking oil may contain less than 10% w/w LOP after heating at 250° F. for 50 hours. The LOP of the cooking oil may be less than 10% w/w, 5% w/w, 3% w/w, 1% w/w, or less. The LOP of the cooking oil may be more than 1% w/w, 3% w/w, 5% w/w, 10% w/w, or more. The LOP of the cooking oil may be from about 1% w/w to 10% w/w, 1% w/w to 5% w/w, 3% w/w to 10% w/w, or 3% w/w to 5% w/w. The LOP of the cooking oil may be measured after heating for 25 hrs, 50 hrs, 100 hrs, 200 hrs, 300 hrs, 500 hrs, 1000 hrs, or more. The LOP of the cooking oil may be measured after heating for at most about 1000 hrs, 500 hrs, 300 hrs, 200 hrs, 100 hrs, 50 hrs, 25 hrs, or less. The LOP of the cooking oil may be measured after heating at a temperature of at least about 250° F., 300° F., 350° F., 400° F., 450° F., 500° F., or more. The LOP of the cooking oil may be measured after heating at a temperature of at most about 500° F., 450° F., 400° F., 350° F., 300° F., 250° F., or less. The LOP of the cooking oil may be measured after heating at a temperature from about 250° F. to 500° F., 250° F. to 350° F., or 250° F. to 300° F.

The oxidation products may be generated from linoleic acid. The oxidation products content generated from linoleic acid may be a percentage relative to the total TAG content of the cooking oil. The percentage of oxidation products generated from linoleic acid in the cooking oil may be less than 20%, 10%, 5%, 3%, 1%, or less. The percentage of oxidation products in the cooking oil generated from linoleic acid may be more than 0.1%, 1%, 3%, 5%, 10%, 20%, or more. The percentage of oxidation products in the cooking oil may be from about 0.10% to 20%, 0.1% to 10%, 0.1% to 3%, 0.1% to 1%. The percentage of oxidation products generated may be below a detection limit or considered negligible. In some cases, the percentage may be relative to a total weight percent.

The cooking oil may contain less than 10% w/w of oxidation products generated from linoleic acid after heating at 250° F. for 50 hours. The oxidation products generated from linoleic acid of the cooking oil may be less than 10% w/w, 5% w/w, 3% w/w, 1% w/w, or less. The oxidation products generated from linoleic acid of the cooking oil may be more than 1% w/w, 3% w/w, 5% w/w, 10% w/w, or more. The oxidation products generated from linoleic acid of the cooking oil may be from about 1% w/w to 10% w/w, 1% w/w to 5% w/w, 3% w/w to 10% w/w, or 3% w/w to 5% w/w. The oxidation products generated from linoleic acid of the cooking oil may be measured after heating for about 25 hrs, 50 hrs, 100 hrs, 200 hrs, 300 hrs, 500 hrs, 1000 hrs, or more. The oxidation products generated from linoleic acid of the cooking oil may be measured after heating for at most about 1000 hrs, 500 hrs, 300 hrs, 200 hrs, 100 hrs, 50 hrs, 25 hrs, or less. The oxidation products generated from linoleic acid of the cooking oil may be measured after heating at a temperature of at least about 250° F., 300° F., 350° F., 400° F., 450° F., 500° F., or more. The oxidation products generated from linoleic acid of the cooking oil may be measured after heating at a temperature of at most about 500° F., 450° F., 400° F., 350° F., 300° F., 250° F., or less. The oxidation products generated from linoleic acid of the cooking oil may be measured after heating at a temperature from about 250° F. to 500° F., 250° F. to 350° F., or 250° F. to 300° F.

In some embodiments, the LOP may be 4-hydroxy-trans-2-nonenal (HNE). The 4-hydroxy-trans-2-nonenal (HNE) of the cooking oil may contain less than 350 μmol/L after heating at 250° F. for 50 hours. The HNE of the cooking oil may be less 1000 μmol/L, 350 μmol/L, 100 μmol/L, 50 μmol/L, or less. The HNE of the cooking oil may be more than 50 μmol/L, 100 μmol/L, 350 μmol/L, 1000 μmol/L, or more. The HNE of the cooking oil may be from about 50 mol/L to 1000 μmol/L, 100 μmol/L to 500 μmol/L, 100 μmol/L to 350 μmol/L, 350 μmol/L to 1000 μmol/L, or 350 μmol/L to 500 μmol/L.

The cooking oil may contain 4-hydroxynonenal (HNE). The percentage of HNE may be a weight percentage relative to cooking oil. The percentage of HNE in the cooking oil may be less than about 10%, 5%, 3%, 1%, 0.1%, or less. The percentage of HNE in the cooking oil may be more than about 0.1%, 1%, 3%, 5%, 10%, or more. The percentage of HNE in the cooking oil may be from about 0.1% to 10%, 0.1% to 3%, 0.1% to 1%. In some embodiments, the one or more contents may be below a detection limit or considered negligible.

The cooking oil may include one or more aldehydes. The aldehydes may be, for example, unsaturated aldehydes, saturated aldehydes and/or α,β-unsaturated aldehydes, etc. The amount of aldehydes in the cooking oil may be less than 50 parts per million (ppm), 10 ppm, 5 ppm, 1 ppm, 0.1 ppm, or less. The amount of aldehydes in the cooking oil may be more than 0.1 ppm, 1 ppm, 5 ppm, 10 ppm, 50 ppm or more. The amount of aldehydes may be from about 0.1 ppm to 50 ppm, 0.1 ppm to 10 ppm, or 0.1 ppm to 1 ppm.

The cooking oil may contain less than 3% (w/w) of aldehydes after heating for 50 hours at 250° F. The aldehyde content of the cooking oil may be less than 10%, 5%, 3%, 1%, or less. The aldehyde content of the cooking oil may be more than 1%, 3%, 5%, 10%, or more. The aldehyde content of the cooking oil may be from about 1% to 10%, 1% to 5%, 3% to 10%, or 3% to 5%. The aldehyde content of the cooking oil may be measured after heating for about 25 hrs, 50 hrs, 100 hrs, 200 hrs, 300 hrs, 500 hrs, 1000 hrs, or more. The aldehyde content of the cooking oil may be measured after heating for at most about 1000 hrs, 500 hrs, 300 hrs, 200 hrs, 100 hrs, 50 hrs, 25 hrs, or less. The aldehyde content of the cooking oil may be measured after heating at a temperature of at least about 250° F., 300° F., 350° F., 400° F., 450° F., 500° F., or more. The aldehyde content of the cooking oil may be measured after heating at a temperature of at most about 500° F., 450° F., 400° F., 350° F., 300° F., 250° F., or less. The aldehyde content of the cooking oil may be measured after heating at a temperature from about 250° F. to 500° F., 250° F. to 350° F., or 250° F. to 300° F.

The cooking oil may include one or more aldehydes. The aldehyde may be acrolein and/or crotonaldehyde. The amount of acrolein in the cooking oil may be less than 50 parts per million (ppm), 10 ppm, 5 ppm, 1 ppm, 0.1 ppm, or less. The amount of acrolein in the cooking oil may be more than 0.1 ppm, 1 ppm, 5 ppm, 10 ppm, 50 ppm or more. The amount of acrolein may be from about 0.1 ppm to 50 ppm, 0.1 ppm to 10 ppm, or 0.1 ppm to 1 ppm. The amount of crotonaldehyde in the cooking oil may be less than 50 parts per million (ppm), 10 ppm, 5 ppm, 1 ppm, 0.1 ppm, or less. The amount of crotonaldehyde in the cooking oil may be more than 0.1 ppm, 1 ppm, 5 ppm, 10 ppm, 50 ppm or more. The amount of crotonaldehyde may be from about 0.1 ppm to 50 ppm, 0.1 ppm to 10 ppm, or 0.1 ppm to 1 ppm.

In some embodiments, the cooking oil may include less than 100 ppm of detectable volatile aldehydes, such as alpha, beta-unsaturated aldehydes, including acrolein and crotonaldehyde. In some embodiments, the cooking oil may include more than 100 ppm of detectable volatile aldehydes, such as alpha, beta-unsaturated aldehydes, including acrolein and crotonaldehyde.

The cooking oil may include one or more α,β-unsaturated aldehydes. The cooking oil may contain less than 2% (w/w) of α,β-unsaturated aldehyde after heating for 50 hours at 250° F. The α,β-unsaturated aldehyde content of the cooking oil may be less than 5%, 3%, 2%, 1% or less. The α,β-unsaturated aldehyde content of the cooking oil may be more than 1%, 2%, 3%, 5%, or more. The α,β-unsaturated aldehydes content of the cooking oil may be from about 1% to 2%, 1% to 3%, 1% to 5%, 2% to 3%, or 3% to 5%. The α,β-unsaturated aldehydes content of the cooking oil may be measured after heating for 25 hrs, 50 hrs, 100 hrs, 200 hrs, 300 hrs, 500 hrs, 1000 hrs, or more. The α,β-unsaturated aldehyde content of the cooking oil may be measured after heating for at most about 1000 hrs, 500 hrs, 300 hrs, 200 hrs, 100 hrs, 50 hrs, 25 hrs, or less. The α,β-unsaturated aldehyde content of the cooking oil may be measured after heating at a temperature of at least about 250° F., 300° F., 350° F., 400° F., 450° F., 500° F., or more. The α,β-unsaturated aldehyde content of the cooking oil may be measured after heating at a temperature of at most about 500° F., 450° F., 400° F., 350° F., 300° F., 250° F., or less. The α,β-unsaturated aldehyde content of the cooking oil may be measured after heating at a temperature from about 250° F. to 500° F., 250° F. to 350° F., or 250° F. to 300° F.

The cooking oil may include one or more saturated aldehydes. The cooking oil may contain less than 1% (w/w) of saturated aldehydes after heating for 50 hours at 250° F. The saturated aldehyde content of the cooking oil may be less than 5%, 3%, 1%, 0.5% or less. The saturated aldehyde content of the cooking oil may be more than 0.5%, 1%, 3%, 5%, or more. The saturated aldehyde content of the cooking oil may be from about 0.5% to 3%, 1% to 5%, or 3% to 5%. The saturated aldehyde content of the cooking oil may be measured after heating for about 25 hours (hrs), 50 hrs, 100 hrs, 200 hrs, 300 hrs, 5000 hrs, 1000 hrs, or more. The saturated aldehyde content of the cooking oil may be measured after heating for at most about 1000 hrs, 500 hrs, 300 hrs, 200 hrs, 100 hrs, 50 hrs, 25 hrs, or less. The saturated aldehyde content of the cooking oil may be measured after heating at a temperature of at least about 250° F., 300° F., 350° F., 400° F., 450° F., 500° F., or more. The saturated aldehyde content of the cooking oil may be measured after heating at a temperature of at most about 500° F., 450° F., 400° F., 350° F., 300° F., 250° F., or less. The saturated aldehyde content of the cooking oil may be measured after heating at a temperature from about 250° F. to 500° F., 250° F. to 350° F., or 250° F. to 300° F.

The cooking oil may contain less than about 0.5 mmol/mol of combined 4-hydrox/4-hydroperoxy-trans-2-alkenals after heating for 50 hours (hrs) at a temperature of 250° F. The combined 4-hydrox/4-hydroperoxy-trans-2-alkenals may be less than about 5.0 mmol/mol, 2.0 mmol/mol, 1.0 mmol/mol, 0.5 mmol/mol, 0.1 mmol/mol or less. The combined 4-hydrox/4-hydroperoxy-trans-2-alkenals may be more than about 0.1 mmol/mol, 0.5 mmol/mol, 1.0 mmol/mol, 2.0 mmol/mol, 5.0 mmol/mol, or more. In some cases, the combined 4-hydrox/4-hydroperoxy-trans-2-alkenals may be from about 0.1 mmol/mol to 5.0 mmol/mol, 0.1 mmol/mol to 1.0 mmol/mol, 0.5 mmol/mol to 2.0 mmol/mol, or 0.5 mmol/mol to 1.0 mmol/mol. In some cases, the combined 4-hydrox/4-hydroperoxy-trans-2-alkenals may be measured after at most about 1000 hours (hrs), 500 hrs, 300 hrs, 200 hrs, 100 hrs, 50 hrs, 25 hrs, or less. In some cases, the combined 4-hydrox/4-hydroperoxy-trans-2-alkenals may be measured after at least about 25 hrs, 50 hrs, 100 hrs, 200 hrs, 300 hrs, 500 hrs, 1000 hrs, or more. In some cases, the combined 4-hydrox/4-hydroperoxy-trans-2-alkenals may be measured after from about 25 hrs to 300 hrs, 25 to 50 hrs, 50 hrs to 100 hrs, 100 hrs to 300 hrs, or 300 hrs to 1000 hrs. For example, the cooking oil may contain less than 0.5 mmol/mol of combined 4-hydrox/4-hydroperoxy-trans-2-alkenals after heating at 250° F. for 50 hours. The combined 4-hydrox/4-hydroperoxy-trans-2-alkenals content of the cooking oil may be measured after heating at a temperature of at least about 250° F., 300° F., 350° F., 400° F., 450° F., 500° F., or more. The combined 4-hydrox/4-hydroperoxy-trans-2-alkenals content of the cooking oil may be measured after heating at a temperature of at most about 500° F., 450° F., 400° F., 350° F., 300° F., 250° F., or less. The combined 4-hydrox/4-hydroperoxy-trans-2-alkenals content of the cooking oil may be measured after heating at a temperature from about 250° F. to 500° F., 250° F. to 350° F., or 250° F. to 300° F.

The cooking oil may include a leukotoxin. The cooking oil may contain less than 2% (w/w) of a leukotoxin after heating for 50 hours at 250° F. The leukotoxin content of the cooking oil may be less than about 5%, 3%, 2%, 1% or less. The leukotoxin content of the cooking oil may be more than about 1%, 2%, 3%, 5%, or more. The leukotoxin content of the cooking oil may be from about 1% to 2%, 1% to 3%, 1% to 5%, 2% to 3%, or 3% to 5%. The leukotoxin content of the cooking oil may be measured after heating for about 25 hrs, 50 hrs, 100 hrs, 200 hrs, 300 hrs, 500 hrs, 1000 hrs, or more. The leukotoxin content of the cooking oil may be measured after heating for at most about 1000 hrs, 500 hrs, 300 hrs, 200 hrs, 100 hrs, 50 hrs, 25 hrs, or less. The leukotoxin content of the cooking oil may be measured after heating at a temperature of at least about 250° F., 300° F., 350° F., 400° F., 450° F., 500° F., or more. The leukotoxin content of the cooking oil may be measured after heating at a temperature of at most about 500° F., 450° F., 400° F., 350° F., 300° F., 250° F., or less. The leukotoxin content of the cooking oil may be measured after heating at a temperature from about 250° F. to 500° F., 250° F. to 350° F., or 250° F. to 300° F.

The cooking oil may include a leukotoxin diol. The cooking oil may contain less than 2% (w/w) of a leukotoxin diol after heating for 50 hours at 250° F. The leukotoxin diol content of the cooking oil may be less than about 5%, 3%, 2%, 1% or less. The leukotoxin diol content of the cooking oil may be more than about 1%, 2%, 3%, 5%, or more. The leukotoxin diol content of the cooking oil may be from about 1% to 2%, 1% to 3%, 1% to 5%, 2% to 3%, or 3% to 5%. The leukotoxin diol content of the cooking oil may be measured after heating for about 25 hrs, 50 hrs, 100 hrs, 200 hrs, 300 hrs, 500 hrs, 1000 hrs, or more. The leukotoxin diol content of the cooking oil may be measured after heating for at most about 1000 hrs, 500 hrs, 300 hrs, 200 hrs, 100 hrs, 50 hrs, 25 hrs, or less. The leukotoxin diol content of the cooking oil may be measured after heating at a temperature of at least about 250° F., 300° F., 350° F., 400° F., 450° F., 500° F., or more. The leukotoxin diol content of the cooking oil may be measured after heating at a temperature of at most about 500° F., 450° F., 400° F., 350° F., 300° F., 250° F., or less. The leukotoxin diol content of the cooking oil may be measured after heating at a temperature from about 250° F. to 500° F., 250° F. to 350° F., or 250° F. to 300° F.

The cooking oil may include leucocidin. The cooking oil may contain less than 2% (w/w) of a leucocidin after heating for 50 hours at 250° F. The leucocidin content of the cooking oil may be less than about 5%, 3%, 2%, 1% or less. The leucocidin content of the cooking oil may be more than about 1%, 2%, 3%, 5%, or more. The leucocidin content of the cooking oil may be from about 1% to 2%, 1% to 3%, 1% to 5%, 2% to 3%, or 3% to 5%. The leucocidin of the cooking oil may be measured after heating for about 25 hrs, 50 hrs, 100 hrs, 200 hrs, 300 hrs, 500 hrs, 1000 hrs, or more. The leucocidin of the cooking oil may be measured after heating for at most about 1000 hrs, 500 hrs, 300 hrs, 200 hrs, 100 hrs, 50 hrs, 25 hrs, or less. The leucocidin content of the cooking oil may be measured after heating at a temperature of at least about 250° F., 300° F., 350° F., 400° F., 450° F., 500° F., or more. The leucocidin content of the cooking oil may be measured after heating at a temperature of at most about 500° F., 450° F., 400° F., 350° F., 300° F., 250° F., or less. The leucocidin content of the cooking oil may be measured after heating at a temperature from about 250° F. to 500° F., 250° F. to 350° F., or 250° F. to 300° F.

In some embodiments, the microbially derived oil is resistant to decomposition into polar materials as measured by total polar material (TMP) in the oil when heated to 370 F, wherein the oil comprises a TMP of less than 20% after 6 days, wherein the oil comprises a TMP of less than 30% after 12 days, or wherein the oil comprises a TMP of less than 35% after 20 days. In some embodiments, the microbially derived oil prevents adhesion of a first particle of the food to a second particle of the food when cooked in the microbially derived oil. In some embodiments, the microbially derived oil comprises a polyunsaturated fatty acid content of less than about 4 mmol/kg. In some embodiments, the microbially derived oil comprises a polyunsaturated fatty acid content of less than about 3 mmol/kg. In some embodiments, the microbially derived oil comprises a polyunsaturated fatty acid content of less than about 2.5 mmol/kg. In some embodiments, the microbially derived oil comprises a linoleic acid content of less than about 2.5 mmol/kg. In some embodiments, the microbially derived oil comprises a monounsaturated fatty acid content of at least 55 mmol/kg. In some embodiments, the microbially derived oil comprises a monounsaturated fatty acid content of about 60 mmol/kg. In some embodiments, the microbially derived oil comprises a saturated fatty acid content of less than about 3 mmol/kg. In some embodiments, the microbially derived oil comprises arachidic acid in an amount of less than about 0.07 mmol/kg. In some embodiments, the microbially derived oil comprises palmitic acid in an amount of less than about 1.5 mmol/kg. In some embodiments, the microbially derived oil comprises stearic acid in an amount of less than about 0.8 mmol/kg. In some embodiments, the microbially derived oil comprises less than about 2 mmol/kg α,β-unsaturated aldehydes when heated to about 180° C. In some embodiments, the microbially derived oil comprises less than about 2 mmol/kg α,β-unsaturated aldehydes when heated to about 180° C. for about 90 minutes or less. In some embodiments, the microbially derived oil comprises less than about 50 mmol/kg aldehydes when heated to about 180° C. for about 90 minutes or less. In some embodiments, the microbially derived oil comprises essentially no α,β-unsaturated aldehydes when heated to about 180° C. for about 5 minutes or less. In some embodiments, the microbially derived oil comprises less than about 1.5 mmol/kg α,β-unsaturated aldehydes when heated to about 180° C. for about 60 minutes or less. In some embodiments, the microbially derived oil comprises essentially no (Z)-2-Alkenals when heated to about 180° C. for about 20 minutes or less. In some embodiments, the microbially derived oil comprises less than about 1 mmol/kg (Z)-2-Alkenals when heated to about 180° C. for about 90 minutes or less. In some embodiments, the microbially derived oil comprises essentially no (Z,E)-2,4-Alkadienals when heated to about 180° C. for about 90 minutes or less. In some embodiments, the microbially derived oil comprises no detectable (Z,E)-2,4-Alkadienals when heated to about 180° C. for about 20 minutes or less. In some embodiments, the microbially derived oil comprises essentially no 4-Hydroperoxy-/4-Hydroxy-(E)-2-alkenals when heated to about 180° C. for about 10 minutes or less. In some embodiments, the microbially derived oil comprises less than 1 mmol/kg 4-Hydroperoxy-/4-Hydroxy-(E)-2-alkenals when heated to about 180° C. for about 90 minutes or less. In some embodiments, the microbially derived oil comprises essentially no 4,5-Epoxy-(E)-2-alkenals when heated to about 180° C. for about 90 minutes or less. In some embodiments, the microbially derived oil comprises less than 0.3 mmol/kg 4-(E,E)-2,4-Alkadienals when heated to about 180° C. for about 20 minutes or less. In some embodiments, the microbially derived oil comprises less than about 50 mmol/kg total aldehydes when heated to about 180° C.

### IV. Fryer Cooking Oil Quality Parameters

In aspect, the present disclosure provides a fryer having a cooking oil. The fryer may be a food fryer. The fryer may house and/or heat cooking oil for food frying. The fryer may be made from mild steel, stainless steel, plastic, etc. The fryer may be configured to heat and/or fry the food in the cooking oil. The cooking oil may be heated by the fryer. The fryer may be configured to supply a temperature of at least about 200° F., 250° F., 300° F., 350° F., 400° F., 450° F., 500° F., or more. The fryer may be configured to supply a temperature of at most about 500° F., 450° F., 400° F., 350° F., 300° F., 250° F., 200° F., or less. The fryer may be configured to supply a temperature from about 200° F. to 500° F., 300° F. to 400° F., 350° F. to 400° F., or 325° F. to 400° F.

The fryer may be able to hold cooking oil. The fryer may be capable of holding at least about 1 pound (lb), 5 lbs, 10 lbs, 15 lbs, 20 lbs, 30 lbs, 40 lbs, 50 lbs, 60 lbs, 70 lbs, 80 lbs, 90 lbs, 100 lbs, 200 lbs, 1000 lbs, 5000 lbs, or more cooking oil. The fryer may be capable of holding at most about 5000 lbs, 1000 lbs, 200 lbs 100 lbs, 90 lbs, 80 lbs, 70 lbs, 60 lbs, 50 lbs, 40 lbs, 30 lbs, 20 lbs, 15 lbs, 10 lbs, 5 lbs, 1 lb, or less cooking oil. The fryer may be capable of holding from about 1 lb to 5000 lbs, 1 lb to 1000 lbs, 200 lbs to 500 lbs, 1 lb to 200 lbs, 1 lb to 100 lbs, 10 lbs to 70 lbs, 20 lbs to 60 lbs, 30 lbs to 50 lbs, or 50 lbs to 70 lbs of cooking oil.

The fryer may be able to hold a given volume of cooking oil. The volume of cooking oil of the fryer may be at least about 0.1 liters (L), 0.5 L, 1.0 L, 5.0 L, 10.0 L, 50.0 L, 100.0 L, 500.0 L, 1000 L, 10000 L, or more. The volume of cooking oil of the fryer may be at most about 10000 L, 1000 L, 500.0 L, 100.0 L, 50.0 L, 10.0 L, 5.0 L, 1.0 L, 0.5 L, or less. The volume of the cooking oil of the fryer may be from about 0.5 L to 10000 L, 10.0 L to 1000 L, 100.0 L to 500.0 L, or 50.0 L to 500.0 L. The fryer may be of any three-dimensional shape, for example, cubic, rectangular, cylinder, spherical, etc. The fryer may process food in batches or continuously.

The cooking oil may have a variety of cooking oil quality parameters. The cooking oil quality parameters may be a value determined after a period of time. The cooking oil quality parameters may be a percentage value determined after a period of time. The cooking oil quality parameters may be a percentage value determined after heating for a period of time. The cooking oil quality parameters may include, for example, an oil stability index (OSI), total polar material (TPM), free fatty acid content, an aldehyde content, saturated acid content, α,β-unsaturated aldehydes content, lipid oxidation product (LOP) content, moisture content, specific gravity, peroxide value, acid value, olfactory quality, light absorption, and iodine value.

The cooking oil performance parameters may be measured after heating for a period of time. The cooking oil performance parameters may be measured after heating for at least about 1 hour (hr), 2 hrs, 3 hrs, 4 hrs, 5 hrs, 6 hrs, 12 hrs, 24 hrs, 50 hrs, 100 hrs, 200 hrs, 300 hrs, 500 hrs, 1000 hrs or more. The cooking oil performance parameters may be measured after heating for at most about 1000 hrs, 500 hrs, 300 hrs, 200 hrs, 100 hrs, 50 hrs, 24 hrs, 12 hrs, 6 hrs, 5, hrs, 4 hrs, 3 hrs, 2 hrs, 1 hr, or less. The cooking oil may be measured after heating from about 1 hr to 1000 hrs, 1 hr to 500 hrs, 1 hr to 300 hrs, 1 hr to 100 hrs, 1 hr to 50 hrs, 1 hr to 24 hrs, 1 hr to 6 hrs, 1 to 4 hrs, 4 hrs to 100 hrs, or 200 hrs to 1000 hrs.

The cooking oil performance parameters may be measured after heating at a given temperature for a period of time. The cooking oil performance parameter may be measured after heating at a temperature of at least about 250 Fahrenheit (° F.), 300° F., 350° F., 400° F., 450° F., 500° F., or more. The cooking oil performance parameters may be measured after heating at a temperature of at most about 500° F., 450° F., 400° F., 350° F., 300° F., 250° F. or less. The cooking oil performance parameters may be measured after heating at a temperature from about 250° F. to 500° F., 250° F. to 400° F., 250° F. to 350° F., or 250° F. to 300° F.

### Oil Stability Index

The oil stability index may be used to determine the relative oxidative stability of the fatty materials within the cooking oil. The oxidative stability of the cooking oil may be determined using the American Oil Chemical Society (AOCS) standard method CD 12B-92 and/or the Rancimat method. In some embodiments, the oxidative stability of the cooking oil may be measured isothermally at elevated temperatures to accelerate oxidation. In some cases, the OSI is the point of maximum change of the rate of oxidation. In some cases, the OSI is a method that may determine the relative resistance of fats or oils to oxidation from the cooking oil.

The cooking oil may have an OSI value. The cooking oil OSI value may be determined without the use of external antioxidants in the cooking oil. The cooking oil may have an OSI value of greater than about 30 hrs, 40 hrs, 50 hrs, 60 hrs, 70 hrs, 80 hrs, 90 hrs, 100 hrs, 150 hrs or more. The cooking oil may have an OSI value of less than about 150 hrs, 100 hrs, 90 hrs, 80 hrs, 70 hrs, 60 hrs, 50 hrs, or less. The cooking oil may have an OSI value from about 30 hrs to 200 hrs, 50 hrs to 200 hrs, 50 hrs to 150 hrs, or 50 hrs to 100 hrs.

### Total Polar Material

The total polar material (TPM) may be generated during the frying process of the cooking oil. During the frying process, the cooking oil may deteriorate as a result of hydrolytic, oxidative and/or thermal reactions. Polar compounds may be formed from the non-polar triacylglycerols. In some cases, these are referred to as the total polar material (TPM), whereas the remaining triacylglycerols and other compounds of low polarity make up the non-polar fraction. The ratio and the amount of these two fractions may depend on the kind of frying oil, storage condition, and processing conditions like frying temperature, frying time and the food being fried. In some cases, the TPM may be used as an indicator for the quality of the cooking oil. In some cases, the TPM may be measured using a digital TPM device (e.g., testo 270 cooking oil tester).

The cooking oil may have a TPM content value. The TPM content value may be a percentage (w/v) of polar materials compared to non-polar materials in the cooking oil. The TPM value may be below 10% after heating for 4 hrs at a temperature greater than 250° F., 300° F., 350° F., 400° F., 450° F., 500° F., or more. The TPM value may be below 10% after heating for 4 hrs at a temperature less than 500° F., 450° F., 400° F., 350° F., 300° F., 250° F. or less. The TPM value may be below 10% after heating for 4 hrs at a temperature from about 250° F. to 500° F., 250° F. to 400° F., 250° F. to 350° F., or 250° F. to 300° F. In some cases, the TPM content value may be at most about 30%, 25%, 20%, 10%, 7%, 5%, 3%, or less. In some cases, the TPM content value may be at least about 3%, 5%, 7%, 10%, 20%, 25%, 30% or more. In some cases, the TPM content value may be from about 3% to 30%, 5% to 25%, or 10% to 20%. In some cases, the TPM content may be measured after at least about 4 hrs, 12 hrs, 24 hrs, 3 days, 1 week, or more. In some cases, the TPM content may be measured after at most about 1 week, 3 days, 24 hrs, 12 hrs, 4 hrs, or less. In some cases, the TPM content may be measured from about 4 hrs to 1 week, 4 hrs to 3 days, 4 hrs to 24 hrs, or 4 hrs to 12 hrs. The TPM content of the cooking oil may be measured after heating at a temperature of at least about 250° F., 300° F., 350° F., 400° F., 450° F., 500° F., or more. The TPM content of the cooking oil may be measured after heating at a temperature of at most about 500° F., 450° F., 400° F., 350° F., 300° F., 250° F., or less. The TPM content of the cooking oil may be measured after heating at a temperature from about 250° F. to 500° F., 250° F. to 350° F., or 250° F. to 300° F. In some embodiments, the microbially derived oil is resistant to decomposition into polar materials as measured by total polar material (TMP) in the oil when heated to 370 F, wherein the oil comprises a TMP of less than 20% after 6 days, wherein the oil comprises a TMP of less than 30% after 12 days, or wherein the oil comprises a TMP of less than 35% after 20 days.

### Free Fatty Acids

The free fatty acid content of a cooking oil may be determined. The free fatty acids may be a measure of the change in the fat of the cooking oil at room temperature with exposure to oxygen in the air (rancidity) or as a result of hydrolysis. In some cases, it may be appropriate to determine the ageing of unused, i.e. unheated fat, via the free fatty acid content of a cooking oil. In some cases, the free fatty acid may be one or more of the following: palmitic acid, stearic acid, palmitoleic acid, oleic acid, linoleic acid, alpha linolenic acid, etc. In some cases, the percentage of free fatty acid of the cooking oil may be determined using ¹H-NMR, ¹³C-NMR, and/or ³¹P-NMR.

### Smoke Point

The cooking oil may include a smoke point. The smoke point may be the lowest temperature of the heated cooking oil at which smoke visibly develops on the surface. In some cases, the smoke point may be reduced by the various decomposition reactions that may take place in the cooking oil before and/or during deep frying. The smoke point may be determined using an external thermometer. The smoke point of the cooking oil may be at least about 250° F., 300° F., 350° F., 400° F., 450° F., 500° F., 550° F., 600° F., or more. The smoke point of the cooking oil may be at most about 600° F., 550° F., 500° F., 450° F., 400° F., 350° F., 300° F., 250° F., or less. The smoke point of the cooking oil may be from about 250° F. to 600° F., 300° F. to 550° F., or 350° F. to 500° F.

### Acid Number

The cooking oil may include an acid number indicator. The acid number may indicate how much potassium hydroxide may be required to neutralize the free fatty acids in the cooking oil. The acid number may be determined using titration. The acid number may be determined before and/or after heating the cooking oil for a period of time.

### Iodine Number

The cooking oil may include an iodine number indicator. The iodine number may indicate how much iodine may be absorbed by the cooking oil. In some cases, the greater quantity of iodine consumed, the greater the number of double bonds in the cooking oil. In some cases, the greater the number of double bonds, the greater the freshness of the tested cooking oil. The iodine number may be determined by titration. The iodine number may be determined before and/or after heating the cooking oil for a period of time

### Peroxide Number

The cooking oil may include a peroxide number indicator. The peroxide number may be used to determine the oxidation in the cooking oil. The peroxide number may be determined using titration. In some cases, the cooking oil may be cold for the determination of the peroxide number. The peroxide number may be determined before and/or after heating the cooking oil for a period of time

### Cooking Oil Color

In some embodiments, the color of the cooking oil may be a quality feature for freshness. In some cases, the color of the cooking oil can vary from one cooking oil to another. In some cases, if the color of the fresh cooking oil is darker than expected, further tests may be required such as a measurement of the free fatty acids. In some embodiments, for cooking oil, the color may be changed firstly by the various degradation products of the cooking oil and secondly by the ingredients which can enter the cooking oil from the product being deep fried. For example, if breaded meat is fried, the oil may darken quicker than if potatoes are mainly fried. In some cases, this effect may be attributable to the Maillard reaction.

### Cooking Oil Absorption

In some embodiments, optical spectroscopy may be used to obtain an absorption spectra (e.g., UV-Vis-NIR spectra) of the cooking oil. Optical spectroscopy may use a light beam to illuminate the cooking oil sample. This may give rise to reflected, transmitted, and scattered intensities of the compounds within the cooking oil. The absorption spectra of the cooking oil sample may be used to determine the relative quantities of TAG and/or degradation products within the cooking sample.

### Residue on Fryer

In some embodiments, the cooking oil may form a residue on the fryer. In some cases, this residue is a function of the composition of the fryer oil and its degradation products. In some cases, the residue is a polymer that forms on the fryer parts exposed to the cooking oil. In some embodiments the residue starts to accumulate at about 100 hrs of heating the cooking oil. In some cases, the residue forms at about a time more than about 10 hrs, 20 hrs, 30 hrs, 40 hrs, 50 hrs, 100 hrs, 200 hrs, 300 hrs, 500 hrs, 1000 hrs, or more. In other cases, the residue forms at a time less than about 1000 hrs, 500 hrs, 300 hrs, 200 hrs, 100 hrs, 50 hrs, 40 hrs, 30 hrs, 20 hrs, 10 hrs, or less. The residue may form after heating at a temperature of at least about 250° F., 300° F., 350° F., 400° F., 450° F., 500° F., or more. The residue may form after heating at a temperature of at most about 500° F., 450° F., 400° F., 350° F., 300° F., 250° F., or less. The residue may form after heating at a temperature from about 250° F. to 500° F., 250° F. to 350° F., or 250° F. to 300° F.

### V. Method of Preparing a Fried Food

The present disclosure also provides a method of preparing a fried food including heating the cooking oil in the fryer to at least 250° F. The cooking oil may be heated in the fryer to at least about 250° F., 300° F., 350° F., 400° F., 450° F., 500° F., or more. The cooking oil may be heated in the fryer to at most about 500° F., 450° F., 400° F., 350° F., 300° F., 250° F., or less. The cooking oil may be heated in the fryer from about 250° F. to 500° F., 250° F. to 350° F., or 250° F. to 300° F.

The method can also include placing a piece of food in the cooking oil until the temperature of the piece of food increases to at least 150° F. The method can also include placing a piece of food in the cooking oil until the temperature of the piece of food increases to at least about 100° F., 125° F., 150° F., 175° F., 200° F., or more. The method can also include placing a piece of food in the cooking oil until the temperature of the piece of food increases to at most about 200° F., 175° F., 150° F., 125° F., 100° F., or less. The method can also include placing a piece of food in the cooking oil until the temperature of the piece of food increases to from about 100° F. to 200° F., 150° F. to 200° F., or 125° F. to 175° F.

The method of can also further include removing the fried food from the fryer. In some embodiments, the food may be a meat, seafood, or vegetable. In some cases, the meat may be chicken. In some cases, the seafood may be fish. In some cases, the vegetable may be a tuber. In some cases, the vegetable may be a potato or onion. In some instances, the food is a processed food product.

### VI. Composition of the Fried Food

The present disclosures also provides a fried food composition. The fried food composition may include a food, cooking oil, and one or more degradation products. In some cases, the cooking oil in the fryer may include one or more degradation products. The degradation products may be, for example, aldehydes, unsaturated aldehydes, lipid oxidation products, NHE, and the like. The degradation products may be absorbed into the fried food. In some cases, the fried food generated using the cooking oil may contain less degradation products than a food fried with a different cooking oil. The different cooking oil may contain more degradation products (e.g. NHE) than the first cooking oil and may be considered to be more toxic than the first cooking oil.

### VII. Examples

### Example 1: Determination of the Oil Stability Index for a Cooking Oil Using AOCS Standard

The oil stability index of a cooking oil can be determined using the American Oil Chemical Society (AOCS) standard method CD 12B-92. This method determines the resistance to oxidation of an oil by passing a stream of purified air thorough a test sample held at a constraint temperature. The effluent air from the oil or fat test sample is then bubbled through a vessel containing deionized water. The conductivity of the water is continually monitored, and changes when volatile organic acids created from oxidation of the oil dissolve in the water.

### Example 2: Determination of the Oil Stability Index for a Cooking Oil Using the Rancimat Method

In the Rancimat method, oxidation is accelerated by means of heating up the reaction vessel and by passing air continuously through the sample. This process causes the fatty acid molecules in the sample to oxidize. First, peroxides form as primary products of oxidation. After some time, the fatty acids are completely destroyed and secondary oxidation products are formed, including volatile low-molecular organic acids such as, acetic acid and formic acid. These are transported by the airstream to a second vessel containing distilled water, where conductivity is measured continuously. The appearance of volatile acids is recorded in the measuring vessel as an increase in conductivity. The time that elapses until these secondary reaction products appear is called induction time, induction period or Oil Stability Index (OSI). This value characterizes the resistance of the sample to oxidation. The longer the induction time, the more stable a sample is.

### Example 3: Determination of the Total Polar Material of a Cooking Oil Column Procedure

A sample of a defined weight of the cooking oil is placed on the weighting agent of a column. The sample moves slowly through the column and is collected again at the bottom. As the sample moves through the column, the polar materials present are retained by the weighting agent of the column, so that the collector will only contain the nonpolar parts of the fat. Once the entire sample has gone through the column, the residual fat can be weighed and the nonpolar materials of the fat can thus be determined. If this sum is detracted from the total weight, the polar materials of the sample are obtained. The total polar material percentage (w/V) can be calculated as follows:

$$Total Polar Material \% = \frac{E - A}{A} * 100$$

where A=nonpolar fraction (in gm); E=test portion (in gm) in 20 mL aliquot.

### Example 4: Determination of the Total Polar Material (TPM) of a Cooking Oil Via Capacitive Measurement

A voltage is connected to two plates of a capacitor labeled as red (positive) and blue (negative). The capacitor plates are charged until a certain quantity of electrical charge is reached. As the charge increases, the polar materials of the fat progressively align themselves. The red, positive ends of the materials point towards the blue, negative plate, the blue, negative ends towards the red, positive plate. Once the capacitor is charged, it has a certain capacity. This is dependent on the dielectric, in this case the oil. The more polar materials are contained in the cooking oil, the greater the capacity of the capacitor. This change in capacity is converted and then appears on the display of the testo 270 cooking oil tester as a percentage TPM content, for example.

### Example 5: Free Fatty Acid Determination Measurement

Free fatty acids in the fat of unheated cooking oil can be measured using a test rod. A dye is applied to the test rod which changes color according to the content of free fatty acids. By then comparing the test strip against an appropriate color scale, the content of free fatty acids can be determined.

### Example 6: Free Fatty Acid Determination Measurement Via ¹H NMR Analysis

The percentage of free fatty acid in cooking oil can be determined based on the integration of the signal corresponding to the α-carbonyl methylene protons of the FFA (the methylene group directly adjacent to the COOH group) and the α-carbonyl-CH₂ signal of esterified fatty acids. In the cooking oil, α-CH₂ peaks of fatty acids generally appear at chemical shift (5) values higher than those of the ester, as a consequence of the stronger deshielding effect of the carboxylic group with respect to the ester group. Hence, one of the peaks of the triplet of FFA is visible outside the α-CH₂ region of the ester, while the other two peaks overlap with those due to the ester. This means that a sample of cooking oil containing both FFA and ester can show a pseudo-quartet signal in the α-CH₂ region of the proton NMR spectrum and that the intensity of the peaks depends on the content of FFA in esters. The FFA content can be calculated from the unmerged peak of the FFA triplet using the following equation:

$$\% FFA = \frac{4 * {I}_{unmerged - α - {CH}_{2} - FFA}}{{I}_{total - α - {CH}_{2} - FFA + ester}}$$

where I_{unmerged-α-CH2-FFA} is the area of the unmerged FFA peak and I_{total-α-CH2-FFA+ester} can be the total area of the α-CH-2 of both FFA and ester. The pre-factor 4 can account for the fact that the triplet of the α-CH₂ group of the FFA has an intensity ratio of 1:2:1, so that the total area is four times the area of the single unmerged FFA peak.

### Example 7: Aldehyde Determination Via ¹H NMR Analysis

The cooking oil can be heated at 180° C. for periods of up to 90 min. Each 90 min. heating cycle can be completed n=6 replicated sessions for the cooking oil. This shallow frying simulation can involve the heating of a 6.00 ml volume of cooking oil in an air-dried 250 ml glass beaker within a thermostated silicon oil bath maintained at a temperature of 180° C. throughout the total heating period. Aliquots (ca. 0.25 ml) of oil samples can be collected at the 0, 5, 10, 20, 30, 60 and 90 min. heating time-points for ¹H NMR analysis. Immediately following collection, the lipid-soluble chain-terminating antioxidant 2,5-di-tert-butylhydroquinone (DTBHQ) will be added to each cooking oil sample (at a final added concentration of 2.00 mmol·kg⁻¹) in order to block or retard the further generation of aldehydes and their CHPD and HPM precursors during periods of storage and sample preparation at ambient temperature. Samples can be prepared for ¹H NMR analysis within 2 hr. after collection, and can be stored in sealed containers within a light-excluded zone whilst awaiting analysis.

¹H NMR measurements on the above samples can be conducted on a 400 MHz Bruker Avance spectrometer operating at a frequency of 399.94 MHz and a probe temperature of 293 K. Typically, a 0.20 ml aliquot of the cooking oil sample can be diluted to a final volume of 0.60 ml with deuterated chloroform (C²HCl3) containing 3.67 mmol·L⁻¹ tetramethylsilane (TMS) and 15.00 mmol·L⁻¹ 1,3,5-trichlorobenzene (1,3,5-TCB): the C²HCl₃ diluent can provide a field frequency lock, the TMS can act as an internal chemical shift reference (d=0.00 ppm), and 1,3,5-TCB (s, d=7.20 ppm) can serve as an internal concentration reference standard. These solutions can then be placed in 5-mm diameter NMR tubes. Typical pulsing conditions can be: 128 or 256 free induction decays (FIDs) using 65,536 data points and a 4.5 s pulse repetition rate, the latter can allow full spin-lattice (T₁) relaxation of protons in the samples investigated. Resonances present in each spectrum can be assigned by a consideration of chemical shifts, coupling patterns and coupling constants. One- and two-dimensional COSY and TOCSY spectra can be acquired to confirm ¹H NMR assignments.

From the FA compositions of these oils, their intrinsic peroxidative susceptibility indices (PSIs) can be computed, i.e. PSI=[0.025(% monoenoic FA)]+[1.00(% dienoic FA)]+[2.00(% trienoic FA)]+[4.00(% tetraenoic FA)]+[6.00(% pentaenoic FA)]+[8.00(% hexaenoic FA)]. In some cases, contributions to the PSI from tetraenoic, pentaenoic and hexaenoic FA sources can be negligible.

Calibration curves for typical trans-2-alkenals and n-alkanals (0-600 μmol·L⁻¹ and 0.20-50.00 mmol·L⁻¹) can be generated and used to determine R² values.

The univariate analysis of the total acylglycerol-normalized ¹H NMR aldehydic class ISB intensity datasets can involve an analysis-of covariance (ANCOVA) model, which can incorporate 2 prime factors and a total of 3 sources of variation: (1) that ‘between-cooking oils’, qualitative fixed effect (Oi); (2) ‘between-sampling time-points’ quantitative fixed effect ‘nested’ within ‘culinary oils’ (Tj); and (3) the culinary oil x time-point first-order interaction effect (OTij). This experimental design is represented by equation 2, in which yijk represents the (univariate) aldehyde ISB dependent variable values observed, its overall population mean value in the absence of any significant, influential sources of variation, and ₑᵢⱼₖ the unexplained error (residual) contribution.

$${y}_{ijk} = μ + {O}_{i} + {T}_{j} + {OT}_{ij} + {e}_{ijk} \qquad ( 2 )$$

ANCOVA can be conducted with XLSTAT2016 software. Datasets can be generalized logarithmically (g log)-transformed, mean-centered and standardized prior to analysis in order to satisfy assumptions of normality and homoscedasticity. Post-hoc analysis of significant differences can be observed between individual culinary oils and sampling time-points can be performed using the Bonferroni method which can correct for false discovery rates.

Agglomerative hierarchal clustering (AHC), principal component analysis (PCA) and Pearson (linear) correlation analysis of the extensive culinary oil NMR-based aldehyde concentration dataset can be performed using Metaboanalyst 3.0 software module options. Datasets (mmol. aldehyde/mol. FA) can be analyzed either untransformed and unscaled, or alternatively after cube root- or glog-transformations, and Pareto scaling. AHC dendograms can be generated employing Euclidean distance and Ward's linkage clustering algorithm. Heatmap and correlation feature diagrams can also be obtained using this software module.

Authentic aldehydes employed for ¹H NMR reference purposes, including n-hexanal, n-octanal, trans-2-octenal, trans-2-nonenal trans,trans-deca-2,4-dienal, etc. can be obtained from the Sigma-Aldrich Chemical Co. (USA). Crotonaldehyde (butenal) can be purchased from Sigma-Aldrich as a 20:1 molar ratio of its trans-(E-):cis-(Z-) isomers in order to permit assignments of resonances for cis-2-alkenal LOPs in thermally-stressed cooking oils.

### Example 8: Moisture Content Determination

Ten grams of cooking oil sample can be placed in a weighed crucible. The samples can be dried for 1 h to constant weights in an oven set at 105° C. and then allowed to cool in desiccators for 15 min. Finally, the difference can be calculated using the following equation.

$$\% Moisture = \frac{W 1 \times 100}{W 2}$$

where W1=weight loss (grams) upon drying and W2=weight (grams) of the oil sample.

### Example 9: Specific Gravity Determination

Dry pycnometer may be used to determine specific gravity. Specific gravity can be measured by relative density of the cooking oil to water. Distilled water can be added into the pycnometer followed by measurement using electronic balance. Similarly, oil weight can be measured. The specific gravity value was calculated as follows:

$$Specific Gravity = \frac{weight of cooking oil ( grams )}{weight of distilled water ( grams )}$$

### Example 10: Peroxide Value Determination

Ten milliliters (mL) of oil sample can be dissolved in acetic-acid/chloroform (3:2 ratios) solvents. This solution can be further reacted with 0.5 mL of 15% potassium iodide (KI). The liberated iodine can be titrated with 0.1 N sodium thiosulphate using 0.5 mL starch as indicator. Blank titration can be performed. The peroxide value was calculated as follows:

$$Peroxide Value = ( B - S ) \times W \times N$$

where, S=volume of sodium-thiosulphate consumed by the oil sample, B=volume of sodium-thiosulphate used for blank, W=weight of oil sample, N=the normality of sodium-thiosulphate.

### Example 11: Acid Value Determination

Mixture of 10 mL of cooking oil sample and 100 mL of ethyl-alcohol can be heated until the content starts to boil. The hot content can be cooled and titrated with 15% KOH solution using phenolphthalein as endpoint indicator. Acid value can be calculated as follows:

$$Acid Value = \frac{V \times N \times M . wt}{W}$$

where, V=volume of standard KOH solution in mL, N=normality of standard KOH solution, W=weight of oil sample in grams, M.wt (molecular weight) of KOH (56.1 g/mol)

### Example 12: Iodine Value

Mixture of 0.5 mL of oil sample and 10 mL chloroform can be added into 25 ml of iodine solution, and allowed to react for 30 min for a complete reaction between iodine and the unsaturated bonds of oils. The flask can be covered by aluminum foil to avoid light exposure. Then, 20 mL of 15% aqueous KI and 100 mL of water can be added to transform leftover iodine to iodide. The final content can be titrated with 0.1 N sodium-thiosulphate (Na₂S₂O₃) solutions using starch as an indicator. Iodine value can be calculated as follows:

$$Iodine Value = \frac{( A - B ) \times N \times 0.127 \times 100}{W}$$

where, A=mL of 0.1 N Na₂S₂O₃ required by oil sample, B=mL of 0.1 N Na₂S₂O₃ required by the blank, N=normality of Na₂S₂O₃, W=weight of oil in gram, 1 mL 1 N Na₂S₂O₃=0.127 g I₂.

### Example 13: Lipid Oxidation Products Determination

Twenty-five milliliter cooking oil can be transferred to a 600 mL beaker and be heated for 25 minutes at 225° C. in an oven. Samples will be cooled, transferred to a 100 mL bottle and placed, together with corresponding fresh sample, in a dark cooling room (4° C.) until analysis on the following day. PeroxySafe™ kit-STD assay, AlkalSafe™ kit-STD assay, and STD controls can be used and purchased from SafTest, Inc.

Measurement of peroxide value (PV) using the PeroxySafe™ Kit-STD assay: the PeroxySafe™ STD kit can be performed according to the procedure following the kit. All volumes can be halved compared to the original sample preparation procedure and a Beckman DU® 640 spectrophotometer (Beckman Instruments, Inc. (now Beckman Coulter, Inc.), CA, USA) can be used for the measurements of absorbance at 570 nm. All samples can be measured in duplicates. Samples with PV above 5.0 meq/kg can be diluted to ensure the concentration to be within the concentration rage of the calibration curve.

Measurement of alkenals using the AlkalSafe™ Kit-STD assay: the AlkalSafe™ STD kit can be performed according to the procedure following the kit. However, some modifications can be made. All volumes can be halved compared to the original sample preparation procedure and a Beckman DU® 640 spectrophotometer can be used for the measurements of absorbance at 550 nm. All samples can be measured in duplicates.

### Example 14: Optical Spectroscopy

Absorption spectra may be obtained by diluting a sample of cooking oil to an appropriate level to minimize saturation of the detector within the spectrometer. The absorption spectra may be obtained of the cooking oil sample before heating/frying and compared to the absorption spectra obtained of a cooking oil sample that has been heated/fried.

### Example 15—Quantification of Thermal Decomposition Byproducts of Edible Oil Compositions

Very high concentrations of toxic lipid oxidation products (LOPs), particularly those known as aldehydes, are generated from the oxidation of polyunsaturated fatty acid (PUFA)-rich culinary oils when exposed to high-temperature frying practices. Of the two major classes of aldehydes produced, more than 70% of those arising from PUFA oxidation sources comprise the more toxic α,β-unsaturated aldehydes, and a broad spectrum of these toxin types (specifically trans- and cis-2-alkenals, trans, trans- and cis, trans-alka-2,4-dienals, 4,5-epxoxy-trans-2-alkenals, and 4-hydroxy- and 4-hydroperoxy-trans-2-alkenals), but less than 30% of the less toxic saturated aldehydes. However, from slower thermally-induced monounsaturated fatty acid (MUFA) oxidation, only lower levels of trans-2-alkenals, along with one sub-class of saturated aldehydes (n-alkanals), are evolved from such heating episodes, and usually only following longer heating durations.

Ingestion of cytotoxic and genotoxic aldehydes, which occurs through passage of thermo-oxidised, aldehyde-containing oxidised oils into fried foods, or food containing these oils, followed by their consumption, potentially induce and/or promote a wide range of deleterious health effects in humans (including cardiovascular diseases, hypertension, cancer, neurodegenerative disorders, teratogenicity and inflammation, amongst many others). Therefore, it is desirable to avoid the use of high PUFA content cooking oils such as natural corn or sunflower oils for frying and cooking purposes. Since MUFAs are much more resistant to aldehyde-generating thermally-induced peroxidation processes, MUFA-rich frying oil (e.g., Zero Acre Farms Inc.) withstand adverse peroxidation processes during laboratory-simulated frying episodes. Relatedly, products produced with the oils of the present disclosure may also provide similar beneficial effects, by not forming reactive aldehydes upon heating, and providing a healthier product for the end consumer.

### Experimental Protocol

In this example, various oils underwent laboratory-simulated frying episodes at 180° C. Aldehydic lipid oxidation products (LOPs) and triacylglycerol fatty acids were determined by high-resolution proton (¹H) nuclear magnetic resonance (NMR) analysis in Zero Acre Farms, sunflower, corn, extra virgin olive, avocado, palm, canola and coconut oil samples collected at the 0, 5, 10, 20, 30, 60 and 90 minute simulated frying time-points. In addition to monitoring the time-dependent production of toxic LOPs such as aldehydes in these thermally-stressed cooking oils, the aldehyde generation lag phase was also determined from these oils. This lag phase is defined as the time taken prior to significant aldehyde generation in oils exposed to simulated frying episodes at the above temperature, and is determined from plots of individual aldehyde class levels against heating time mainly through cubic spline fitting approaches). Typically, PUFA-rich oils such as sunflower oil have short lag phases, whereas MUFA- and saturated fatty acid-(SFA)-rich frying media have longer and very much longer values, respectively.

The procedure followed in this example quantified a series of lipid oxidation products (LOPs) predominantly arising from the thermally-induced autoxidation of both PUFAs and MUFAs present in intact culinary oils [e.g. cytotoxic/genotoxic aldehydes, and their conjugated hydroperoxydiene (CHPD) precursors such as 9(R/S-hydroperoxy-cis-9,trans-11-octadecadienoic acid] by ¹H NMR analysis at operating frequencies of 400-600 MHz, data also providing much evidence for the presence of many additional LOPs, such as epoxy-fatty acids. This powerful multicomponent analytical technique was applied to determine the precise molecular nature and concentrations of such LOPs in samples of newly-developed cooking oil products when heated according to standard shallow- or deep-frying practices. Results arising therefrom are routinely compared and contrasted to those obtained from corresponding thermal stressing episodes conducted with a range of commercially-available, culinary oil products which are frequently employed by consumers and are often used in the production of mayonnaise and other edible compositions, specifically soybean, sunflower, canola, corn, olive and coconut oils, together with others.

These investigations will be readily facilitated by the acquisition of two-dimensional (2D) shift-correlated and ¹³C NMR spectra. The hydroxyepoxides represent the most potent carcinogens derived from the metabolic transformation of aromatic hydrocarbons, and such species are also generated from conjugated hydroperoxydienes (e.g., 11-hydroxy-9,10-epoxy-12-octadecadenoic acid arising from the 9-hydroperoxide of linoleate, presumably via an intramolecular oxygen transfer process).

Culinary oil products were placed in glass containers and heated at a temperature of 180° C. in the presence of atmospheric 02 according to shallow-frying episodes for periods of up to 90 min. The shallow-frying episodes involved the heating of 6.00 ml volumes of oils within a 250 ml volume glass beaker. These samples were stirred with a magnetic follower and their temperature continuously maintained at 180° C. throughout the heating process using a calibrated thermometer. Aliquots (0.30 ml) of the oils were removed for NMR analysis at the 5, 10, 20, 30, 60 and 90 min. time-points, and these samples will be treated with 2,5-di-tertiary-butyl hydroquinone (DTBHQ, final concentration 1.00×10⁻² mol·kg⁻¹) to prevent any further autoxidation of PUFAs therein following sample collection. All samples were stored in the dark at ambient temperature for periods of up to 48 hr. prior to NMR analysis. A total of n=2 replicate samples will be obtained at each of the above time-points for each oil product investigated in order to closely monitor the reproducibility (analytical precision) of the results acquired. Appropriate control samples of unheated oils (pre-DTHBQ-treated) were stored and subjected to NMR analysis in the same manner.

### Proton NMR Analysis

Proton (¹H) NMR measurements on the above samples was conducted on a 600 MHz spectrometer facility operating at a frequency of 600.17 MHz and a probe temperature of 293 K. A 0.20 ml aliquot of each oil sample was diluted to a final volume of 0.60 ml with deuterated chloroform (C2HCl3) containing 3.67 mmol·l-1 tetramethylsilane (TMS) and 15.00 mmol·l-1 1,3,5-tribromobenzene (1,3,5-TBB): the C2HCl3 diluent will provide a field frequency lock, the TMS will act as an internal chemical shift reference (δ=0.00 ppm), and 1,3,5-TBB (s, 6=7.54 ppm) will serve as an internal LOP concentration reference standard. These solutions were then be placed in 5-mm diameter NMR tubes. Typical pulsing conditions were: 128 or 256 free induction decays (FIDs) using 65,536 data points and a 4.5 s pulse repetition rate, the latter to allow full spin-lattice (T₁) relaxation of protons in the samples investigated. Resonances present in each spectrum will be routinely assigned by a consideration of chemical shifts, coupling patterns and coupling constants. One- and two-dimensional COSY and TOCSY spectra will be employed to confirm ¹H NMR assignments.

### Determination of Aldehyde Content

Clearly visible aldehydic LOP regions of the spectral profiles acquired (i.e. those within the 5.40-10.20 ppm spectral range) were preprocessed by the application of a separate macro for the ‘intelligent bucketing’ sub-routine. These procedures were conducted using the ACD/Labs Spectrus Processor 2021 software package (ACD/Labs, Toronto, Ontario, Canada M5C 1T4), and this will generate a culinary oil dataset matrix consisting of bucket variables (intelligently-selected buckets, abbreviated as ISBs) corresponding to the —CHO function resonances of a range of aldehyde classes, specifically trans-2-alkenals (doublet, 6=9.48-9.51 ppm), trans,trans- and cis,trans-alka-2,4-dienals (both doublets, 6=9.51-9.54 and 9.59-9.61 ppm respectively), 4,5-epoxy-2-alkenals (doublet, 6=9.54-9.56 ppm), 4-hydroxy-/4-hydroperoxy-trans-2-alkenals (both doublets, 6=9.59-9.61 ppm), n-alkanals (triplet, 6=9.74-9.76 ppm), low-molecular-mass n-alkanals, predominantly linolenate hydroperoxide-derived propanal (triplet, 6=9.78-9.80 ppm), and cis-2-alkenals (doublet, δ=10.05-10.08 ppm). Prior to commencing this intelligent bucketing process, all spectra will be examined visually for any inherent distortions and manually corrected, if required. The electronic intensities of resonances corresponding to each of the above —CHO resonance ISBs will be normalised to (1) that of one encompassing all acylglycerol-CH3 function signals (δ=0.82-0.96 ppm) so that their concentrations in each oil sample may be expressed as μmol. or mmol. aldehyde per mol. of total fatty acid, or (2) that of internal TBB so that their absolute molar concentrations may be determined. ‘Between-frying cycle’ sample coefficients of variation for these determinations will be made from each of the n=2 replicated thermal stressing episode samples, in addition to replicate determinations made on the same samples.

A similar approach was employed for the ¹H NMR analysis of further LOPs (such as conjugated hydroperoxydienes and hydroxydienes, hydroperoxymonoenes, epoxy-fatty acids, etc.), and the full fatty acid profiles of each culinary oil product investigated, together with triacylglycerol hydrolysis products, and any sterols and stanols present therein.

The recent availability of spectrometers of operating frequencies ≥500 MHz has led to a synchronous increase in the development and application of both homonuclear and heteronuclear two-dimensional (2D) NMR methods in order to resolve the large number of overlapping multiple resonances (many with higher order coupling patterns) now detectable in high-resolution ¹H spectra acquired on complex multicomponent samples such as LOP-rich thermally-stressed culinary oils. The range of such 2D NMR techniques employable readily facilitates establishment of the precise molecular structures of these compounds present in such mixtures. Proton-proton and proton-carbon scalar couplings readily determine groups of resonances arising from individual components, and the unambiguous structural information derived therefrom is, in general, not acquirable from alternative analytical techniques. Therefore, in this investigation, we shall also employ 1H-1H relayed coherence transfer, 1H-1H correlation and total correlation (COSY and TOCSY respectively), 1H-13C heteronulcear multiple quantum coherence (HMQC), and 1H-1H J-resolved NMR spectroscopic techniques for the purpose of clarifying spectral assignments, including the provision of further valuable information regarding the identities of LOPs present in thermally/oxidatively-stressed culinary oils.

### 2.4 Free Fatty Acid Contents of Culinary Oils

Free fatty acids (FFAs) present in all culinary oil samples explored, both unheated and thermally-stressed for increasing time-points at 180° C., was identified and monitored by a modification of the method outlined by Skiera et al. [11] which describes a relatively simple ¹H NMR approach involving the electronic integration of the carboxyl group (—CO₂H) resonance(s) of FFAs found in the high frequency regions of the spectra acquired (11-12 ppm). For this purpose, culinary oil samples will be homogenised in a C²HCl₃/hexadeuterated dimethylsulphoxide (DMSO-d6) admixture (5:1 v/v), and will use TMS as an internal reference standard, and a pre-analysis drying process. This sample preparation technique serves to overcome the rapid proton exchange processes that are observed in pure C²HCl3, solution, which give rise to severe line broadening and hence obscurement of these 11-12 ppm —CO₂H resonances. FFA quantification is performed via expression of the integration value of this signal relative to that of the α-carbonyl-CH₂ protons located within the 2.2-2.4 ppm region of spectra acquired, and this yields oil FFA contents in mmol/mol TAG.

### 2.5 ¹H NMR Determination of the Oxidative Stability Indices (OSIs) of Culinary Oils

OSI values for both aldehydic LOPs and their CHPD precursors was simultaneously determined from sigmoidal plots of their ¹H NMR-determined concentrations versus time exposed to laboratory-simulated shallow frying episodes at a temperature of 180° C. In this manner, both types of OSI value may be determined simultaneously using the same analytical technique. Similarly, oil iodine values (IVs) are also readily determined from our ¹H NMR analysis of the individual acylglycerol fatty acid contents of these products.

### Peroxide Values (Recommended AOCS Method)

The lipid peroxide levels of all culinary oils investigated, both unheated (control) and thermally-stressed samples, was determined using the recommended AOCS method for this analysis [12]. Specifically, the iron(III)-thiocyanate method will be employed for this purpose.

p-Anisidine Values

Similarly, the p-anisidine value (AV) was determined on all oil samples evaluated in this study according to the AOCS Official Method Cd 18-90, which was reapproved in 2017. The AV serves as a measure of aldehyde levels generated in culinary oil or fat samples, most especially the more toxic unsaturated classes (predominantly isomeric 2-alkenals and alka-2,4-dienals). For this analysis, iso-octane solutions of the oils will be reacted with p-anisidine in glacial acetic acid to generate yellow-coloured reaction products. By convention, the p-anisidine value is defined as 100 times the visible absorbance value spectrophotometrically determined at a wavelength of 350 nm in a 1 cm cuvette of a solution which contains exactly 1.00 g of the oil in a 100 mL volume of a mixture of solvents and reagents.

### ¹³C NMR Evaluations

Notwithstanding, a range of molecularly-valuable NMR applications to the analysis of lipids and further associated agents in culinary oils are provided by ¹³C NMR spectroscopy, and these benefits predominantly arise from the much more expansive chemical shift range of resonances in the spectral profiles acquired. Indeed, one important advantage of the ¹³C NMR analysis is determination of the fatty acid substitutional status of the predominantly triacylglycerol (TAG) glycerol backbones, indices which serve to provide much useful molecular information regarding oil authenticities. Such applications are readily achievable and straightforward, and additionally methylenic, vinylic and carbonyl function ¹³C NMR signals are readily exploitable for the structure-specific and direct determination of the relative quantities of fatty acids present at each molecular locality.

The biosynthesis of triacylglycerols (TAGs) in vegetable and also marine oils features a preferential esterification of particular unsaturated fatty acids (USFAs) in the sn-2 (central) backbone position; for example, in authentic olive oil products, the contents of oleate and linoleate located at this site represents 98-99% of the total fatty acid content, whereas that of saturated fatty acids (SFAs) at this substitutional position is not permitted to exceed 1.5%. However, with neutralisation of the relatively high free fatty acid content of, for example, olive-pomace oils, large quantities of free fatty acids (FFAs) are recovered. Such FFA mixtures may subsequently be commercially esterified back to TAGs via treatment with glycerol, and the synthetic (chemically-esterified) oils arising therefrom contain such fatty acids randomly distributed on the two (sn-1(3)- or sn-2-) glycerol backbone sites, i.e. 67 and 33% at the sn-1(3) and sn-(2) positions respectively, so that ca. 15% (w/w) of available saturated fatty acids (SFAs) are present at this authentification-specific sn-(2) position.

¹H and ¹³C NMR Analysis of Diacylglycerols, Monoacylglycerols and Free Fatty Acids

¹H NMR analysis provides much valuable molecular information regarding the molecular nature of TAG hydrolysis products such as sn-(1,2)- and sn-(1,3)-diacylglycerols, sn-(1/3)- and sn-(2) monoacylglycerols, together with free glycerol. Such information is supported by the acquisition of ¹³C NMR spectra, the glyceryl carbon pattern of which allows the rapid, virtually non-invasive determination of the relative sn-(1,2)- and sn-(1,3)-diacylglycerol contents of culinary oils. Again, such observations are of paramount importance regarding the authentification status of oils tested, since higher concentrations of such diacylglycerols are commonly found in either neutralised or refined products. Indeed, although they remove FFAs, common culinary oil refining processes, which involve methodologies for chemical and/or physical neutralisation, together with those for bleaching and deodourising, give rise to only a partial reduction in the levels of diacylglycerols, which are absorbed within the ‘soapy’ phase featured in oil neutralisation and washing regimens. Therefore, the total quantities of diacylglycerols present, together with the ratio of sn-(1,3)-diacylglycerol concentration to this parameter, can permit discrimination between virgin and refined vegetable oils.

### 7. ¹³C NMR Method for Monitoring of Free Acidity (Free Fatty Acids) in Culinary Oil Products

Determination of the FFA contents of culinary oil products generally represents one of the most important primary methods of classifying them according to their origin, pre-processing and frying use treatments, and comparisons of the relative intensities of the FFA carbonyl function ¹³C NMR resonances (δ=176-178 ppm) to those of the glycerol-esterified ones (δ=171-174 ppm) represents a quantitative index for monitoring the free acidity of such products (expressed as a percentage mole fraction).

### Diacylglycerol Contents and Oil Freshness

The FFA, diacylglycerol and monoacylglycerol contents of such culinary oils, which are all readily determined from a combination of ¹H and ¹³C NMR analyses, are parameters which may be employed to determine the degree of lipolytic alteration of TAGs, and which in vegetable oils is related to the quality of the vegetables or vegetable seeds from which these products arise. Both oil storage conditions and oil sn-(1,2)- and sn-(1,3)-diacylglycerol contents, can also represent markers of storage; sn-(1,2)-diacylglycerols are native molecular species, whereas the sn-(1,3) derivatives are derived from lipolysis or isomerisation reactions.

### Determination of the Trans-Fatty Acid Contents of Culinary Frying Oils

Since the absence or undetectability of trans-fatty acids in virgin or extra-virgin vegetable-derived culinary oils serves as a purity index, the relatively facile ¹³C NMR determination of these unnatural lipid species provides an additional valuable authentification index—refined, i.e. bleached and deodourised oils, nearly always contain ¹³C NMR-detectable levels of such trans-fatty acids (for example, 0.10-1.00% for refined olive and olive-pomace oils). For ¹³C NMR analysis, the methylene function region of such spectra are very useful since the chemical shift value of the trans-allylic ¹³C signal (6=32.5-32.7 ppm) exhibits only a very limited dependence on its precise carbon-carbon double bond location.

Furthermore, the vinylic ¹³C resonances are valuable for determining differing trans-isomers and permitting evaluations of the positional distributions of such differing species, and these offer major advantages over alternative analytical techniques available, such as those based on chromatographic separation.

### Unsaponification Fraction Analysis

Where relevant, the molecular compositions of culinary oil products may also be assessed by high-resolution NMR analysis of their unsaponifiable fractions, which is predominantly constituted of squalene, β-sitosterol, and further additional sterols and stanols, together with various aliphatic alcohols. Indeed, this approach, involving both ¹H and ¹³C NMR spectroscopies, has been employed in conjunction with MV chemometric analysis in order to discriminate between, for example, genuine virgin olive oil and its refined or olive-pomace products (the prior acquisition of ¹H and ¹³C NMR spectra of these agents in pure, authentic form serves to facilitate these determinations). Fortunately, the C18-methyl group functions of these molecules has ¹H NMR signals located at very high field (i.e., 6=0.50-0.72 ppm), and hence are fully resolved from the nearest acylglycerol-CH₃ function ones (i.e. 6=0.87-0.98 ppm) Moreover, resonances arising from steroidal hydrocarbons derived from oil refinement processes (stimastadienes) have also been acquired and interpreted.

### Quality Assessments of Culinary Oils

These quality assessments are, in general, related to each culinary oil's oxidative stability, sensitivities and sensory properties, together with their nutritional properties, and both ¹H and ¹³C NMR spectral profiles acquired can provide a high level of complementary molecular information regarding the quality of these products.

¹H and ¹³C NMR analysis of the phenolic antioxidant fractions of culinary oil products.

Phenolic compounds detectable in culinary oil products, notably virgin oils, offer valuable health and health-protective benefits, since they (1) add to the nutritional properties of such products, and (2) offer a valuable defence against the free radical-mediated oxidation of unsaturated fatty acids (especially PUFAs), during periods of transport and storage. As expected, the phenolic compound content of a range of unrefined culinary oils is strongly correlated to their oxidative stabilities when exposed to storage for prolonged periods of time. However, these measurements are also correlated with their potential roles in determining consumer acceptability sensory responses. Since these agents are readily detectable and monitored in such oils via a combination of ¹H and ¹³C NMR analyses, we shall also employ these analytical strategies to evaluate their contents in the culinary oils to be investigated.

### Results

Culinary frying oils underwent laboratory-simulated frying episodes at 180° C. Aldehydic lipid oxidation products (LOPs) and triacylglycerol fatty acids were determined by high-resolution proton (¹H) nuclear magnetic resonance (NMR) analysis in Zero Acre Farms, sunflower, corn, extra virgin olive, avocado, palm, canola and coconut oil samples collected at the 0, 5, 10, 20, 30, 60 and 90 minute simulated frying time-points. In addition to monitoring the time-dependent production of toxic LOPs such as aldehydes in these thermally-stressed cooking oils, the aldehyde generation lag phase was also determined from these oils. This lag phase is defined as the time taken prior to significant aldehyde generation in oils exposed to simulated frying episodes at the above temperature, and is determined from plots of individual aldehyde class levels against heating time mainly through cubic spline fitting approaches). Typically, PUFA-rich oils such as sunflower oil have short lag phases, whereas MUFA- and saturated fatty acid-(SFA)-rich frying media have longer and very much longer values, respectively.

Substantially lower levels of aldehydes were generated in the Zero Acre Farms product than those observed in PUFA-rich ones, e.g. only 18±3% of the total more toxic α,β-unsaturated aldehyde content of PUFA-rich sunflower oil at the 20 min. simulated pan frying time-point. With the exception of trans-2-alkenals, all these unsaturated aldehydes are derived from the heat-stimulated peroxidation of PUFAs and not MUFAs. In fact, only low concentrations of these more toxic classes of aldehydes were generated in the Zero Acre Farms product at this 20 minute simulated frying time-point. Moreover, the only aldehyde toxin classes detectable in this MUFA-rich oil at an extended heating time-point of 90 minutes were trans-2-alkenals and alka-2,4-dienals, with substantially lower concentrations of the latter than that for sunflower oil.

Further experiments demonstrated that other MUFA-rich cooking oils such as avocado and extra virgin oils (containing 71% MUFAs and 13% (w/w) PUFAs, and 73% MUFAs and 11% (w/w) PUFAs respectively) generated only 23 and 22%, respectively, of the total α,β-unsaturated aldehyde concentration of sunflower oil at the 20 min. simulated frying time-point.

Oxidative lag-phase times observed for these frying oils are provided in the Table 1. For the MUFA-rich Zero Acre Inc. frying oil, no 4,5-epoxy-trans-2-alkenals were generated whatsoever up to a thermal stressing time-point of 90 min., but this class of toxic aldehydic LOP was formed in extra-virgin olive and avocado oils from the 20 and 60 minute heating episodes at 180° C., respectively.

In conclusion, the MUFA-rich, low PUFA, Zero Acre frying oil product tested generated markedly lower levels of food-penetrative and therefore food-ingestible, toxic aldehydes than PUFA-rich ones such as sunflower oil when exposed to laboratory-simulated frying episodes. Since aldehydes detectable in fried potato chip servings are predominantly frying oil-derived, this PUFA-depleted oil potentially offers many health-friendly advantages when employed for high-temperature frying or cooking purposes. Further, when incorporated into other edible compositions, such as the mayonnaise described herein, the low PUFA Zero Acre oil should prevent those compositions from decomposing into high levels of toxic aldehydes at ambient or elevated temperatures.

The ¹H NMR Technique employed for the analysis of cooking oils has the ability to detect and quantify 100 or more different food/lipid molecules simultaneously, with an analysis time of 10-15 minutes per sample. Other molecules detected in this study included conjugated hydroperoxydienes (PUFA-generated primary LOPs, which represent precursors of aldehydes), epoxy-fatty acid LOPs, and tocopherol antioxidants, together with cholesterol-blocking sterols and stanols in selected oil products.

The below table shows a summary of results data:

TABLE 1
Oxidative lag-phase times observed for these frying oils

| | | Lag Phase Time (min.) | | | |
|---|---|---|---|---|---|
| | | | trans,trans- | | |
| | Peroxidative | trans-2- | Alka-2,4- | | Other |
| Culinary | Susceptibility | Alkenals | dienals | n-Alkanals | unsaturated |
| Oil | Index (PSI) | (unsaturated) | (unsaturated) | (saturated) | aldehydes |
| Sunflower | 63.6 | 7 | 7 | 6 | 4-8 |
| Corn | 61.1 | 6 | 6 | <5 | 4-10 |
| Canola | 38.2 | 10 | 11 | 9 | 9-15 |
| Extra-Virgin | 13.0 | 7 | 8 | 7 | 20-30 |
| Olive | | | | | |
| Avocado | 16.3 | 15 | 18 | 13 | 20-60 |
| Cultured Oil | 5.6 | 20 | 20 | 20 | n/a |

The below table 2 shows the full results data set values for measured compounds are reported as mmol/kg.

TABLE 2
Measured compounds in frying oils

| | | | | | | 4- | | | | | |
|---|---|---|---|---|---|---|---|---|---|---|---|
| | Repli- | Heating | | | 4,5-Epoxy- | Hydroperoxy-/ | | | | Total | Worst |
| | cate | Time | (E)-2- | (E,E)-2,4- | (E)-2- | 4-Hydroxy- | (Z,E)-2,4- | n- | (Z)-2- | Alde- | Alde- |
| Oil Tested | No. | (min.) | Alkenals | Alkadienals | alkenals | (E)-2-alkenals | Alkadienals | Alkanals | Alkenals | hydes | hydes |
| Cultured Oil | 1 | 0 | 0 | 0 | 0 | 0 | 0 | 0 | 0 | 0 | 0 |
| Cultured Oil | 2 | 0 | 0 | 0 | 0 | 0 | 0 | 0 | 0 | 0 | 0 |
| Cultured Oil | 1 | 5 | 0.37 | 0 | 0 | 0 | 0 | 0.37 | 0 | 0.74 | 0 |
| Cultured Oil | 2 | 5 | 0 | 0 | 0 | 0 | 0 | 0 | 0 | 0 | 0 |
| Cultured Oil | 1 | 10 | 0.2 | 0 | 0 | 0 | 0 | 0.44 | 0 | 0.64 | 0 |
| Cultured Oil | 2 | 10 | 0.09 | 0.09 | 0 | 0 | 0 | 0.23 | 0 | 0.41 | 0.09 |
| Cultured Oil | 1 | 20 | 5.96 | 0.25 | 0 | 0.06 | 0 | 5.66 | 0 | 11.93 | 0.31 |
| Cultured Oil | 2 | 20 | 3.33 | 0.19 | 0 | 0.05 | 0 | 3.71 | 0 | 7.28 | 0.24 |
| Cultured Oil | 1 | 30 | 10.8 | 0 | 0 | 0.37 | 0 | 9.31 | 0.14 | 20.62 | 0.51 |
| Cultured Oil | 2 | 30 | 6.88 | 0 | 0 | 0.33 | 0 | 6.71 | 0.09 | 14.01 | 0.42 |
| Cultured Oil | 1 | 60 | 21.2 | 0 | 0 | 0.7 | 0 | 16.31 | 0.75 | 38.96 | 1.45 |
| Cultured Oil | 2 | 60 | 15.1 | 0 | 0 | 0.44 | 0 | 12.13 | 0.58 | 28.25 | 1.02 |
| Cultured Oil | 1 | 90 | 21.69 | 0 | 0 | 0.85 | 0 | 22.7 | 0.93 | 46.17 | 1.78 |
| Cultured Oil | 2 | 90 | 17.8 | 0 | 0 | 0.69 | 0 | 17.65 | 0.71 | 36.85 | 1.4 |
| | | | | | | | | | | 0 | 0 |
| Corn Oil | 1 | 0 | 0 | 0 | 0 | 0 | 0 | 0 | 0 | 0 | 0 |
| Corn Oil | 2 | 0 | 0 | 0 | 0 | 0 | 0 | 0 | 0 | 0 | 0 |
| Corn Oil | 1 | 5 | 0.71 | 0.4 | 0 | 0 | 0 | 0 | 0 | 1.11 | 0.4 |
| Corn Oil | 2 | 5 | 0.26 | 0.23 | 0 | 0 | 0 | 0 | 0 | 0.49 | 0.23 |
| Corn Oil | 1 | 10 | 1.68 | 1.52 | 0.7 | 0.62 | 0.68 | 1.6 | 0 | 6.8 | 3.52 |
| Corn Oil | 2 | 10 | 1.98 | 1.75 | 0.78 | 0.85 | 0.85 | 1.82 | 0 | 8.03 | 4.23 |
| Corn Oil | 1 | 20 | 4.52 | 4.39 | 1.48 | 1.26 | 1.76 | 3.62 | 0 | 17.03 | 8.89 |
| Corn Oil | 2 | 20 | 5.88 | 5.41 | 1.68 | 1.44 | 2.05 | 4.38 | 0 | 20.84 | 10.58 |
| Corn Oil | 1 | 30 | 7.86 | 6.53 | 2.05 | 1.72 | 2.244 | 5.36 | 0 | 25.76 | 12.54 |
| Corn Oil | 2 | 30 | 9.28 | 8.46 | 2.45 | 1.91 | 2.77 | 6.66 | 0 | 31.53 | 15.59 |
| Corn Oil | 1 | 60 | 16.2 | 11.02 | 4.03 | 3.1 | 3.41 | 8.26 | 1.38 | 47.4 | 22.94 |
| Corn Oil | 2 | 60 | 20.78 | 14.76 | 4.85 | 4.21 | 4.66 | 11.83 | 2 | 63.09 | 30.48 |
| Corn Oil | 1 | 90 | 35.94 | 20.08 | 8.68 | 7.21 | 6.77 | 16.75 | 3.23 | 98.66 | 45.97 |
| Corn Oil | 2 | 90 | 33.58 | 16.12 | 5.92 | 5.62 | 4.85 | 15.94 | 3.28 | 85.31 | 35.79 |
| | | | | | | | | | | 0 | 0 |
| Sunflower Oil | 1 | 0 | 0.972 | 0.864 | 0 | 0 | 0 | 1.056 | 0 | 2.892 | 0.864 |
| Sunflower Oil | 2 | 0 | 0.876 | 0.744 | 0 | 0 | 0 | 0.912 | 0 | 2.532 | 0.744 |
| Sunflower Oil | 3 | 0 | 0 | 0 | 0 | 0 | 0 | 0 | 0 | 0 | 0 |
| Sunflower Oil | 1 | 5 | 1.092 | 0.804 | 0 | 0 | 0 | 0.996 | 0 | 2.892 | 0.804 |
| Sunflower Oil | 2 | 5 | 1.188 | 1.032 | 0 | 0 | 0 | 1.116 | 0 | 3.336 | 1.032 |
| Sunflower Oil | 3 | 5 | 0 | 0.08 | 0 | 0 | 0 | 0.14 | 0 | 0.22 | 0.08 |
| Sunflower Oil | 1 | 10 | 1.81 | 1.67 | 0.86 | 0 | 0.8 | 1.51 | 0 | 6.65 | 3.33 |
| Sunflower Oil | 2 | 10 | 2.04 | 2.06 | 0.83 | 0 | 1.01 | 1.9 | 0 | 7.84 | 3.9 |
| Sunflower Oil | 3 | 10 | 1.5 | 2.48 | 0.27 | 0.71 | 0 | 1.49 | 0 | 6.45 | 3.46 |
| Sunflower Oil | 1 | 20 | 5.76 | 5.58 | 1.85 | 1.42 | 2.02 | 3.91 | 1.21 | 21.75 | 12.08 |
| Sunflower Oil | 2 | 20 | 6.29 | 5.76 | 1.8 | 1.32 | 2.05 | 4.57 | 0.96 | 22.75 | 11.89 |
| Sunflower Oil | 3 | 20 | 4.9 | 4.55 | 0.67 | 2.16 | 0 | 4.98 | 0 | 17.26 | 7.38 |
| Sunflower Oil | 1 | 30 | 9.97 | 8.33 | 2.62 | 2.21 | 2.81 | 6.1 | 1.42 | 33.46 | 17.39 |
| Sunflower Oil | 2 | 30 | 10.66 | 8.33 | 2.63 | 2.16 | 3.01 | 7.3 | 1.42 | 35.51 | 17.55 |
| Sunflower Oil | 3 | 30 | 9.41 | 6.27 | 1.65 | 3.21 | 0.52 | 10.1 | 0.22 | 31.38 | 11.87 |
| Sunflower Oil | 1 | 60 | 21.74 | 14.16 | 5.53 | 4.3 | 4.24 | 11.42 | 1.64 | 63.03 | 29.87 |
| Sunflower Oil | 2 | 60 | 23.71 | 12.97 | 4.96 | 4.61 | 4.21 | 13.76 | 2.2 | 66.42 | 28.95 |
| Sunflower Oil | 3 | 60 | 19.52 | 9.04 | 3.76 | 7.18 | 2.41 | 23.35 | 0.84 | 66.1 | 23.23 |
| Sunflower Oil | 1 | 90 | 34.27 | 14.47 | 6.13 | 5.47 | 3.73 | 15.41 | 2.32 | 81.8 | 32.12 |
| Sunflower Oil | 2 | 90 | 32.44 | 12.75 | 6.78 | 6.43 | 4.97 | 18.1 | 2.41 | 83.88 | 33.34 |
| Sunflower Oil | 3 | 90 | 26.45 | 10.35 | 5.15 | 10.54 | 3.59 | 33.45 | 1.28 | 90.81 | 30.91 |
| | | | | | | | | | | 0 | 0 |
| Olive Oil | 1 | 0 | 0 | 0 | 0 | 0 | 0 | 0 | 0 | 0 | 0 |
| Olive Oil | 1 | 5 | 0 | 0 | 0 | 0 | 0 | 0 | 0 | 0 | 0 |
| Olive Oil | 1 | 10 | 2.76 | 2.08 | 1.1 | 0.83 | 1.21 | 2.56 | 0 | 10.54 | 5.22 |
| Olive Oil | 1 | 20 | 7.34 | 3.74 | 1.49 | 1.24 | 1.63 | 5.41 | 0 | 20.85 | 8.1 |
| Olive Oil | 1 | 30 | 14.8 | 4.9 | 2.39 | 2.02 | 2.14 | 8.95 | 1.57 | 36.77 | 13.02 |
| Olive Oil | 1 | 60 | 26.38 | 6.04 | 3.68 | 3.29 | 2.83 | 10.62 | 2.04 | 54.88 | 17.88 |
| Olive Oil | 1 | 90 | 31.38 | 5.99 | 3.66 | 3.37 | 2.86 | 10.7 | 2.03 | 59.99 | 17.91 |
| | | | | | | | | | | 0 | 0 |
| Rapeseed Oil | 1 | 0 | 0 | 0 | 0 | 0 | 0 | 0 | 0 | 0 | 0 |
| Rapeseed Oil | 2 | 0 | 0 | 0 | 0 | 0 | 0 | 0 | 0 | 0 | 0 |
| Rapeseed Oil | 1 | 5 | 0 | 0 | 0 | 0 | 0 | 0 | 0 | 0 | 0 |
| Rapeseed Oil | 2 | 5 | 0 | 0 | 0 | 0 | 0 | 0 | 0 | 0 | 0 |
| Rapeseed Oil | 1 | 10 | 1.34 | 1.4 | 0 | 0 | 0 | 0 | 0 | 2.74 | 1.4 |
| Rapeseed Oil | 2 | 10 | 1.73 | 1.9 | 0 | 0 | 0 | 0 | 0 | 3.63 | 1.9 |
| Rapeseed Oil | 1 | 20 | 4.9 | 4.44 | 0 | 0 | 1.85 | 3.98 | 0 | 15.17 | 6.29 |
| Rapeseed Oil | 2 | 20 | 5.88 | 5.32 | 0 | 0 | 2.08 | 4.76 | 0 | 18.04 | 7.4 |
| Rapeseed Oil | 1 | 30 | 9.62 | 7.13 | 2.44 | 2.27 | 2.57 | 6.94 | 1.14 | 32.11 | 15.55 |
| Rapeseed Oil | 2 | 30 | 12.8 | 9.28 | 3.25 | 3 | 3.52 | 9.12 | 1.64 | 42.61 | 20.69 |
| Rapeseed Oil | 1 | 60 | 21.05 | 10.57 | 4.31 | 4.4 | 3.88 | 12.53 | 2.02 | 58.76 | 25.18 |
| Rapeseed Oil | 2 | 60 | 18.29 | 13.32 | 5.76 | 5.62 | 4.88 | 15.71 | 2.53 | 66.11 | 32.11 |
| Rapeseed Oil | 1 | 90 | 29.3 | 11.99 | 5.94 | 6.06 | 4.93 | 15.24 | 3.38 | 76.84 | 32.3 |
| Rapeseed Oil | 2 | 90 | 30.18 | 14.02 | 6.68 | 6.14 | 5.86 | 16.99 | 3.54 | 83.41 | 36.24 |
| | | | | | | | | | | 0 | 0 |
| Soybean Oil | 1 | 0 | 0 | 0 | 0 | 0 | 0 | 0 | 0 | 0 | 0 |
| Soybean Oil | 2 | 0 | 0 | 0 | 0 | 0 | 0 | 0 | 0 | 0 | 0 |
| Soybean Oil | 1 | 5 | 0 | 0 | 0 | 0 | 0 | 0 | 0 | 0 | 0 |
| Soybean Oil | 2 | 5 | 0 | 0 | 0 | 0 | 0 | 0 | 0 | 0 | 0 |
| Soybean Oil | 1 | 10 | 1.43 | 1.39 | 0 | 0 | 0 | 1.54 | 0 | 4.36 | 1.39 |
| Soybean Oil | 2 | 10 | 1.02 | 1.01 | 0 | 0 | 0 | 0.79 | 0 | 2.82 | 1.01 |
| Soybean Oil | 1 | 20 | 2.87 | 3.05 | 0 | 0 | 1.48 | 3.06 | 0 | 10.46 | 4.53 |
| Soybean Oil | 2 | 20 | 1.31 | 1.44 | 0 | 0 | 0.84 | 1.31 | 0 | 4.9 | 2.28 |
| Soybean Oil | 1 | 30 | 6.74 | 7.01 | 2.86 | 2.39 | 3.53 | 5.1 | 1.67 | 29.3 | 17.46 |
| Soybean Oil | 2 | 30 | 2.92 | 3.2 | 1.49 | 1.44 | 1.86 | 2.57 | 1.14 | 14.62 | 9.13 |
| Soybean Oil | 1 | 60 | 20.63 | 14.8 | 6.12 | 5.04 | 6.12 | 11.21 | 2.96 | 66.88 | 35.04 |
| Soybean Oil | 2 | 60 | 9.18 | 7.56 | 2.94 | 2.63 | 3.06 | 5.66 | 1.32 | 32.35 | 17.51 |
| Soybean Oil | 1 | 90 | 35.04 | 15.38 | 6.91 | 5.86 | 5.7 | 13.86 | 3.79 | 86.54 | 37.64 |
| Soybean Oil | 2 | 90 | 22.38 | 10.13 | 4.16 | 3.72 | 3.65 | 8.22 | 1.78 | 54.04 | 23.44 |

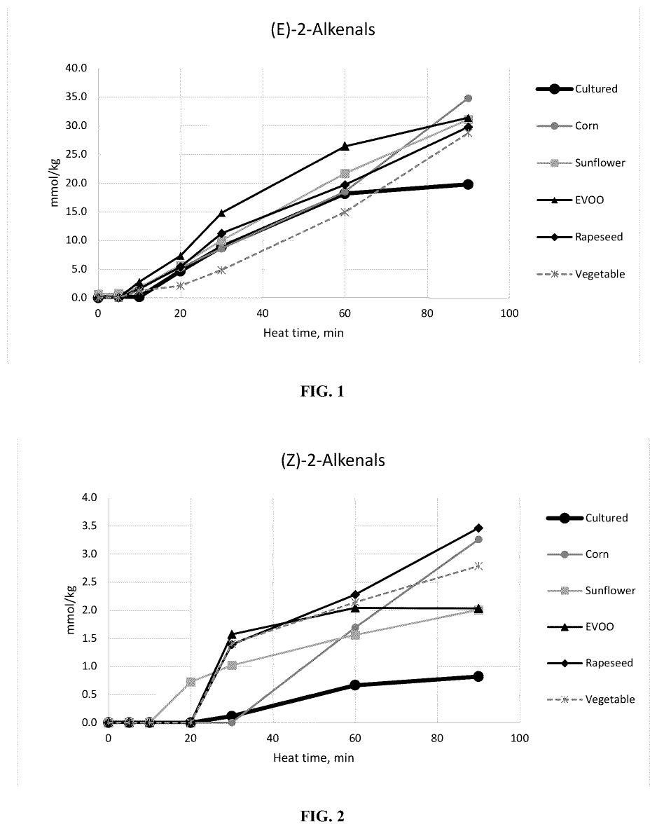

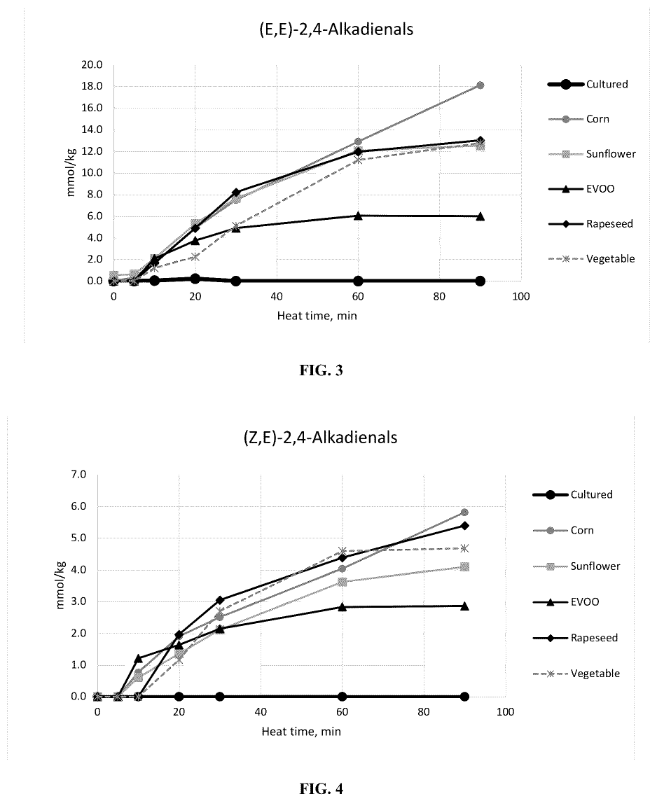

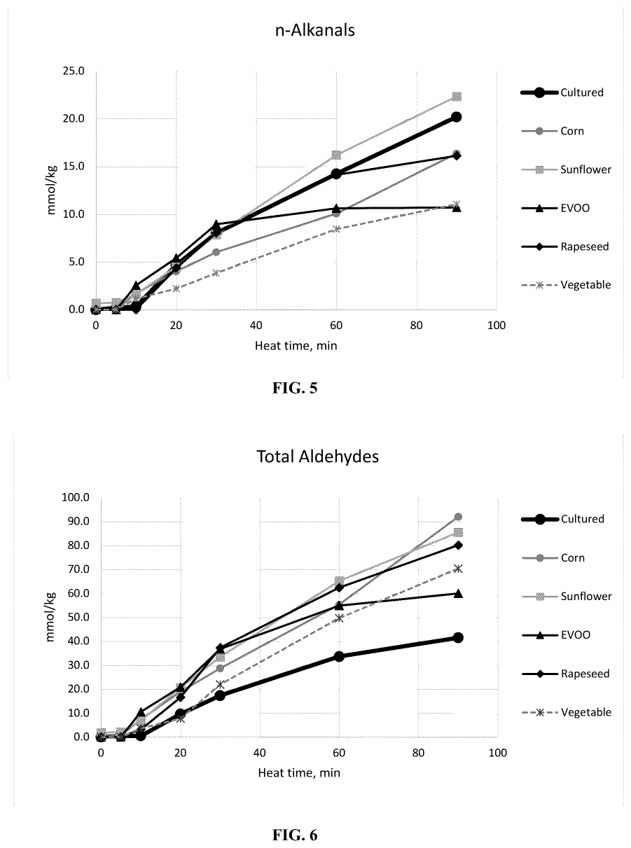

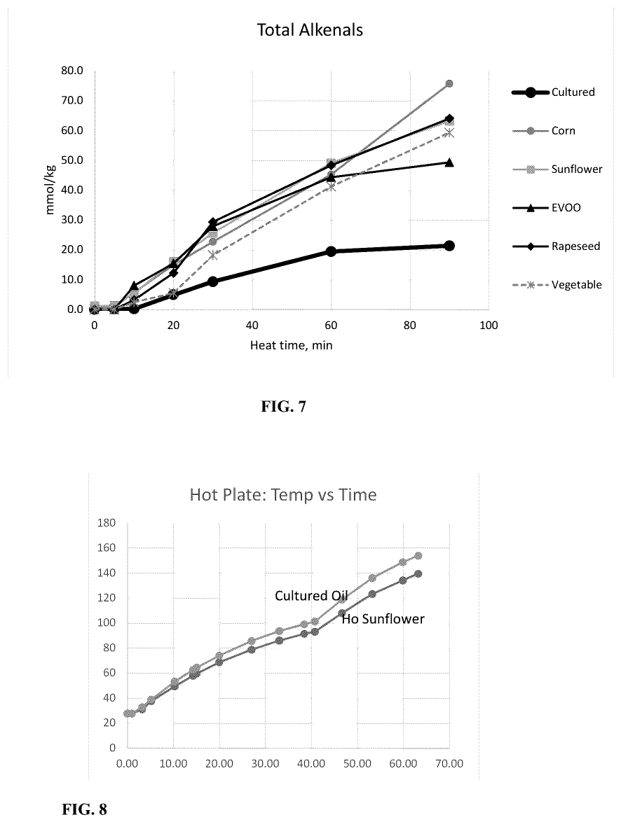

The above data is illustrated in FIGS. 1-7. Soybean oil is labeled as vegetable oil in FIGS. 1-7.

### Example 16—Improvements to Cooking Times

The cost of cooking a food product in oil, such as a deep-fried food product, is in part determined by the temperature of the oil required to cook the product and the time the product is required to be exposed to the hot oil. If a product can be cooked in a lower temperature oil, then less energy is required to heat the oil. If a product can be cooked in a shorter period of time, more product can be produced from the same equipment over a given time period. If both lower temperature and shorter times can be achieved, there is a combined value. Described here is a cooking apparatus, such as a deep fryer, which contains an oil that has a lower heat capacity than a conventional frying oil. As a result, the oil requires less energy to reach a target cooking temperature and will reach that temperature in a shorter period of time than given the same power. As a result, the energy and time spent to heat the will be less. Food, such as potatoes, chicken, onion rings, and the like, placed in the heated oil in the apparatus, will cook more rapidly than the same food placed in a similar apparatus containing a conventional frying oil. As the oil has a lower heat capacity, the transfer of heat from the oil to the food will be more efficient, resulting in the food requiring less time to be cooked.

### Example 17—Identification of an Oil Requiring a Shorter Time to Reach Temperature

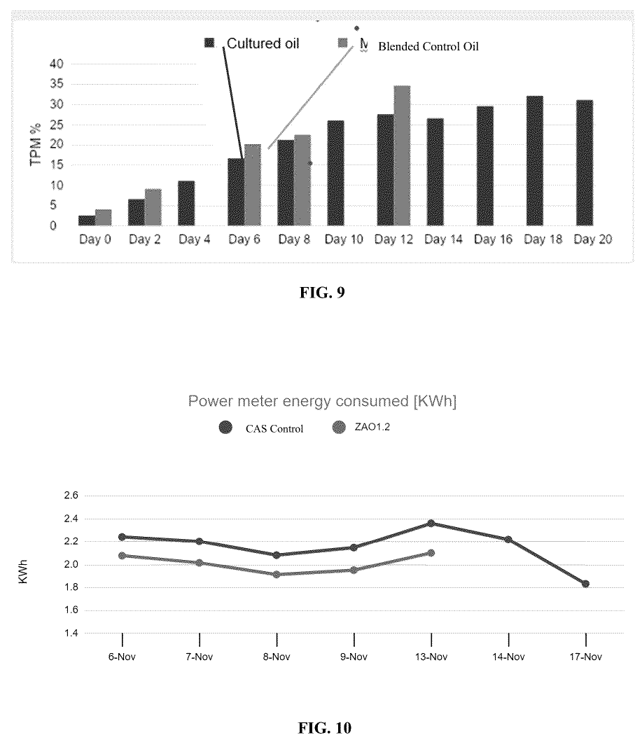

Oils with different heat capacities would be expected to change temperatures as different rates when exposed to the same amount of conductive heat. High oleic soybean oil, which is commercially used for cooking and deep frying in restaurants and food manufacturing was compared to an oil produced by from the fermentation of sugar (cultured oil) for the rate of temperature change. The composition of the two oils are shown in Table 3. 700 g of each oil was placed in a 1 L glass beaker, and each of the beakers were placed on identical heating elements (hot plates). A high temperature thermometer was placed in each, and to initiate the comparison the hot plates were set to 180 F at the same time. The temperature of the oils were then monitored and recorded over the course 65 minutes. At 40 minutes, the set point of the hot plates were each increased to 340 F. As is shown in FIGS. 8-9. the cultured oil shows a higher rate of temperature increase than the high oleic sunflower oil, this is observed over the first 40 minutes when the temperature is set for 180 F and is increased when the temperature was set to 340 F. This is a surprising finding, as both oils are rich in oleic acid. However, the cultured oil has over 90% oleic acid, while the high oleic sunflower oil has no more than 80%. Further, the cultured oil has less than 4% saturated and less than 3% polyunsaturated fatty acids. As the complexity of the mixture of triacylglycerols is significantly lower in the cultured oil in comparison to the high oleic sunflower oil, it is possible it is the more homogeneous nature of the cultured oil that imparts its apparent lower heat capacity.

### Example 18: Demonstration of a Lower Energy Requirement for the Heating of Cultured Oil Vs Soybean Oil

To evaluate the energy consumption required to heat soybean oil in comparison to cultured oil, two small deep fryers were filled with 3.47 kg of either commercially available Soybean (CAS) or Cultured Oil (ZAO 1.2). Each fryer was plugged into a power meter that tracked the current flowing to the fryer and the total power (kW/h) consumed. Each fryer was turned on and set to 350 F for 8 hours/day for 11 days. The daily energy consumed by each fryer to maintain the target temperature are shown in FIG. 11. As shown, surprisingly the cultured oil consumed consistently about 10% less energy to maintain the oil at 350 F.

### Example 19—Demonstration of Shorter Cooking Time in Oil Having Apparent Lower Heat Capacity

In a real-life comparison, potatoes were fried in cultured oil (Example 17, above) vs a commercial frying oil (blended oil—Cottonseed oil, canola oil, TBHQ and citric acid added to protect flavor, and dimethylpolysiloxane (antifoaming agent)). Commercial fryers were filled with either Cultured Oil or blended and set to the same target temperature (370 F), and then used over the course of 2-3 weeks to cook French fries. The time required to cook the fries in the blended oil was consistently 1 minute 45 seconds (105 seconds) in fresh oil, increasing over 12 days to 2 minutes and 10 seconds (130 seconds), before the oil needed to be discarded. In comparison, the cultured oil required only 1 minute and 20 seconds (80 seconds) when the oil was fresh, moving to 1 minute and 55 seconds (115 seconds) by the 20th day, when the oil was changed. This is consistent with the oil having a lower heat capacity and being more efficient at transferring heat from the oil to the food. This significant decrease in the time required to cook fries, results in 30-40% increase in available time for frying additional French fry orders.

### Example 20—Improvements to Cooking Times

An oil with a lower heat capacity can transfer heat to food more efficiently, which can result in foods cooking faster than those cooked at the same temperature in an oil having a higher heat capacity. Accordingly, foods cooked for the same amount of time in two oils of different heat capacities might appear different, for example with the one cooked in the low heat capacity oil appearing darker as a result of absorbing more heat and being more cooked. To remedy this, foods cooked in a low heat capacity oil should be able to be cooked at a lower temperature setting and would achieve the same level of cooking as a food cooked in an oil of higher heat capacity set to a higher temperature, over the same period of time. To explore this, a pan containing 30 mL of common vegetable oil is heated until the oil reaches 350 F, three 2 g potato cubes are put in the oil, and they are cooked, turning every 15 seconds for 2 minutes. The potatoes are removed and evaluated for color. An identical pan containing 30 mL of cultured oil is them brought 350 F, and cooking of potatoes is carried out as before. The potatoes cooked at the 350 F in cultured oil are notably darker in color and are “more cooked.” The experiment is repeated with the cultured oil but with the oil being set at lower and lower temperatures (345, 340, 335, 330 F, etc). The potatoes from each experiment are then compared for color development and level of cooking to those cooked in the vegetable oil at 350 F. Potatoes reaching the same color and level of cooking when cooked in the cultured oil for 2 minutes required a significantly lower temperature set point. As a result, cooking food in an oil having a lower heat capacity appears to have the surprising advantage of requiring a lower temperature set point.

### Example 21—Total Polar Materials (TPM) Content of Heated Oils

Total polar materials (TPM) is an analytical method used to track the development of oxidation breakdown products in frying oils, and it can be used to monitor the state or quality of a frying oil over its time of use to cook food. When oils are used for frying food, they can degrade by several mechanisms the result in the production of these polar materials. This is usually driven by three major mechanisms, 1) hydrolysis of the oils to fatty acids, diglycerides, and monoglycerides. Water released from food when placed in the oils are the primary catalyst of this initial reaction, 2) oxidation of the oils and the fatty acids released by hydrolysis. Oxygen abstracts hydrogen atoms from the fatty acid molecule, resulting in carbon radicals that rearrange and further react with oxygen. This chemistry produces peroxides, epoxides, alcohols, ketones, aldehydes, acids, dimers, and polymers, each of which are “polar materials.” Note, saturated fats are more resistant to oxidation than unsaturated fats, and polyunsaturated fats are much more sensitive (fragile) to oxidation than monounsaturated and saturated fats, and 3) reaction with compounds that leach from food, such as carbohydrates, protein, small molecules, and other fats. All of these can accumulate over time and change the properties of the oil as cooking medium. In common vegetable oils, TPM is good predictor of oil quality as high TPM usually correlates with poor food sensory scores and oil rancidity.

Since cultured oil is very high in monounsaturated fat (MUFA) (oleic acid >90%) and very low in polyunsaturated fat (PUFA) (≤3%), it is predicted that cultured oil would have a longer frying life than commercial vegetable oils which are rich in the very unstable polyunsaturated fats, such as linoleic acid. Oil samples were collected from the fryers described in Example 17, and the TPM for each oil was tracked over time. As shown in FIG. 10, the rate of TPM increase is much higher for the commercially available blended oil, which is a mixture of vegetable oils and rich in polyunsaturated fats. Indeed, the commercially available blended oil by 12 days reached a TPM of over 40%, had become rancid (poor sensory), and was changed for fresh oil. The cultured oil, however, lasted for 20 days reaching a TPM of only 35, and surprisingly still showed no sign of rancidity or poor food sensory evaluations. Since the composition of the cultured oil is so rich in monounsaturated fats, it is likely that the molecular breakdown products that result in TPM for the two oils are different, and those for cultured oil do not result in poor sensory characteristics. For example, the blended oil as it is rich in PUFA, each fatty acid containing multiple double0. bonds are likely to further break down into smaller, reactive, and more oxygenated compounds that are more likely to cross react and impact flavor. However, the cultured oil, being mostly MUFA may primarily hydrolyze to the higher molecular weight free fatty acids, diglycerides, and monoglycerides, which may have a lower negative impact on the flavor and sensory characteristics of the cooked food.

While preferred embodiments of the present disclosure have been shown and described herein, it will be obvious to those skilled in the art that such embodiments are provided by way of example only. It is not intended that the present disclosure be limited by the specific examples provided within the specification. While the present disclosure has been described with reference to the aforementioned specification, the descriptions and illustrations of the embodiments herein are not meant to be construed in a limiting sense. Numerous variations, changes, and substitutions will now occur to those skilled in the art without departing from the present disclosure. Furthermore, it shall be understood that all aspects of the present disclosure are not limited to the specific depictions, configurations or relative proportions set forth herein which depend upon a variety of conditions and variables. It should be understood that various alternatives to the embodiments of the present disclosure described herein may be employed in practicing the present disclosure. It is therefore contemplated that the present disclosure shall also cover any such alternatives, modifications, variations or equivalents. It is intended that the following claims define the scope of the present disclosure and that methods and structures within the scope of these claims and their equivalents be covered thereby.

### Embodiments

Embodiment 1: A fryer containing a cooking oil that comprises a triacylglyceride (TAG) with a polyunsaturated fatty acids (PUFA) content of less than 2%.

Embodiment 2: The fryer of embodiment 1, wherein the TAG has a C18:2 fatty acid content of less than 1%.

Embodiment 3: The fryer of embodiments 1 or 2, wherein the TAG has a linoleic acid content of less than 1%.

Embodiment 4: The fryer of any one of embodiments 1-3, wherein the TAG has an omega-6 fatty acid content of less than 1%.

Embodiment 5: The fryer of any one of embodiments 1-4, wherein the TAG has a MUFA content of more than 50%.

Embodiment 6: The fryer of any one of embodiments 1-5, wherein the TAG has a MUFA content of 50% to 95%.

Embodiment 7: The fryer of any one of embodiments 1-6, wherein the TAG has a C18:1 fatty acid content of 70% or greater.

Embodiment 8: The fryer of any one of embodiments 1-7, wherein the TAG has a SFA content of 40% or greater.

Embodiment 9: The fryer of any one of embodiments 1-7, wherein the TAG has a SFA content of 5% to 15%.

Embodiment 10: The fryer of any one of embodiments 1-9, wherein the TAG has a SFA content of 5% to 90% and a MUFA content of 10% to 80%

Embodiment 11: The fryer of any one of embodiments 1-10, wherein the cooking oil has an OSI of greater than 50 hours without antioxidants added to the cooking oil.

Embodiment 12: The fryer of any one of embodiments 1-11, wherein the cooking oil has an OSI of greater than 100 hours without antioxidants added to the cooking oil.

Embodiment 13: The fryer of any one of embodiments 1-12, wherein the cooking oil has a TPM content below 10% after heating at a temperature greater than 250° F. for 4 hours.

Embodiment 14: The fryer of any one of embodiments 1-13, wherein the cooking oil has a TPM content below 10% after heating at a temperature greater than 300° F. for 4 hours.

Embodiment 15: The fryer of any one of embodiments 1-14, wherein the cooking oil has a TPM content below 10% after heating at a temperature greater than 350° F. for 4 hours.

Embodiment 16: The fryer of any one of embodiments 1-15, wherein the cooking oil has a TPM content below 10% after heating at a temperature greater than 400° F. for 4 hours

Embodiment 17: The fryer of any one of embodiments 1-16, wherein the cooking oil has a TPM content below 10% after heating from between 250° F. to 400° F. for 4 hours

Embodiment 18: The fryer of any one of embodiments 1-17, wherein the cooking oil has a TPM content of less than 24% after heating at 250° F. for three days.

Embodiment 19: The fryer of any one of embodiments 1-18, wherein the cooking oil comprises less than 5% free fatty acids after heating at 250° F. for 4 hours.

Embodiment 20: The fryer of any one of embodiments 1-19, wherein the cooking oil contains less than 3% of aldehydes after heating at 250° F. for 50 hours.

Embodiment 21: The fryer of any one of embodiments 1-13, wherein the cooking oil contains less than 1% of saturated aldehydes after heating at 250° F. for 50 hours.

Embodiment 22: The fryer of any one of embodiments 1-13, wherein the cooking oil contains less than 2% of α,β-unsaturated aldehydes after heating at 250° F. for 50 hours.

Embodiment 23: The fryer of any one of embodiments 1-13, wherein the cooking oil contains less than 0.5 mmol/mol FA of combined 4-hydrox/4-hydroperoxy-trans-2-alkenals after heating at 250° F. for 50 hours.

Embodiment 24: The fryer of any one of embodiments 1-13, wherein the cooking oil contains less than 5% w/w lipid oxidation products (LOP) after heating at 250° F. for 50 hours.

Embodiment 25: The fryer of any one of embodiments 1-13, wherein the cooking oil contains less than 350 μmol/L 4-hydroxy-trans-2-nonenal (HNE) after heating at 250° F. for 50 hours.

Embodiment 26: A fryer containing a cooking oil with a linoleic acid content is substantially negligible.

Embodiment 27: The fryer of embodiment 26, wherein the linoleic acid content is below a detection limit.

Embodiment 28: The fryer of embodiments 26 or 27, wherein the cooking oil is a yeast oil.

Embodiment 29: The fryer of embodiments 26 or 27, wherein the cooking oil is a non-photosynthetic microbial oil.

Embodiment 30: The fryer of any one of embodiments 26 to 29, wherein the cooking oil contains less than 5% oxidation products of linoleic acid.

Embodiment 31: The fryer of any one of embodiments 26 to 30, wherein the cooking oil contains less than 3% 4-hydroxynonenal (HNE).

Embodiment 32: The fryer of any one of embodiments 26 to 31, wherein the cooking oil contains less than 5 ppm of acrolein.

Embodiment 33: The fryer of any one of embodiments 26 to 32, wherein the cooking oil comprising less than 5 ppm of crotonaldehyde

Embodiment 34: The fryer of any one of embodiments 26 to 33, wherein the cooking oil comprising less than 100 ppm of detectable volatile aldehydes, such as alpha, beta-unsaturated aldehydes, including acrolein and crotonaldehyde.

Embodiment 35: A fryer containing a cooking oil comprising a specific heat which is less than a conventional cooking oil, and a food, wherein a time to cook the food in the cooking oil is less than a time to cook the food in the conventional cooking oil, optionally, wherein the conventional cooking oil is sunflower oil.

Embodiment 36: A fryer containing a cooking oil comprising a specific heat which is less than a conventional cooking oil, and a food, wherein a time to cook the food in the cooking oil is the same as a time to cook the food in the conventional cooking oil when a temperature of the cooking oil is less than a temperature of the conventional oil, optionally, wherein the conventional cooking oil is sunflower oil.

Embodiment 37: A fryer containing a food, and a cooking oil comprising at least 90% oleic acid, and less than 4% saturated fatty acids and less than 3% polyunsaturated fatty acids, wherein a time to cook the food in the cooking oil is less than a time to cook the food in the conventional cooking oil.

Embodiment 38: A fryer containing a cooking oil which is resistant to decomposition into polar materials as measured by total polar material (TMP) in the oil when heated to 370 F, wherein the oil comprises a TMP of less than 20% after 6 days, wherein the oil comprises a TMP of less than 30% after 12 days, or wherein the oil comprises a TMP of less than 35% after 20 days.

Embodiment 39: A fryer containing a cooking oil, and a food, wherein the cooking oil prevents adhesion of a first particle of the food to a second particle of the food when cooked in the cooking oil.

Embodiment 40: The fryer of any the preceding embodiments, wherein the temperature of the cooking oil is at least 5, 10, 15, 20, 25, or 30 F less than the temperature of the conventional oil, to achieve the same time to cook the food in the cooking oil as the conventional oil.

Embodiment 41: The fryer of any the preceding embodiments, wherein the cooking oil comprises a specific heat which is less than a conventional cooking oil and a food, wherein a time to cook the food in the cooking oil is less than a time to cook the food in the conventional cooking oil, optionally, wherein the conventional cooking oil is sunflower oil.

Embodiment 42: The fryer of any the preceding embodiments, the wherein the cooking oil is resistant to decomposition into polar materials as measured by total polar material (TMP) in the oil when heated.

Embodiment 43: The fryer of any the preceding embodiments, the wherein the TMP comprises peroxides, epoxides, alcohols, ketones, aldehydes, acids, dimers, polymers, or combinations thereof.

Embodiment 44: The fryer of any the preceding embodiments, wherein the cooking oil prevents adhesion of a first particle of the food to a second particle of the food when cooked in the cooking oil.

Embodiment 45: The fryer of any the preceding embodiments, wherein the cooking oil comprises at least 90% oleic acid, and less than 4% saturated fatty acids and less than 3% polyunsaturated fatty acids, wherein a time to cook the food in the cooking oil is less than a time to cook the food in the conventional cooking oil.

Embodiment 46: The fryer of any the preceding embodiments, wherein the cooking oil is resistant to decomposition into polar materials as measured by total polar material (TMP) in the oil when heated to 370 F, wherein the oil comprises a TMP of less than 20% after 6 days, wherein the oil comprises a TMP of less than 30% after 12 days, or wherein the oil comprises a TMP of less than 35% after 20 days.

Embodiment 47: The fryer of any the preceding embodiments, wherein the cooking oil comprises less than about 5 mmol/kg α,β-unsaturated aldehydes when heated to about 180° C.

Embodiment 48: The fryer of any the preceding embodiments, wherein the cooking oil comprises a polyunsaturated acid content of less than about 5 mmol/kg.

Embodiment 49: The fryer of any the preceding embodiments, wherein the cooking oil is resistant to rancidification resulting from oxidization or hydrolysis of fatty acids.

Embodiment 50: The fryer of any the preceding embodiments, wherein the cooking oil comprises a polyunsaturated fatty acid content of less than about 4 mmol/kg.

Embodiment 51: The fryer of any the preceding embodiments, wherein the cooking oil comprises a polyunsaturated fatty acid content of less than about 3.5 mmol/kg.

Embodiment 52: The fryer of any the preceding embodiments, wherein the cooking oil comprises a polyunsaturated fatty acid content of less than about 3 mmol/kg.

Embodiment 53: The fryer of any the preceding embodiments, wherein the cooking oil comprises a polyunsaturated fatty acid content of less than about 2.5 mmol/kg.

Embodiment 54: The fryer of any the preceding embodiments, wherein the cooking oil comprises a polyunsaturated fatty acid content of less than about 2.25 mmol/kg.

Embodiment 55: The fryer of any the preceding embodiments, wherein the cooking oil comprises a linoleic acid content of less than about 2.5 mmol/kg.

Embodiment 56: The fryer of any the preceding embodiments, wherein the cooking oil comprises a linoleic acid content of less than about 2.25 mmol/kg.

Embodiment 57: The fryer of any the preceding embodiments, wherein the cooking oil comprises a linoleic acid content of less than about 2 mmol/kg, or about 2 mmol/kg.

Embodiment 58: The fryer of any the preceding embodiments, wherein the cooking oil comprises a monounsaturated fatty acid content of at least 55 mmol/kg.

Embodiment 59: The fryer of any the preceding embodiments, wherein the cooking oil comprises a monounsaturated fatty acid content of at least 57.5 mmol/kg.

Embodiment 60: The fryer of any the preceding embodiments, wherein the cooking oil comprises a monounsaturated fatty acid content of about 60 mmol/kg.

Embodiment 61: The fryer of any the preceding embodiments, wherein the cooking oil comprises a saturated fatty acid content of less than about 3 mmol/kg.

Embodiment 62: The fryer of any the preceding embodiments, wherein the cooking oil comprises a saturated fatty acid content of less than about 2.75 mmol/kg.

Embodiment 63: The fryer of any the preceding embodiments, wherein the cooking oil comprises a saturated fatty acid content of about 2.5 mmol/kg.

Embodiment 64: The fryer of any the preceding embodiments, wherein the cooking oil comprises arachidic acid in an amount of less than about 0.07 mmol/kg.

Embodiment 65: The fryer of any the preceding embodiments, wherein the cooking oil comprises palmitic acid in an amount of less than about 1.5 mmol/kg.

Embodiment 66: The fryer of any the preceding embodiments, wherein the cooking oil comprises stearic acid in an amount of less than about 0.8 mmol/kg.

Embodiment 67: The fryer of any the preceding embodiments, wherein the cooking oil comprises less than about 2 mmol/kg α,β-unsaturated aldehydes when heated to about 180° C.

Embodiment 68: The fryer of any the preceding embodiments, wherein the cooking oil comprises less than about 1.8 mmol/kg α,β-unsaturated aldehydes when heated to about 180° C.

Embodiment 69: The fryer of any the preceding embodiments, wherein the cooking oil comprises less than about 2 mmol/kg α,β-unsaturated aldehydes when heated to about 180° C. for about 90 minutes or less.

Embodiment 70: The fryer of any the preceding embodiments, wherein the cooking oil comprises less than about 1.8 mmol/kg α,β-unsaturated aldehydes when heated to about 180° C. for about 90 minutes or less.

Embodiment 71: The fryer of any the preceding embodiments, wherein the cooking oil comprises less than about 50 mmol/kg aldehydes when heated to about 180° C. for about 90 minutes or less.

Embodiment 72: The fryer of any the preceding embodiments, wherein the cooking oil comprises essentially no α,β-unsaturated aldehydes when heated to about 180° C. for about 5 minutes or less.

Embodiment 73: The fryer of any the preceding embodiments, wherein the cooking oil comprises no detectable α,β-unsaturated aldehydes when heated to about 180° C. for about 5 minutes or less when measured using high-resolution proton (1H) nuclear magnetic resonance (NMR).

Embodiment 74: The fryer of any the preceding embodiments, wherein the cooking oil comprises less than about 0.1 mmol/kg α,β-unsaturated aldehydes when heated to about 180° C. for about 10 minutes or less.

Embodiment 75: The fryer of any the preceding embodiments, wherein the cooking oil comprises less than about 0.35 mmol/kg α,β-unsaturated aldehydes when heated to about 180° C. for about 20 minutes or less.

Embodiment 76: The fryer of any the preceding embodiments, wherein the cooking oil comprises less than about 0.55 mmol/kg α,β-unsaturated aldehydes when heated to about 180° C. for about 30 minutes or less.

Embodiment 77: The fryer of any the preceding embodiments, wherein the cooking oil comprises less than about 1.5 mmol/kg α,β-unsaturated aldehydes when heated to about 180° C. for about 60 minutes or less.

Embodiment 78: The fryer of any the preceding embodiments, wherein the cooking oil comprises essentially no (Z)-2-Alkenals when heated to about 180° C. for about 20 minutes or less.

Embodiment 79: The fryer of any the preceding embodiments, wherein the cooking oil comprises no detectable (Z)-2-Alkenals when heated to about 180° C. for about 20 minutes or less when measured using high-resolution proton (1H) nuclear magnetic resonance (NMR).

Embodiment 80: The fryer of any the preceding embodiments, wherein the cooking oil comprises less than about 0.15 mmol/kg (Z)-2-Alkenals when heated to about 180° C. for about 30 minutes or less.

Embodiment 81: The fryer of any the preceding embodiments, wherein the cooking oil comprises less than about 0.8 mmol/kg (Z)-2-Alkenals when heated to about 180° C. for about 60 minutes or less.

Embodiment 82: The fryer of any the preceding embodiments, wherein the cooking oil comprises less than about 1 mmol/kg (Z)-2-Alkenals when heated to about 180° C. for about 90 minutes or less.

Embodiment 83: The fryer of any the preceding embodiments, wherein the cooking oil comprises essentially no (Z,E)-2,4-Alkadienals when heated to about 180° C. for about 90 minutes or less.

Embodiment 84: The fryer of any the preceding embodiments, wherein the cooking oil comprises no detectable (Z,E)-2,4-Alkadienals when heated to about 180° C. for about 20 minutes or less when measured using high-resolution proton (1H) nuclear magnetic resonance (NMR).

Embodiment 85: The fryer of any the preceding embodiments, wherein the cooking oil comprises essentially no 4-Hydroperoxy-/4-Hydroxy-(E)-2-alkenals when heated to about 180° C. for about 10 minutes or less.

Embodiment 86: The fryer of any the preceding embodiments, wherein the cooking oil comprises no detectable 4-Hydroperoxy-/4-Hydroxy-(E)-2-alkenals when heated to about 180° C. for about 10 minutes or less when measured using high-resolution proton (1H) nuclear magnetic resonance (NMR).

Embodiment 87: The fryer of any the preceding embodiments, wherein the cooking oil comprises less than 0.1 mmol/kg 4-Hydroperoxy-/4-Hydroxy-(E)-2-alkenals when heated to about 180° C. for about 20 minutes or less.

Embodiment 88: The fryer of any the preceding embodiments, wherein the cooking oil comprises less than 0.4 mmol/kg 4-Hydroperoxy-/4-Hydroxy-(E)-2-alkenals when heated to about 180° C. for about 30 minutes or less.

Embodiment 89: The fryer of any the preceding embodiments, wherein the cooking oil comprises less than 0.4 mmol/kg 4-Hydroperoxy-/4-Hydroxy-(E)-2-alkenals when heated to about 180° C. for about 50 minutes or less.

Embodiment 90: The fryer of any the preceding embodiments, wherein the cooking oil comprises less than 0.8 mmol/kg 4-Hydroperoxy-/4-Hydroxy-(E)-2-alkenals when heated to about 180° C. for about 60 minutes or less.

Embodiment 91: The fryer of any the preceding embodiments, wherein the cooking oil comprises less than 1 mmol/kg 4-Hydroperoxy-/4-Hydroxy-(E)-2-alkenals when heated to about 180° C. for about 90 minutes or less.

Embodiment 92: The fryer of any the preceding embodiments, wherein the cooking oil comprises essentially no 4,5-Epoxy-(E)-2-alkenals when heated to about 180° C. for about 90 minutes or less.

Embodiment 93: The fryer of any the preceding embodiments, wherein the cooking oil comprises no detectable 4,5-Epoxy-(E)-2-alkenals when heated to about 180° C. for about 20 minutes or less when measured using high-resolution proton (1H) nuclear magnetic resonance (NMR).

Embodiment 94: The fryer of any the preceding embodiments, wherein the cooking oil comprises less than 0.3 mmol/kg 4-(E,E)-2,4-Alkadienals when heated to about 180° C. for about 20 minutes or less.

Embodiment 95: The fryer of any the preceding embodiments, wherein the cooking oil comprises less than about 50 mmol/kg total aldehydes when heated to about 180° C.

Embodiment 96: The fryer of any the preceding embodiments, wherein the cooking oil comprises less than about 50 mmol/kg total aldehydes when heated to about 180° C. for about 90 minutes or less.

Embodiment 97: The fryer of any the preceding embodiments, wherein the cooking oil comprises less than about 40 mmol/kg total aldehydes when heated to about 180° C. for about 60 minutes or less.

Embodiment 98: The fryer of any the preceding embodiments, wherein the cooking oil comprises less than about 25 mmol/kg total aldehydes when heated to about 180° C. for about 30 minutes or less.

Embodiment 99: The fryer of any the preceding embodiments, wherein the cooking oil comprises less than about 15 mmol/kg total aldehydes when heated to about 180° C. for about 20 minutes or less.

Embodiment 100: The fryer of any the preceding embodiments, wherein the cooking oil comprises less than about 1 mmol/kg total aldehydes when heated to about 180° C. for about 10 minutes or less.

Embodiment 101: The fryer of any the preceding embodiments, wherein the cooking oil comprises: 50% to 95% by weight of one or more monounsaturated fatty acids; 0 to 15% by weight of one or more saturated fatty acids; less than 90% oleic acid; and less than 5% linoleic acid.

Embodiment 102: The fryer of any of the preceding embodiments, wherein the TAG has a C18:2 fatty acid content of less than 1%.

Embodiment 103: The fryer of any of the preceding embodiments, wherein the TAG has a linoleic acid content of less than 1%.

Embodiment 104: The fryer of any of the preceding embodiments, wherein the TAG has an omega-6 fatty acid content of less than 1%.

Embodiment 105: The fryer of any of the preceding embodiments, wherein the TAG has a MUFA content of more than 50%.

Embodiment 106: The fryer of any of the preceding embodiments, wherein the TAG has a MUFA content of 50% to 95%.

Embodiment 107: The fryer of any of the preceding embodiments, wherein the TAG has a C18:1 fatty acid content of 70% or greater.

Embodiment 108: The fryer of any of the preceding embodiments, wherein the TAG has a SFA content of 40% or greater.

Embodiment 109: The fryer of any of the preceding embodiments, wherein the TAG has a SFA content of 5% to 15%.

Embodiment 110: The fryer of any of the preceding embodiments, wherein the TAG has a SFA content of 5% to 90% and a MUFA content of 10% to 80%

Embodiment 111: The fryer of any of the preceding embodiments, wherein the cooking oil has an OSI of greater than 50 hours without antioxidants added to the cooking oil.

Embodiment 112: The fryer of any of the preceding embodiments, wherein the cooking oil has an OSI of greater than 100 hours without antioxidants added to the cooking oil.

Embodiment 113: The fryer of any of the preceding embodiments, wherein the cooking oil has a TPM content below 10% after heating at a temperature greater than 250° F. for 4 hours.

Embodiment 114: The fryer of any of the preceding embodiments, wherein the cooking oil has a TPM content below 10% after heating at a temperature greater than 300° F. for 4 hours.

Embodiment 115: The fryer of any of the preceding embodiments, wherein the cooking oil has a TPM content below 10% after heating at a temperature greater than 350° F. for 4 hours.

Embodiment 116: The fryer of any of the preceding embodiments, wherein the cooking oil has a TPM content below 10% after heating at a temperature greater than 400° F. for 4 hours

Embodiment 117: The fryer of any of the preceding embodiments, wherein the cooking oil has a TPM content below 10% after heating from between 250° F. to 400° F. for 4 hours

Embodiment 118: The fryer of any of the preceding embodiments, wherein the cooking oil has a TPM content of less than 24% after heating at 250° F. for three days.

Embodiment 119: The fryer of any of the preceding embodiments, wherein the cooking oil comprises less than 5% free fatty acids after heating at 250° F. for 4 hours.

Embodiment 120: The fryer of any of the preceding embodiments, wherein the cooking oil contains less than 3% of aldehydes after heating at 250° F. for 50 hours.

Embodiment 121: The fryer of any of the preceding embodiments, wherein the cooking oil contains less than 1% of saturated aldehydes after heating at 250° F. for 50 hours.

Embodiment 122: The fryer of any of the preceding embodiments, wherein the cooking oil contains less than 2% of α,β-unsaturated aldehydes after heating at 250° F. for 50 hours.

Embodiment 123: The fryer of any of the preceding embodiments, wherein the cooking oil contains less than 0.5 mmol/mol FA of combined 4-hydrox/4-hydroperoxy-trans-2-alkenals after heating at 250° F. for 50 hours.

Embodiment 124: The fryer of any of the preceding embodiments, wherein the cooking oil contains less than 5% w/w lipid oxidation products (LOP) after heating at 250° F. for 50 hours.

Embodiment 125: The fryer of any of the preceding embodiments, wherein the cooking oil contains less than 350 μmol/L 4-hydroxy-trans-2-nonenal (HNE) after heating at 250° F. for 50 hours.

Embodiment 126: The fryer of any of the preceding embodiments, wherein the cooking oil comprises a linoleic acid content is substantially negligible.

Embodiment 127: The fryer of any of the preceding embodiments, wherein the linoleic acid content is below a detection limit.

Embodiment 128: The fryer of any of the preceding embodiments, wherein the cooking oil is a yeast oil.

Embodiment 129: The fryer of any of the preceding embodiments, wherein the cooking oil is a non-photosynthetic microbial oil.

Embodiment 130: The fryer of any of the preceding embodiments, wherein wherein the cooking oil contains less than 5% oxidation products of linoleic acid.

Embodiment 131: The fryer of any of the preceding embodiments, wherein wherein the cooking oil contains less than 3% 4-hydroxynonenal (HNE).

Embodiment 132: The fryer of any of the preceding embodiments, wherein the cooking oil contains less than 5 ppm of acrolein.

Embodiment 133: The fryer of any of the preceding embodiments, wherein the cooking oil comprising less than 5 ppm of crotonaldehyde

Embodiment 134: The fryer of any of the preceding embodiments, wherein the cooking oil comprising less than 100 ppm of detectable volatile aldehydes, such as alpha, beta-unsaturated aldehydes, including acrolein and crotonaldehyde.

Embodiment 135: A method of preparing a fried food comprising: heating the cooking oil in the fryer of embodiment 1 to at least 250° F.; placing a piece of food in the cooking oil until the temperature of the piece of food increases to at least 150° F.; removing the fried food from the fryer.

Embodiment 136: A method of preparing a fried food comprising: heating a cooking oil in the fryer to at least 180° F., wherein the oil comprises less than about 5 mmol/kg α,β-unsaturated aldehydes when heated to about 180° F., wherein the composition comprises a polyunsaturated acid content of less than about 5 mmol/kg; placing a piece of food in the cooking oil until the temperature of the piece of food increases to at least 150° F.; and removing the fried food from the fryer.

Embodiment 137: A method of preparing a fried food comprising heating a cooking oil to a temperature of at least 250 F, placing a food in the cooking oil, wherein the method prevents adhesion of a first particle of the food to a second particle of the food when cooked in the cooking oil.

Embodiment 138: A method of preparing a fried food comprising heating an edible cultured cooking oil to a temperature of at least 250 F, placing a food in the edible cultured cooking oil, wherein the method prevents or reduces adhesion of a first particle of the food to a second particle of the food when cooked in the edible cultured cooking oil.

Embodiment 139: A method of preparing a fried food comprising heating an edible cultured cooking oil to a temperature of at least 250 F, placing a food in the edible cultured cooking oil, wherein the method increases a transfer of heat to the food and/or reduces a cooking time of the food as compared to a plant-derived oil.

Embodiment 140: A method of reducing a content of total polar materials in a fried food comprising: heating an edible cultured cooking oil in a fryer to at least 180° F., wherein the oil comprises a monounsaturated fat (MUFA) of at least 90% wt., a polyunsaturated fat (PUFA) of up to 3%, or both; placing a piece of food in the cooking oil until the temperature of the piece of food increases to at least 150° F.; and removing the fried food from the fryer, wherein the fried food comprises a reduced content of total polar materials as compared to a same food cooked in a plant derived oil at a same temperature for a same time.

Embodiment 141: The method of any of the preceding embodiments, wherein the food is a meat, seafood, or vegetable.

Embodiment 142: The method of any of the preceding embodiments, wherein the meat is chicken.

Embodiment 143: The method of any of the preceding embodiments, wherein the seafood is fish.

Embodiment 144: The method of any of the preceding embodiments, wherein the vegetable is a tuber.

Embodiment 145: The method of any of the preceding embodiments, wherein the vegetable is a potato or onion.

Embodiment 146: The method of any of the preceding embodiments, wherein the food is a processed food.

Embodiment 147: The method of any of the preceding embodiments, wherein a time required to increase the temperature of the piece of food to at least 150 F is less than a conventional oil, optionally, wherein the conventional oil is sunflower oil.

Embodiment 148: The method of any of the preceding embodiments, wherein a time to cook the food in the cooking oil is the same as a time to cook the food in the conventional cooking oil when a temperature of the cooking oil is less than a temperature of the conventional oil, optionally, wherein the conventional cooking oil is sunflower oil.

Embodiment 149: The method of any of the preceding embodiments, wherein the cooking oil is resistant to decomposition into polar materials as measured by total polar material (TMP) in the oil when heated to 370 F, wherein the oil comprises a TMP of less than 20% after 6 days, wherein the oil comprises a TMP of less than 30% after 12 days, or wherein the oil comprises a TMP of less than 35% after 20 days.

Embodiment 150: The method of any of the preceding embodiments, wherein the cooking oil prevents adhesion of a first particle of the food to a second particle of the food when cooked in the cooking oil.

Embodiment 151: The method of any the preceding embodiments, wherein the cooking oil comprises a polyunsaturated fatty acid content of less than about 4 mmol/kg.

Embodiment 152: The method of any the preceding embodiments, wherein the cooking oil comprises a polyunsaturated fatty acid content of less than about 3.5 mmol/kg.

Embodiment 153: The method of any the preceding embodiments, wherein the cooking oil comprises a polyunsaturated fatty acid content of less than about 3 mmol/kg.

Embodiment 154: The method of any the preceding embodiments, wherein the cooking oil comprises a polyunsaturated fatty acid content of less than about 2.5 mmol/kg.

Embodiment 155: The method of any the preceding embodiments, wherein the cooking oil comprises a polyunsaturated fatty acid content of less than about 2.25 mmol/kg.

Embodiment 156: The method of any the preceding embodiments, wherein the cooking oil comprises a linoleic acid content of less than about 2.5 mmol/kg.

Embodiment 157: The method of any the preceding embodiments, wherein the cooking oil comprises a linoleic acid content of less than about 2.25 mmol/kg.

Embodiment 158: The method of any the preceding embodiments, wherein the cooking oil comprises a linoleic acid content of less than about 2 mmol/kg, or about 2 mmol/kg.

Embodiment 159: The method of any the preceding embodiments, wherein the cooking oil comprises a monounsaturated fatty acid content of at least 55 mmol/kg.

Embodiment 160: The method of any the preceding embodiments, wherein the cooking oil comprises a monounsaturated fatty acid content of at least 57.5 mmol/kg.

Embodiment 161: The method of any the preceding embodiments, wherein the cooking oil comprises a monounsaturated fatty acid content of about 60 mmol/kg.

Embodiment 162: The method of any the preceding embodiments, wherein the cooking oil comprises a saturated fatty acid content of less than about 3 mmol/kg.

Embodiment 163: The method of any the preceding embodiments, wherein the cooking oil comprises a saturated fatty acid content of less than about 2.75 mmol/kg.

Embodiment 164: The method of any the preceding embodiments, wherein the cooking oil comprises a saturated fatty acid content of about 2.5 mmol/kg.

Embodiment 165: The method of any the preceding embodiments, wherein the cooking oil comprises arachidic acid in an amount of less than about 0.07 mmol/kg.

Embodiment 166: The method of any the preceding embodiments, wherein the cooking oil comprises palmitic acid in an amount of less than about 1.5 mmol/kg.

Embodiment 167: The method of any the preceding embodiments, wherein the cooking oil comprises stearic acid in an amount of less than about 0.8 mmol/kg.

Embodiment 168: The method of any the preceding embodiments, wherein the cooking oil comprises less than about 2 mmol/kg α,β-unsaturated aldehydes when heated to about 180° C.

Embodiment 169: The method of any the preceding embodiments, wherein the cooking oil comprises less than about 1.8 mmol/kg α,β-unsaturated aldehydes when heated to about 180° C.

Embodiment 170: The method of any the preceding embodiments, wherein the cooking oil comprises less than about 2 mmol/kg α,β-unsaturated aldehydes when heated to about 180° C. for about 90 minutes or less.

Embodiment 171: The method of any the preceding embodiments, wherein the cooking oil comprises less than about 1.8 mmol/kg α,β-unsaturated aldehydes when heated to about 180° C. for about 90 minutes or less.

Embodiment 172: The method of any the preceding embodiments, wherein the cooking oil comprises less than about 50 mmol/kg aldehydes when heated to about 180° C. for about 90 minutes or less.

Embodiment 173: The method of any the preceding embodiments, wherein the cooking oil comprises essentially no α,β-unsaturated aldehydes when heated to about 180° C. for about 5 minutes or less.

Embodiment 174: The method of any the preceding embodiments, wherein the cooking oil comprises no detectable α,β-unsaturated aldehydes when heated to about 180° C. for about 5 minutes or less when measured using high-resolution proton (1H) nuclear magnetic resonance (NMR).

Embodiment 175: The method of any the preceding embodiments, wherein the cooking oil comprises less than about 0.1 mmol/kg α,β-unsaturated aldehydes when heated to about 180° C. for about 10 minutes or less.

Embodiment 176: The method of any the preceding embodiments, wherein the cooking oil comprises less than about 0.35 mmol/kg α,β-unsaturated aldehydes when heated to about 180° C. for about 20 minutes or less.

Embodiment 177: The method of any the preceding embodiments, wherein the cooking oil comprises less than about 0.55 mmol/kg α,β-unsaturated aldehydes when heated to about 180° C. for about 30 minutes or less.

Embodiment 178: The method of any the preceding embodiments, wherein the cooking oil comprises less than about 1.5 mmol/kg α,β-unsaturated aldehydes when heated to about 180° C. for about 60 minutes or less.

Embodiment 179: The method of any the preceding embodiments, wherein the cooking oil comprises essentially no (Z)-2-Alkenals when heated to about 180° C. for about 20 minutes or less.

Embodiment 180: The method of any the preceding embodiments, wherein the cooking oil comprises no detectable (Z)-2-Alkenals when heated to about 180° C. for about 20 minutes or less when measured using high-resolution proton (1H) nuclear magnetic resonance (NMR).

Embodiment 181: The method of any the preceding embodiments, wherein the cooking oil comprises less than about 0.15 mmol/kg (Z)-2-Alkenals when heated to about 180° C. for about 30 minutes or less.

Embodiment 182: The method of any the preceding embodiments, wherein the cooking oil comprises less than about 0.8 mmol/kg (Z)-2-Alkenals when heated to about 180° C. for about 60 minutes or less.

Embodiment 183: The method of any the preceding embodiments, wherein the cooking oil comprises less than about 1 mmol/kg (Z)-2-Alkenals when heated to about 180° C. for about 90 minutes or less.

Embodiment 184: The method of any the preceding embodiments, wherein the cooking oil comprises essentially no (Z,E)-2,4-Alkadienals when heated to about 180° C. for about 90 minutes or less.

Embodiment 185: The method of any the preceding embodiments, wherein the cooking oil comprises no detectable (Z,E)-2,4-Alkadienals when heated to about 180° C. for about 20 minutes or less when measured using high-resolution proton (1H) nuclear magnetic resonance (NMR).

Embodiment 186: The method of any the preceding embodiments, wherein the cooking oil comprises essentially no 4-Hydroperoxy-/4-Hydroxy-(E)-2-alkenals when heated to about 180° C. for about 10 minutes or less.

Embodiment 187: The method of any the preceding embodiments, wherein the cooking oil comprises no detectable 4-Hydroperoxy-/4-Hydroxy-(E)-2-alkenals when heated to about 180° C. for about 10 minutes or less when measured using high-resolution proton (1H) nuclear magnetic resonance (NMR).

Embodiment 188: The method of any the preceding embodiments, wherein the cooking oil comprises less than 0.1 mmol/kg 4-Hydroperoxy-/4-Hydroxy-(E)-2-alkenals when heated to about 180° C. for about 20 minutes or less.

Embodiment 189: The method of any the preceding embodiments, wherein the cooking oil comprises less than 0.4 mmol/kg 4-Hydroperoxy-/4-Hydroxy-(E)-2-alkenals when heated to about 180° C. for about 30 minutes or less.

Embodiment 190: The method of any the preceding embodiments, wherein the cooking oil comprises less than 0.4 mmol/kg 4-Hydroperoxy-/4-Hydroxy-(E)-2-alkenals when heated to about 180° C. for about 50 minutes or less.

Embodiment 191: The method of any the preceding embodiments, wherein the cooking oil comprises less than 0.8 mmol/kg 4-Hydroperoxy-/4-Hydroxy-(E)-2-alkenals when heated to about 180° C. for about 60 minutes or less.

Embodiment 192: The method of any the preceding embodiments, wherein the cooking oil comprises less than 1 mmol/kg 4-Hydroperoxy-/4-Hydroxy-(E)-2-alkenals when heated to about 180° C. for about 90 minutes or less.

Embodiment 193: The method of any the preceding embodiments, wherein the cooking oil comprises essentially no 4,5-Epoxy-(E)-2-alkenals when heated to about 180° C. for about 90 minutes or less.

Embodiment 194: The method of any the preceding embodiments, wherein the cooking oil comprises no detectable 4,5-Epoxy-(E)-2-alkenals when heated to about 180° C. for about 20 minutes or less when measured using high-resolution proton (1H) nuclear magnetic resonance (NMR).

Embodiment 195: The method of any the preceding embodiments, wherein the cooking oil comprises less than 0.3 mmol/kg 4-(E,E)-2,4-Alkadienals when heated to about 180° C. for about 20 minutes or less.

Embodiment 196: The method of any the preceding embodiments, wherein the cooking oil comprises less than about 50 mmol/kg total aldehydes when heated to about 180° C.

Embodiment 197: The method of any the preceding embodiments, wherein the cooking oil comprises less than about 50 mmol/kg total aldehydes when heated to about 180° C. for about 90 minutes or less.

Embodiment 198: The method of any the preceding embodiments, wherein the cooking oil comprises less than about 40 mmol/kg total aldehydes when heated to about 180° C. for about 60 minutes or less.

Embodiment 199: The method of any the preceding embodiments, wherein the cooking oil comprises less than about 25 mmol/kg total aldehydes when heated to about 180° C. for about 30 minutes or less.

Embodiment 200: The method of any the preceding embodiments, wherein the cooking oil comprises less than about 15 mmol/kg total aldehydes when heated to about 180° C. for about 20 minutes or less.

Embodiment 201: The method of any the preceding embodiments, wherein the cooking oil comprises less than about 1 mmol/kg total aldehydes when heated to about 180° C. for about 10 minutes or less.

1.-49. (canceled)

50. A microbially derived oil comprising a triacylglyceride (TAG), wherein said TAG comprises a monounsaturated fat (MUFA) content of at least 90% wt., a polyunsaturated fat (PUFA) content of less than 2% wt., and a C18:2 fatty acid content of less than 1% wt.; and further wherein the microbially derived oil comprises less aldehydes, alkenals, and/or alkadenials compared to a plant derived oil.

51. The microbially derived oil of claim 50, wherein the oil is derived from a genetically engineered microbe.

52. The microbially derived oil of claim 50, wherein the microbially derived oil is a non-photosynthetic microbial oil.

53. The microbially derived oil of claim 50, wherein the oil is derived from a yeast, a bacteria, and/or a fungi.

54. The microbially derived oil of claim 53, wherein the oil is generated from yeast comprising Candida, Cryptococcus, Lipomyces, Rhodosporidium, Rhodotorula, Rhizpus, Trichosporon, Apiotrichum, Cutaneotrichosporon, and/or Yarrowia.

55. The microbially derived oil of claim 54, wherein said yeast comprise Rhodosporidium toruloides, Lipomyces starkeyi, Rhodosporidium sp., Rhodotorula sp., Yarrowia sp., Cryptococcus sp., Lipomyces sp., Candida curvata, Rhodotorula glutinis, Rhodotula 110, Cryptococcus podzolicus, Trichosporon porosum, Pichia segobiensis, Trichosporonoides spathulata, Kodamaea ohmeri, Cryptococcus sp., Cryptococcus music, Lipomyces tetrasporus, Lipomyces sp, Cutaneotrichosporon oleaginosus, ATCC 20509, and/or Metschnikowia pulcherrim.

56. The microbially derived oil of claim 53, wherein the bacteria comprise Rhodococcus sp, Acetinobacter sp, Ralstonia sp., Gordonia sp., and/or Arthrobacter sp.

57. The microbially derived oil of claim 53, wherein the fungi comprise Cunninghamella echinulate, Mortierella alpina, Aspergillus niger, Trichoderma reesia, Backusella sp., Pilaira sp., Rhizopus sp., Thamnostylum sp., Mortierella sp., and/or Mucoromycota sp.

58. The microbially derived oil of claim 50, wherein the oil comprises less than 100 ppm of detectable volatile aldehydes, such as alpha, beta-unsaturated aldehydes, including acrolein and crotonaldehyde.

59. The microbially derived oil of claim 50, wherein the oil is resistant to decomposition into polar materials as measured by total polar material (TMP) in the oil when heated.

60. The microbially derived oil of claim 59, wherein the TMP comprises peroxides, epoxides, alcohols, ketones, aldehydes, acids, dimers, polymers, or combinations thereof.

61. The microbially derived oil of claim 59, wherein the oil is resistant to decomposition into polar materials as measured by TMP in the oil when heated to 370° F., wherein the oil comprises a TMP of less than 20% after 6 days, wherein the oil comprises a TMP of less than 30% after 12 days, or wherein the oil comprises a TMP of less than 35% after 20 days.

62. A method of making the microbially derived oil of claim 50, the method comprising allowing oil-producing yeast to accumulate lipids intracellularly when a nutrient in the medium becomes limited and the carbon source is present in excess.

63. The method of claim 62, wherein the nutrient which is limited comprises nitrogen and/or phosphorus.

64. The method of claim 63, wherein nitrogen limitation is used to induce lipogenesis.

65. The method of claim 62, wherein the yeast uses one or more different carbon sources for the production of cell mass and/or lipids.

66. The method of claim 65, wherein carbon source comprises starch, ethanol, volatile fatty acids acetic acid, butyric acid, propionic acid, formic acid, lactose, glucose, fructose, sucrose, raffinose, molasses, bagasse, xylose, glycerol, methanol, synthesis gas, carbon dioxide, carbon monoxide, food wastes, dairy effluents, corn syrup, corn steep liquor, acid whey, yeast extract, and/or cellulose hydrolysates.

67. The method of claim 65, wherein the carbon source is industrial, agricultural, food, and/or municipal organic wastes.

68. The method of claim 65, wherein the carbon source is a fossil source while and/or a renewable bio-based source.

69. A microbial composition capable of producing the microbially derived oil of claim 50.
